(19) United States
(12) Patent Application Publication
(10) Pub. No.: US 2025/0370226 A1
(43) Pub. Date: Dec. 4, 2025

(54) OPTICAL IMAGING SYSTEM

(71) Applicant: Samsung Electro-Mechanics Co., Ltd., Suwon-si (KR)

(72) Inventors: Yong Joo JO, Suwon-si (KR); Ji Su LEE, Suwon-si (KR)

(73) Assignee: Samsung Electro-Mechanics Co., Ltd., Suwon-si (KR)

(21) Appl. No.: 19/098,177

(22) Filed: Apr. 2, 2025

(30) Foreign Application Priority Data
May 30, 2024 (KR) 10-2024-0071100

(51) Int. Cl. G02B 13/00; G02B 7/02; G02B 9/64

(52) U.S. Cl. CPC G02B 13/0045; G02B 7/025; G02B 9/64; G02B 13/006

(57) ABSTRACT

An optical imaging system includes a first lens, a second lens, a third lens, a fourth lens, a fifth lens, a sixth lens, a seventh lens, an eighth lens, and a ninth lens, wherein a composite focal length of the first and second lenses has a positive value, the third lens has a negative refractive power, two lenses among the first lens to ninth lenses are bonded to each other, and the optical imaging system satisfies 0≤|fa/Va−fb/Vb|<3, where fa is a focal length of a lens disposed closer to an object side among the two bonded lenses, Va is an Abbe number of the lens disposed closer to the object side, fb is a focal length of a lens disposed closer to an image plane among the two bonded lenses, and Vb is an Abbe number of the lens disposed closer to the image plane.

### CROSS-REFERENCE TO RELATED APPLICATIONS

This application claims the benefit under 35 USC 119(a) of Korean Patent Application No. 10-2024-0071100 filed on May 30, 2024, in the Korean Intellectual Property Office, the entire disclosure of which is incorporated herein by reference for all purposes.

### BACKGROUND

### 1. Field

The present disclosure relates to an optical imaging system.

### 2. Description of Related Art

A mobile terminal may be equipped with a camera including an optical imaging system composed of a plurality of lenses to enable video calls and image capturing.

As a function of the camera in the mobile terminal gradually increases, a demand for the camera for the mobile terminal having a high degree of resolution is increasing.

In addition, as mobile terminals are gradually becoming smaller, the camera for the mobile terminals need to become slimmer, so development of an optical imaging system that can implement a high degree of resolution while being slim is needed.

### SUMMARY

This Summary is provided to introduce a selection of concepts in simplified form that are further described below in the Detailed Description. This Summary is not intended to identify key features or essential features of the claimed subject matter, nor is it intended to be used as an aid in determining the scope of the claimed subject matter.

In one general aspect, an optical imaging system includes a first lens, a second lens, a third lens, a fourth lens, a fifth lens, a sixth lens, a seventh lens, an eighth lens, and a ninth lens sequentially disposed in ascending numerical order along an optical axis of the optical imaging system from an object side of the optical imaging system toward an image plane of the optical imaging system, wherein a composite focal length of the first lens and the second lens has a positive value, the third lens has a negative refractive power, two lenses among the first lens to the ninth lens are bonded to each other, and the optical imaging system satisfies 0≤|fa/Va−fb/Vb|<3, where fa is a focal length of a lens disposed closer to the object side of the optical imaging system among the two bonded lenses, Va is an Abbe number of the lens disposed closer to the object side of the optical imaging system among the two bonded lenses, fb is a focal length of a lens disposed closer to the image plane of the optical imaging system among the two bonded lenses, and Vb is an Abbe number of the lens disposed closer to the image plane of the optical imaging system among the two bonded lenses.

The optical imaging system may satisfy −0.4<f1/(f×100)<0.7, where f1 is a focal length of the first lens, and f is a total focal length of the optical imaging system.

The optical imaging system may satisfy 0.5<f2/f<1.5, where f2 is a focal length of the second lens, and f is a total focal length of the optical imaging system.

The optical imaging system may satisfy −2<f3/f<0, where f3 is a focal length of the third lens, and f is a total focal length of the optical imaging system.

The optical imaging system may satisfy 0.5<f4/f<3, where f4 is a focal length of the fourth lens, and f is a total focal length of the optical imaging system.

The optical imaging system may satisfy −9<f5/f<−1, where f5 is a focal length of the fifth lens, and f is a total focal length of the optical imaging system.

The optical imaging system may satisfy −1<f6/(f×100)<0, where f6 is a focal length of the sixth lens, and f is a total focal length of the optical imaging system.

The optical imaging system may satisfy −7<f7/f<−2, where f7 is a focal length of the seventh lens, and f is a total focal length of the optical imaging system.

The optical imaging system may satisfy 0.5<f8/f<2, where f8 is a focal length of the eighth lens, and f is a total focal length of the optical imaging system.

The optical imaging system may satisfy −2<f9/f<0, where f9 is a focal length of the ninth lens, and f is a total focal length of the optical imaging system.

The optical imaging system may satisfy 1<TTL/f<1.4 and 0<BFL/f<0.3 are satisfied, where TTL is a distance along the optical axis from an object-side surface of the first lens to the image plane, BFL is a distance along the optical axis from an image-side surface of the ninth lens to the image plane, and f is a total focal length of the optical imaging system.

The optical imaging system may satisfy 0.5<TTL/(2×IMG HT)<0.8, where TTL is a distance along the optical axis from an object-side surface of the first lens to the image plane, and IMG HT is one half of a diagonal length of the image plane.

The optical imaging system may satisfy 1.5<f/EPD<2, where f is a total focal length of the optical imaging system, EPD is an entrance pupil diameter of the optical imaging system, and f/EPD is an F-number of the optical imaging system.

The optical imaging system may satisfy 1.3<AVE(Va, Vb)/Vc<2, where AVE(Va, Vb) is an average value of Abbe numbers of the two bonded lenses, and Vc is an Abbe number of a lens among the first to ninth lenses located adjacent to the two bonded lenses on an image side of the two bonded lenses.

The optical imaging system may further include an adhesive layer bonding the two bonded lenses to each other, wherein a refractive index of the adhesive layer is greater than a refractive index of a lens having a smaller refractive index among the two bonded lenses, and is less than a refractive index of a lens having a greater refractive index among the two bonded lenses.

The optical imaging system may further include an adhesive layer bonding the two bonded lenses to each other, wherein the optical imaging system satisfies 10<Vg<80, where Vg is an Abbe number of the adhesive layer.

The optical imaging system may satisfy 60°<FOV×(IMG HT/f)<90°, where FOV is a field of view of the optical imaging system, IMG HT is one half of a diagonal length of the image plane, and f is a total focal length of the optical imaging system

The optical imaging system may satisfy 6<|f1/f2|<55, where f1 is a focal length of the first lens, and f2 is a focal length of the second lens.

The optical imaging system may satisfy 0.7<f12/f<1, where f12 is a composite focal length of the first lens and the second lens, and f is a total focal length of the optical imaging system.

The optical imaging system may satisfy −11<f34/f<−3, where f34 is a composite focal length of the third lens and the fourth lens, and f is a total focal length of the optical imaging system.

The optical imaging system may satisfy −6<f56/f<0, where f56 is a composite focal length of the fifth lens and the sixth lens, and f is a total focal length of the optical imaging system.

Other features and aspects will be apparent from the following detailed description, the drawings, and the claims.

### BRIEF DESCRIPTION OF DRAWINGS

FIG. 1 is a configuration diagram of an optical imaging system according to a first embodiment of the present disclosure.

FIG. 2 is a view illustrating aberration characteristics of the optical imaging system illustrated in FIG. 1.

FIG. 3 is a configuration diagram of an optical imaging system according to a second embodiment of the present disclosure.

FIG. 4 is a view illustrating aberration characteristics of the optical imaging system illustrated in FIG. 3.

FIG. 5 is a configuration diagram of an optical imaging system according to a third embodiment of the present disclosure.

FIG. 6 is a view illustrating aberration characteristics of the optical imaging system illustrated in FIG. 5.

FIG. 7 is a configuration diagram of an optical imaging system according to a fourth embodiment of the present disclosure.

FIG. 8 is a view illustrating aberration characteristics of the optical imaging system illustrated in FIG. 7.

FIG. 9 is a configuration diagram of an optical imaging system according to a fifth embodiment of the present disclosure.

FIG. 10 is a view illustrating aberration characteristics of the optical imaging system illustrated in FIG. 9.

FIG. 11 is a configuration diagram of an optical imaging system according to a sixth embodiment of the present disclosure.

FIG. 12 is a view illustrating aberration characteristics of the optical imaging system illustrated in FIG. 11.

FIG. 13 is a configuration diagram of an optical imaging system according to a seventh embodiment of the present disclosure.

FIG. 14 is a view illustrating aberration characteristics of the optical imaging system illustrated in FIG. 13.

FIG. 15 is a configuration diagram of an optical imaging system according to an eighth embodiment of the present disclosure.

FIG. 16 is a view illustrating aberration characteristics of the optical imaging system illustrated in FIG. 15.

FIG. 17 is a configuration diagram of an optical imaging system according to a ninth embodiment of the present disclosure.

FIG. 18 is a view illustrating aberration characteristics of the optical imaging system illustrated in FIG. 17.

FIG. 19 is a configuration diagram of an optical imaging system according to a tenth embodiment of the present disclosure.

FIG. 20 is a view illustrating aberration characteristics of the optical imaging system illustrated in FIG. 19.

FIG. 21 is a configuration diagram of an optical imaging system according to an eleventh embodiment of the present disclosure.

FIG. 22 is a view illustrating aberration characteristics of the optical imaging system illustrated in FIG. 21.

Throughout the drawings and the detailed description, the same reference numerals refer to the same elements. The drawings may not be to scale, and the relative sizes, proportions, and depictions of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure of this application. For example, the sequences of operations described herein are merely examples, and are not limited to those set forth herein, but may be changed as will be apparent after an understanding of the disclosure of this application, with the exception of operations necessarily occurring in a certain order. Also, descriptions of features that are known in the art may be omitted for increased clarity and conciseness.

The features described herein may be embodied in different forms, and are not to be construed as being limited to the examples described herein. Rather, the examples described herein have been provided merely to illustrate some of the many possible ways of implementing the methods, apparatuses, and/or systems described herein that will be apparent after an understanding of the disclosure of this application.

Throughout the specification, when an element, such as a layer, region, or substrate, is described as being “on,” “connected to,” or “coupled to” another element, it may be directly “on,” “connected to,” or “coupled to” the other element, or there may be one or more other elements intervening therebetween. In contrast, when an element is described as being “directly on,” “directly connected to,” or “directly coupled to” another element, there can be no other elements intervening therebetween.

As used herein, the term “and/or” includes any one and any combination of any two or more of the associated listed items.

Although terms such as “first,” “second,” and “third” may be used herein to describe various members, components, regions, layers, or sections, these members, components, regions, layers, or sections are not to be limited by these terms. Rather, these terms are only used to distinguish one member, component, region, layer, or section from another member, component, region, layer, or section. Thus, a first member, component, region, layer, or section referred to in examples described herein may also be referred to as a second member, component, region, layer or section without departing from the teachings of the examples.

Spatially relative terms such as “above,” “upper,” “below,” and “lower” may be used herein for ease of description to describe one element's relationship to another element as shown in the figures. Such spatially relative terms are intended to encompass different orientations of the device in use or operation in addition to the orientation depicted in the figures. For example, if the device in the figures is turned over, an element described as being “above” or “upper” relative to another element will then be “below” or “lower” relative to the other element. Thus, the term “above” encompasses both the above and below orientations depending on the spatial orientation of the device. The device may also be oriented in other ways (for example, rotated by 90 degrees or at other orientations), and the spatially relative terms used herein are to be interpreted accordingly.

The terminology used herein is for describing various examples only, and is not to be used to limit the disclosure. The articles “a,” “an,” and “the” are intended to include the plural forms as well, unless the context clearly indicates otherwise. The terms “comprises,” “includes,” and “has” specify the presence of stated features, numbers, operations, members, elements, and/or combinations thereof, but do not preclude the presence or addition of one or more other features, numbers, operations, members, elements, and/or combinations thereof.

In lens configuration diagrams in the figures of the present application, a thickness, a size, and a shape of a lens may be somewhat exaggerated for ease of explanation, and in particular, a spherical shape or an aspherical shape shown in the lens configuration diagram is only illustrative, and is not limited to the shape shown.

An optical imaging system according to an embodiment of the present disclosure may include nine lenses.

A first lens refers to a lens closest to an object side of the optical imaging system, and a ninth lens refers to a lens closest to an image plane (or an image sensor) of the optical imaging system.

In addition, in this specification, values of a radius of curvature, a thickness, and a focal length of a lens, distances, and other quantities are expressed in mm, and values of a field of view (FOV) of the optical imaging system are expressed in degrees.

In addition, in descriptions of a shape of each lens, a statement that a surface has a convex shape means that a paraxial region of the surface is convex, and a statement that a surface has a concave shape means that a paraxial region of the surface is concave.

Therefore, even when one surface of the lens is described as having a convex shape, an edge or peripheral region of the one surface of the lens may be concave. Similarly, even when one surface of the lens is described as having a concave shape, an edge or peripheral region of the surface of the lens may be convex.

A paraxial region of a lens surface refers to a very narrow region of the lens surface near an optical axis of the lens surface.

In greater detail, a paraxial region of a lens surface is a central portion of the lens surface surrounding and including the optical axis of the lens surface in which light rays incident to the lens surface make a small angle θ to the optical axis, and the approximations sin θ≈θ, tan θ≈θ, and cos θ≈1 are valid.

An image plane refers to a virtual surface on which a focus is formed by the optical imaging system. Alternatively, the image plane refers to a surface of an image sensor on which light is received.

An optical imaging system according to an embodiment of the present disclosure may include at least nine lenses.

For example, an optical imaging system according to an embodiment of the present disclosure may include a first lens, a second lens, a third lens, a fourth lens, a fifth lens, a sixth lens, a seventh lens, an eighth lens, and a ninth lens sequentially disposed in ascending numerical order along an optical axis of the optical imaging system from an object side of the optical imaging system toward an image plane of the optical imaging system. Two lenses among the first to ninth lenses may be bonded to each other. The two bonded lenses may be bonded to each other by an adhesive layer. The other seven lenses among the first to ninth lenses may be spaced apart from each other by preset distances along an optical axis of the optical imaging system.

An optical imaging system according to an embodiment of the present disclosure may further include an image sensor for converting an incident image of a subject into an electric signal.

In addition, the optical imaging system may further include an infrared filter (hereinafter referred to simply as a filter) for blocking infrared rays. The filter may be disposed between the ninth lens and the image sensor.

In addition, the optical imaging system may further include an aperture for controlling an amount of light incident on an image plane of the optical imaging system. The first to ninth lenses constituting the optical imaging system according to an embodiment of the present disclosure may be made of various plastic materials.

In addition, at least one lens among the first to ninth lenses has an aspherical surface. For example, the first to ninth lenses may each have at least one aspherical surface.

For example, either one or both of an object-side surface and an image-side surface of each of the first to ninth lenses may be an aspherical surface. In this case, aspherical surfaces of the first to ninth lenses may be expressed by the following Equation 1:

$$Z = \frac{{cY}^{2}}{1 + \sqrt{1 - ( 1 + K ) {c}^{2} {Y}^{2}}} + {AY}^{4} + {BY}^{6} + {CY}^{8} + {DY}^{10} + {EY}^{12} + {FY}^{14} + {GY}^{16} + {HY}^{18} + {JY}^{20} + {LY}^{22} + {MY}^{24} + {NY}^{26} + {OY}^{28} + {PY}^{30} \qquad [ Equation 1 ]$$

In Equation 1, c is a curvature of the lens surface and is equal to a reciprocal of a radius of curvature of the lens surface at an optical axis of the lens surface, K is a conic constant, and Y is a distance from any point on the aspherical surface of the lens to the optical axis. In addition, constants A to H, J, and L to P are aspherical surface coefficients. Z (also known as sag) is a distance in a direction parallel to an optical axis direction between the point on the aspherical surface of the lens at the distance Y from the optical axis of the aspherical surface to a tangential plane perpendicular to the optical axis and intersecting a vertex of the aspherical surface.

An optical imaging system according to an embodiment of the present disclosure may satisfy any one or any combination of any two or more of the following Conditional Expressions 1 to 20:

$$0 \leq \vert fa / Va - fb / Vb \vert < 3 \qquad ( Conditional Expression 1 )$$

$$- 0.4 < f 1 / ( f \times 100 ) < 0.7 \qquad ( Conditional Expression 2 )$$

$$0.5 < f 1 / ( f \times 100 ) < 0.7 \qquad ( Conditional Expression 3 )$$

$$- 2 < f 3 / f < 0 \qquad ( Conditional Expression 4 )$$

$$0.5 < f 4 / f < 3 \qquad ( Conditional Expression 5 )$$

$$- 9 < f 5 / f < - 1 \qquad ( Conditional Expression 6 )$$

$$- 1 < f 6 / ( f \times 100 ) < 0 \qquad ( Conditional Expression 7 )$$

$$- 7 < f 7 / f < - 2 \qquad ( Conditional Expression 8 )$$

$$0.5 < f 8 / f < 2 \qquad ( Conditional Expression 9 )$$

$$- 2 < f 9 / f < 0 \qquad ( Conditional Expression 10 )$$

$$1 < TTL / f < 1.4 \qquad ( Conditional Expression 11 )$$

$$0 < BFL / f < 0.3 \qquad ( Conditional Expression 12 )$$

$$0.5 < TTL / ( 2 \times IMG HT ) < 0.8 \qquad ( Conditional Expression 13 )$$

$$1.5 < f / EPD < 2 \qquad ( Conditional Expression 14 )$$

$$60 ° < FOV \times ( IMG HT / f ) < 90 ° \qquad ( Conditional Expression 15 )$$

$$1.3 < AVE ( Va , Vb ) / Vc < 2 \qquad ( Conditional Expression 16 )$$

$$6 < \vert f 1 / f 2 \vert < 55 \qquad ( Conditional Expression 17 )$$

$$0.7 < f 12 / f < 1 \qquad ( Conditional Expression 18 )$$

$$- 11 < f 34 / f < - 3 \qquad ( Conditional Expression 19 )$$

$$- 6 < f 56 / f < 0 \qquad ( Conditional Expression 20 )$$

$$Nb < Refractive Index of Adhesive Layer < Na \qquad ( Conditional Expression 21 )$$

$$10 < Vg < 80 \qquad ( Conditional Expression 22 )$$

In an embodiment, the optical imaging system may satisfy 0≤|fa/Va−fb/Vb|<3 (Conditional Expression 1). In this case, fa is a focal length of a lens disposed closer to an object side of the optical imaging system among two lenses bonded to each other among the first to ninth lenses, Va is an Abbe number of the lens disposed closer to the object side of the optical imaging system among the two bonded lenses, fb is a focal length of a lens disposed closer to an image plane of the optical imaging system among the two bonded lenses, and Vb is an Abbe number of the lens disposed closer to the image plane of the optical imaging system among the two bonded lenses. Therefore, chromatic aberration may be reduced.

In an embodiment, the optical imaging system may satisfy −0.4<f1/(f×100)<0.7 (Conditional Expression 2). In this case, f1 is a focal length of a first lens from an object side of the optical imaging system, and f is a total focal length of the optical imaging system. Therefore, occurrence of aberration may be minimized by appropriately adjusting a refractive power of the first lens.

In an embodiment, the optical imaging system may satisfy 0.5<f2/f<1.5 (Conditional Expression 3). In this case, f2 is a focal length of a second lens from the object side of the optical imaging system. Therefore, occurrence of aberration may be minimized by appropriately adjusting a refractive power of the second lens.

In an embodiment, the optical imaging system may satisfy −2<f3/f<0 (Conditional Expression 4). In this case, f3 is a focal length of a third lens from the object side of the optical imaging system. Therefore, occurrence of aberration may be minimized by appropriately adjusting a refractive power of the third lens.

In an embodiment, the optical imaging system may satisfy 0.5<f4/f<3 (Conditional Expression 5). In this case, f4 is a focal length of a fourth lens from the object side of the optical imaging system. Therefore, occurrence of aberration may be minimized by appropriately adjusting a refractive power of the fourth lens.

In an embodiment, the optical imaging system may satisfy −9<f5/f<−1 (Conditional Expression 6). In this case, f5 is a focal length of a fifth lens from the object side of the optical imaging system. Therefore, occurrence of aberration may be minimized by appropriately adjusting a refractive power of the fifth lens.

In an embodiment, the optical imaging system may satisfy −1<f6/(f×100)<0 (Conditional Expression 7). In this case, f6 is a focal length of a sixth lens from the object side of the optical imaging system. Therefore, occurrence of aberration may be minimized by appropriately adjusting a refractive power of the sixth lens.

In an embodiment, the optical imaging system may satisfy −7<f7/f<−2 (Conditional Expression 8). In this case, f7 is a focal length of a seventh lens from the object side of the optical imaging system. Therefore, a degree of resolution of a peripheral portion of an image may be improved, and a field curvature phenomenon may be reduced.

In an embodiment, the optical imaging system may satisfy 0.5<f8/f<2 (Conditional Expression 9). In this case, f8 is a focal length of an eighth lens from the object side of the optical imaging system. Therefore, a degree of resolution of a peripheral portion of an image may be improved, and a field curvature phenomenon may be reduced.

In an embodiment, the optical imaging system may satisfy −2<f9/f<0 (Conditional Expression 10). In this case, f9 is a focal length of a ninth lens from the object side of the optical imaging system. Therefore, a degree of resolution of a peripheral portion of an image may be improved, and a field curvature phenomenon may be reduced.

In an embodiment, the optical imaging system may satisfy 1<TTL/f<1.4 (Conditional Expression 11). In this case, TTL is an optical axis distance from an object-side surface of the first lens to an image plane of the optical imaging system. Therefore, the optical imaging system may be miniaturized while improving a degree of resolution of an image.

In an embodiment, the optical imaging system may satisfy 0<BFL/f<0.3 (Conditional Expression 12). In this case, BFL is an optical axis distance from an image-side surface of the ninth lens to the image plane. Therefore, the optical imaging system may be miniaturized while improving a degree of resolution of an image.

In an embodiment, the optical imaging system may satisfy 0.5<TTL/(2×IMG HT)<0.8 (Conditional Expression 13). In this case, IMG HT is one half of a diagonal length of the image plane. Therefore, the optical imaging system may be miniaturized while improving a degree of resolution of an image.

In an embodiment, the optical imaging system may satisfy 1.5<f/EPD<2 (Conditional Expression 14). In this case, EPD is an entrance pupil diameter of the optical imaging system, and f/EPD is an F-number of the optical imaging system. Therefore, a brightness and a degree of resolution of an image may be improved.

In an embodiment, the optical imaging system may satisfy 60°<FOV×(IMG HT/f)<90° (Conditional Expression 15). In this case, FOV is a field of view of the optical imaging system.

In an embodiment, the optical imaging system may satisfy 1.3<AVE(Va, Vb)/Vc<2 (Conditional Expression 16). In this case, AVE(Va, Vb) is an average value of Abbe numbers of two bonded lenses, and Vc is an Abbe number of a lens disposed adjacent to the two bonded lenses on an image side of the two bonded lenses. Therefore, chromatic aberration may be reduced.

In an embodiment, the optical imaging system may satisfy 6<|f1/f2<55 (Conditional Expression 17). In this case, f1 is a focal length of the first lens, and f2 is a focal length of the second lens. Therefore, a degree of resolution may be improved by appropriately adjusting a refractive power of the first lens and a refractive power of the second lens.

In an embodiment, the optical imaging system may satisfy 0.7<f12/f<1 (Conditional Expression 18), where f12 is a composite focal length of the first lens and the second lens. Therefore, a degree of resolution may be improved by appropriately adjusting a refractive power of the first lens and a refractive power of the second lens.

In an embodiment, the optical imaging system may satisfy −11<f34/f<−3 (Conditional Expression 19), where f34 is a composite focal length of the third lens and the fourth lens. Therefore, a degree of resolution may be improved by appropriately adjusting a refractive power of the third lens and a refractive power of the fourth lens.

In an embodiment, the optical imaging system may satisfy −6<f56/f<0 (Conditional Expression 20), where f56 is a composite focal length of the fifth lens and the sixth lens. Therefore, a degree of resolution may be improved by appropriately adjusting a refractive power of the fifth lens and a refractive power of the sixth lens.

In an embodiment, two lenses among the first to ninth lenses may be bonded to each other by an adhesive layer, and a refractive index of the adhesive layer may satisfy Nb<Refractive Index of Adhesive Layer<Na (Conditional Expression 21). In this case, Na is a refractive index of a lens disposed closer to the object side of the optical imaging system among the two bonded lenses, and Nb is a refractive index of a lens disposed closer to the image plane among the two bonded lenses.

In an embodiment, an Abbe number Vg of the adhesive layer may satisfy 10<Vg<80 (Conditional Expression 22).

The first lens may have a positive refractive power or a negative refractive power. In addition, the first lens may have a meniscus shape convex toward the object side of the optical imaging system. For example, an object-side surface of the first lens may be convex in the paraxial region, and an image-side surface of the first lens may be concave in the paraxial region.

The second lens may have a positive refractive power. In addition, the second lens may have a meniscus shape convex toward the object side of the optical imaging system. For example, an object-side surface of the second lens may be convex in the paraxial region, and an image-side surface of the second lens may be concave in the paraxial region.

A composite focal length of the first lens and the second lens may have a positive value.

The third lens may have a negative refractive power. In addition, the third lens may have a meniscus shape convex toward the object side of the optical imaging system. For example, an object-side surface of the third lens may be convex in the paraxial region, and an image-side surface of the third lens may be concave in the paraxial region.

The fourth lens may have a positive refractive power. In addition, the fourth lens may have a meniscus shape convex toward the object side of the optical imaging system. For example, an object-side surface of the fourth lens may be convex in the paraxial region, and an image-side surface of the fourth lens may be concave in the paraxial region.

The fifth lens may have a negative refractive power. In addition, the fifth lens may have a concave shape on both surfaces. For example, an object-side surface and an image-side surface of the fifth lens may be concave in the paraxial region.

Alternatively, the fifth lens may have a meniscus shape convex toward the object side of the optical imaging system. For example, an object-side surface of the fifth lens may be convex in the paraxial region, and an image-side surface of the fifth lens may be concave in the paraxial region.

Alternatively, the fifth lens may have a meniscus shape convex toward an image side of the optical imaging system. For example, an object-side surface of the fifth lens may be concave in the paraxial region, and an image-side surface of the fifth lens may be convex in the paraxial region.

The sixth lens may have a negative refractive power. In addition, the sixth lens may have a meniscus shape convex toward the object side of the optical imaging system. For example, an object-side surface of the sixth lens may be convex in the paraxial region, and an image-side surface of the sixth lens may be concave in the paraxial region.

Alternatively, the sixth lens may have a meniscus shape convex toward the image side of the optical imaging system. For example, an object-side surface of the sixth lens may be concave in the paraxial region, and an image-side surface of the sixth lens may be convex in the paraxial region.

The seventh lens may have a negative refractive power. In addition, the seventh lens may have a meniscus shape convex toward the image side of the optical imaging system. For example, an object-side surface of the seventh lens may be concave in the paraxial region, and an image-side surface of the seventh lens may be convex in the paraxial region.

The eighth lens may have a positive refractive power. In addition, the eighth lens may have a meniscus shape convex toward the object side of the optical imaging system. For example, an object-side surface of the eighth lens may be convex in the paraxial region, and an image-side surface of the eighth lens may be concave in the paraxial region.

The ninth lens may have a negative refractive power. In addition, the ninth lens may have a meniscus shape convex toward the object side of the optical imaging system. For example, an object-side surface of the ninth lens may be convex in the paraxial region, and an image-side surface of the ninth lens may be concave in the paraxial region.

In addition, either one or both of the eighth lens and the ninth lens may have at least one inflection point on either one or both of the object-side surface and the image-side surface. For example, the object-side surface of the eighth lens may be convex in the paraxial region, and may be concave in a peripheral region outside the paraxial region. The image-side surface of the eighth lens may be concave in the paraxial region, and may be convex in a peripheral region outside the paraxial region.

Two lenses among a plurality of lenses of the optical imaging system may be bonded to each other. For example, among the two lenses, an image-side surface of a lens located closer to the object side, and an object-side surface of a lens located closer to the image side, may be bonded to each other.

In an embodiment, the first lens and the second lens may be bonded to each other. For example, the image-side surface of the first lens and the object-side surface of the second lens may be bonded to each other.

In an embodiment, the third lens and the fourth lens may be bonded to each other. For example, the image-side surface of the third lens and the object-side surface of the fourth lens may be bonded to each other.

In an embodiment, the fifth lens and the sixth lens may be bonded to each other. For example, the image-side surface of the fifth lens and the object-side surface of the sixth lens may be bonded to each other.

In an embodiment, the two lenses may be bonded to each other by an adhesive layer. A maximum thickness of the adhesive layer in a state in which the two lenses are bonded to each other may be 1 to 50 μm.

In an embodiment, bonding surfaces of the two bonded lenses (e.g., an image-side surface of the lens closer to the object side of the optical imaging system and an object-side surface of the lens closer to the image plane of the optical imaging system) may be spherical surfaces having the same radius of curvature.

In an embodiment, the bonding surfaces of the two bonded lenses (e.g., an image-side surface of the lens closer to the object side of the optical imaging system and an object-side surface of the lens closer to the image plane of the optical imaging system) may be aspherical surfaces having the same radius of curvature and the same aspherical shape. When the bonding surfaces are aspherical, aspheric coefficients of the bonding surfaces may be the same.

Among nine lenses of the optical imaging system, three lenses may have an Abbe number less than 33. All lenses having an Abbe number less than 33 may have a negative refractive power.

The optical imaging system may have a field of view greater than 75°. In an embodiment, the field of view of the optical imaging system may be less than 90°.

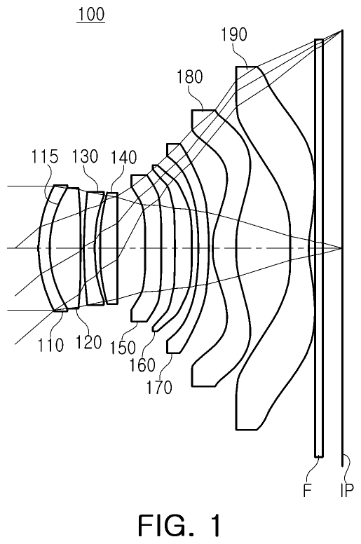

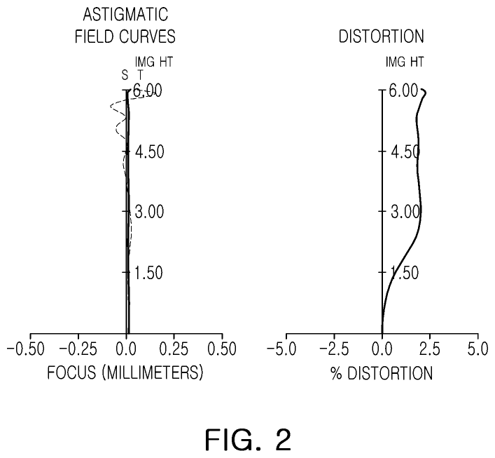

FIG. 1 is a configuration diagram of an optical imaging system according to a first embodiment of the present disclosure, and FIG. 2 is a view illustrating aberration characteristics of the optical imaging system illustrated in FIG. 1.

Referring to FIG. 1, an optical imaging system 100 according to the first embodiment of the present disclosure may include a first lens 110, a second lens 120, a third lens 130, a fourth lens 140, a fifth lens 150, a sixth lens 160, a seventh lens 170, an eighth lens 180, and a ninth lens 190, and may further include a filter F and an image sensor (not shown).

The optical imaging system 100 according to the first embodiment of the present disclosure may form a focus on an image plane IP. The image plane IP may be a surface of the image sensor on which light is received.

Lens characteristics (a radius of curvature, a thickness of a lens or a distance between lenses, a refractive index, and an Abbe number) of each of the lenses and the filter may be as illustrated in Table 1.

TABLE 1

| Surface | | Radius of | Thickness or | Refractive | Abbe |
|---|---|---|---|---|---|
| No. | Element | Curvature | Distance | Index | No. |
| S1 | First | 3.285 | 0.297 | 1.600 | 40.0 |
| S2 | Lens | 3.025 | 0.000 | | |
| S3 | Second | 3.025 | 0.810 | 1.550 | 62.0 |
| S4 | Lens | 181.985 | 0.100 | | |
| S5 | Third | 16.724 | 0.280 | 1.718 | 29.3 |
| S6 | Lens | 4.509 | 0.146 | | |
| S7 | Fourth | 6.659 | 0.452 | 1.661 | 53.5 |
| S8 | Lens | 42.772 | 0.730 | | |
| S9 | Fifth | −74.755 | 0.421 | 1.720 | 29.2 |
| S10 | Lens | 21.789 | 0.361 | | |
| S11 | Sixth | 29.827 | 0.452 | 1.644 | 54.8 |
| S12 | Lens | 25.988 | 0.165 | | |
| S13 | Seventh | −5.703 | 0.280 | 1.614 | 25.9 |
| S14 | Lens | −7.951 | 0.100 | | |
| S15 | Eighth | 1.977 | 0.623 | 1.544 | 56.0 |
| S16 | Lens | 3.966 | 1.424 | | |
| S17 | Ninth | 37.472 | 0.486 | 1.535 | 55.7 |
| S18 | Lens | 2.594 | 0.162 | | |
| S19 | Filter | Infinity | 0.210 | 1.517 | 64.2 |
| S20 | | Infinity | 0.500 | | |
| S21 | Image | Infinity | | | |
| | Plane | | | | |

In the first embodiment of the present disclosure, the first lens 110 may have a negative refractive power, an object-side surface of the first lens 110 may have a convex shape in the paraxial region, and an image-side surface of the first lens 110 may have a concave shape in the paraxial region.

The second lens 120 may have a positive refractive power, an object-side surface of the second lens 120 may have a convex shape in the paraxial region, and an image-side surface of the second lens 120 may have a concave shape in the paraxial region.

The first lens 110 and the second lens 120 may be bonded to each other. For example, the image-side surface of the first lens 110 and the object-side surface of the second lens 120 may be bonded to each other.

The first lens 110 and the second lens 120 may be bonded to each other by an adhesive layer 115.

The third lens 130 may have a negative refractive power, an object-side surface of the third lens 130 may have a convex shape in the paraxial region, and an image-side surface of the third lens 130 may have a concave shape in the paraxial region.

The fourth lens 140 may have a positive refractive power, an object-side surface of the fourth lens 140 may have a convex shape in the paraxial region, and an image-side surface of the fourth lens 140 may have a concave shape in the paraxial region.

The fifth lens 150 may have a negative refractive power, and an object-side surface and an image-side surface of the fifth lens 150 may be concave in the paraxial region.

The sixth lens 160 may have a negative refractive power, an object-side surface of the sixth lens 160 may be convex in the paraxial region, and an image-side surface of the sixth lens 160 may be concave in the paraxial region.

The seventh lens 170 may have a negative refractive power, an object-side surface of the seventh lens 170 may be concave in the paraxial region, and an image-side surface of the seventh lens 170 may be convex in the paraxial region.

The eighth lens 180 may have a positive refractive power, an object-side surface of the eighth lens 180 may be convex in the paraxial region, and an image-side surface of the eighth lens 180 may be concave in the paraxial region.

The ninth lens 190 may have a negative refractive power, an object-side surface of the ninth lens 190 may be convex in the paraxial region, and an image-side surface of the ninth lens 190 may be concave in the paraxial region.

In addition, either one or both of the eighth lens 180 and the ninth lens 190 may have at least one inflection point on either one or both of the object-side surface and the image-side surface.

Each of the surfaces of the first lens 110 to the ninth lens 190 may have aspherical coefficients as illustrated in Table 2. For example, the object-side surfaces and the image-side surfaces of the first lens 110 to the ninth lens 190 may all be aspherical.

TABLE 2

| | S1 | S2 | S3 | S4 | S5 | S6 |
|---|---|---|---|---|---|---|
| Conic | −4.775 | −0.156 | −0.156 | 57.613 | 54.868 | 4.525 |
| Constant (K) | | | | | | |
| 4th Coeffi- | 1.308E−02 | −3.303E−03 | −3.303E−03 | −3.304E−03 | −7.282E−03 | −1.526E−02 |
| cient (A) | | | | | | |
| 6th Coeffi- | 4.277E−03 | 1.653E−02 | 1.653E−02 | −6.283E−02 | −3.677E−02 | 2.533E−02 |
| cient (B) | | | | | | |
| 8th Coeffi- | −3.466E−02 | 2.674E−01 | 2.674E−01 | 2.807E−01 | 2.261E−01 | −1.082E−01 |
| cient (C) | | | | | | |
| 10th Coeffi- | 8.957E−02 | −1.867E+00 | −1.867E+00 | −7.186E−01 | −6.733E−01 | 3.130E−01 |
| cient (D) | | | | | | |
| 12th Coeffi- | −1.442E−01 | 5.873E+00 | 5.873E+00 | 1.205E+00 | 1.286E+00 | −6.079E−01 |
| cient (E) | | | | | | |
| 14th Coeffi- | 1.548E−01 | −1.127E+01 | −1.127E+01 | −1.397E+00 | −1.683E+00 | 8.167E−01 |
| cient (F) | | | | | | |
| 16th Coeffi- | −1.150E−01 | 1.444E+01 | 1.444E+01 | 1.150E+00 | 1.555E+00 | −7.749E−01 |
| cient (G) | | | | | | |
| 18th Coeffi- | 6.028E−02 | −1.284E+01 | −1.284E+01 | −6.818E−01 | −1.032E+00 | 5.249E−01 |
| cient (H) | | | | | | |
| 20th Coeffi- | −2.244E−02 | 8.038E+00 | 8.038E+00 | 2.912E−01 | 4.922E−01 | −2.540E−01 |
| cient (J) | | | | | | |
| 22nd Coeffi- | 5.889E−03 | −3.533E+00 | −3.533E+00 | −8.869E−02 | −1.674E−01 | 8.679E−02 |
| cient (L) | | | | | | |
| 24th Coeffi- | −1.065E−03 | 1.068E+00 | 1.068E+00 | 1.875E−02 | 3.955E−02 | −2.038E−02 |
| cient (M) | | | | | | |
| 26th Coeffi- | 1.260E−04 | −2.113E−01 | −2.113E−01 | −2.610E−03 | −6.160E−03 | 3.121E−03 |
| cient (N) | | | | | | |
| 28th Coeffi- | −8.786E−06 | 2.465E−02 | 2.465E−02 | 2.148E−04 | 5.683E−04 | −2.795E−04 |
| cient (O) | | | | | | |
| 30th Coeffi- | 2.732E−07 | −1.285E−03 | −1.285E−03 | −7.907E−06 | −2.349E−05 | 1.107E−05 |
| cient (P) | | | | | | |

| | S7 | S8 | S9 | S10 | S11 | S12 |
|---|---|---|---|---|---|---|
| Conic | −3.450 | 97.050 | 0.000 | −38.673 | 94.110 | −99.000 |
| Constant (K) | | | | | | |
| 4th Coeffi- | 5.124E−03 | −3.502E−03 | −2.547E−02 | −3.026E−02 | −7.986E−02 | −1.504E−01 |
| cient (A) | | | | | | |
| 6th Coeffi- | −4.557E−02 | 1.534E−04 | −2.125E−02 | 1.852E−02 | 1.160E−01 | 2.284E−01 |
| cient (B) | | | | | | |
| 8th Coeffi- | 2.264E−01 | −1.619E−02 | 8.497E−02 | −4.582E−02 | −1.976E−01 | −3.848E−01 |
| cient (C) | | | | | | |
| 10th Coeffi- | −7.575E−01 | 6.861E−02 | −2.590E−01 | 7.847E−02 | 2.757E−01 | 4.911E−01 |
| cient (D) | | | | | | |
| 12th Coeffi- | 1.708E+00 | −1.749E−01 | 5.280E−01 | −1.004E−01 | −2.899E−01 | −4.459E−01 |
| cient (E) | | | | | | |
| 14th Coeffi- | −2.681E+00 | 2.994E−01 | −7.471E−01 | 9.573E−02 | 2.247E−01 | 2.907E−01 |
| cient (F) | | | | | | |
| 16th Coeffi- | 2.994E+00 | −3.575E−01 | 7.543E−01 | −6.766E−02 | −1.287E−01 | −1.387E−01 |
| cient (G) | | | | | | |
| 18th Coeffi- | −2.408E+00 | 3.029E−01 | −5.513E−01 | 3.518E−02 | 5.472E−02 | 4.912E−02 |
| cient (H) | | | | | | |
| 20th Coeffi- | 1.397E+00 | −1.827E−01 | 2.920E−01 | −1.335E−02 | −1.726E−02 | −1.298E−02 |
| cient (J) | | | | | | |
| 22nd Coeffi- | −5.780E−01 | 7.779E−02 | −1.109E−01 | 3.646E−03 | 3.995E−03 | 2.540E−03 |
| cient (L) | | | | | | |
| 24th Coeffi- | 1.662E−01 | −2.278E−02 | 2.933E−02 | −6.984E−04 | −6.603E−04 | −3.586E−04 |
| cient (M) | | | | | | |
| 26th Coeffi- | −3.153E−02 | 4.360E−03 | −5.123E−03 | 8.925E−05 | 7.375E−05 | 3.456E−05 |
| cient (N) | | | | | | |
| 28th Coeffi- | 3.541E−03 | −4.898E−04 | 5.298E−04 | −6.847E−06 | −4.979E−06 | −2.030E−06 |
| cient (O) | | | | | | |
| 30th Coeffi- | −1.782E−04 | 2.445E−05 | −2.452E−05 | 2.391E−07 | 1.529E−07 | 5.457E−08 |
| cient (P) | | | | | | |

| | S13 | S14 | S15 | S16 | S17 | S18 |
|---|---|---|---|---|---|---|
| Conic | 2.599 | 3.200 | −6.538 | −10.071 | 34.433 | −10.532 |
| Constant (K) | | | | | | |
| 4th Coeffi- | 2.964E−02 | 2.353E−02 | 4.480E−03 | 1.889E−02 | −1.092E−01 | −5.828E−02 |
| cient (A) | | | | | | |
| 6th Coeffi- | 5.589E−02 | −1.536E−02 | −1.520E−02 | −6.497E−03 | 5.335E−02 | 2.917E−02 |
| cient (B) | | | | | | |
| 8th Coeffi- | −2.133E−01 | −2.527E−02 | 1.410E−02 | −1.863E−03 | −2.061E−02 | −1.113E−02 |
| cient (C) | | | | | | |
| 10th Coeffi- | 3.152E−01 | 5.353E−02 | −1.149E−02 | 1.889E−03 | 5.996E−03 | 3.145E−03 |
| cient (D) | | | | | | |
| 12th Coeffi- | −2.796E−01 | −4.765E−02 | 6.817E−03 | −6.699E−04 | −1.273E−03 | −6.594E−04 |
| cient (E) | | | | | | |
| 14th Coeffi- | 1.651E−01 | 2.568E−02 | −2.893E−03 | 1.256E−04 | 1.985E−04 | 1.023E−04 |
| cient (F) | | | | | | |
| 16th Coeffi- | −6.790E−02 | −9.234E−03 | 8.800E−04 | −9.052E−06 | −2.300E−05 | −1.173E−05 |
| cient (G) | | | | | | |
| 18th Coeffi- | 1.988E−02 | 2.307E−03 | −1.920E−04 | −1.369E−06 | 1.991E−06 | 9.897E−07 |
| cient (H) | | | | | | |
| 20th Coeffi- | −4.164E−03 | −4.067E−04 | 2.998E−05 | 4.532E−07 | −1.282E−07 | −6.099E−08 |
| cient (J) | | | | | | |
| 22nd Coeffi- | 6.181E−04 | 5.045E−05 | −3.307E−06 | −5.914E−08 | 6.043E−09 | 2.699E−09 |
| cient (L) | | | | | | |
| 24th Coeffi- | −6.324E−05 | −4.311E−06 | 2.512E−07 | 4.501E−09 | −2.021E−10 | −8.328E−11 |
| cient (M) | | | | | | |
| 26th Coeffi- | 4.215E−06 | 2.417E−07 | −1.247E−08 | −2.075E−10 | 4.530E−12 | 1.696E−12 |
| cient (N) | | | | | | |
| 28th Coeffi- | −1.633E−07 | −8.005E−09 | 3.641E−10 | 5.394E−12 | −6.091E−14 | −2.046E−14 |
| cient (O) | | | | | | |
| 30th Coeffi- | 2.750E−09 | 1.187E−10 | −4.729E−12 | −6.083E−14 | 3.709E−16 | 1.106E−16 |
| cient (P) | | | | | | |

In addition, the optical imaging system 100 according to the first embodiment of the present disclosure may have the aberration characteristics illustrated in FIG. 2.

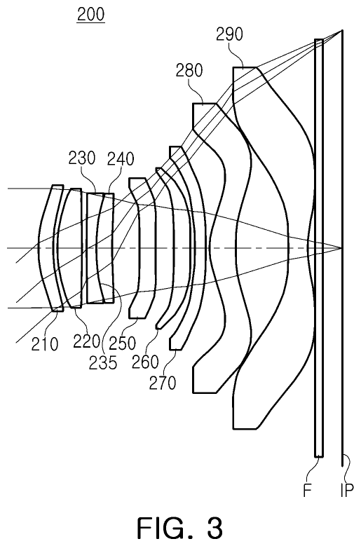

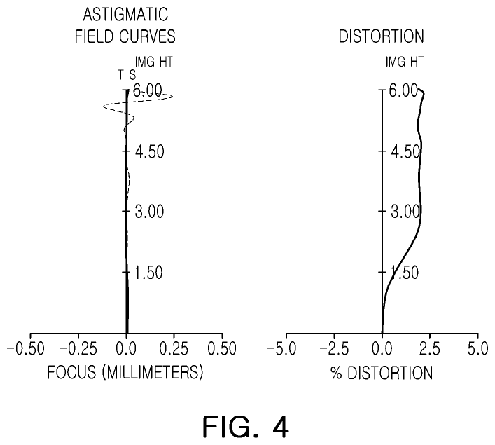

FIG. 3 is a configuration diagram of an optical imaging system according to a second embodiment of the present disclosure, and FIG. 4 is a view illustrating aberration characteristics of the optical imaging system illustrated in FIG. 3.

Referring to FIG. 3, an optical imaging system 200 according to the second embodiment of the present disclosure may include a first lens 210, a second lens 220, a third lens 230, a fourth lens 240, a fifth lens 250, a sixth lens 260, a seventh lens 270, an eighth lens 280, and a ninth lens 290, and may further include a filter F and an image sensor (not shown).

The optical imaging system 200 according to the second embodiment of the present disclosure may form a focus on an image plane IP. The image plane IP may be a surface of the image sensor on which light is received.

Lens characteristics (a radius of curvature, a thickness of a lens or a distance between lenses, a refractive index, and an Abbe number) of each of the lenses and the filter may be as illustrated in Table 3.

TABLE 3

| Surface | | Radius of | Thickness or | Refractive | Abbe |
|---|---|---|---|---|---|
| No. | Element | Curvature | Distance | Index | No. |
| S1 | First | 3.211 | 0.381 | 1.510 | 62.0 |
| S2 | Lens | 3.601 | 0.113 | | |
| S3 | Second | 3.535 | 0.647 | 1.542 | 62.0 |
| S4 | Lens | 68.702 | 0.116 | | |
| S5 | Third | 30.634 | 0.260 | 1.720 | 29.8 |
| S6 | Lens | 5.197 | 0.000 | | |
| S7 | Fourth | 5.197 | 0.418 | 1.540 | 62.0 |
| S8 | Lens | 17.186 | 0.723 | | |
| S9 | Fifth | 78.683 | 0.420 | 1.720 | 29.2 |
| S10 | Lens | 23.277 | 0.478 | | |
| S11 | Sixth | 22.969 | 0.441 | 1.558 | 52.5 |
| S12 | Lens | 15.918 | 0.118 | | |
| S13 | Seventh | −5.965 | 0.285 | 1.614 | 25.9 |
| S14 | Lens | −8.820 | 0.109 | | |
| S15 | Eighth | 2.076 | 0.682 | 1.544 | 56.0 |
| S16 | Lens | 4.708 | 1.387 | | |
| S17 | Ninth | 38.123 | 0.513 | 1.535 | 55.7 |
| S18 | Lens | 2.412 | 0.200 | | |
| S19 | Filter | Infinity | 0.210 | 1.517 | 64.2 |
| S20 | | Infinity | 0.500 | | |
| S21 | Image | Infinity | | | |
| | Plane | | | | |

In the second embodiment of the present disclosure, the first lens 210 may have a positive refractive power, an object-side surface of the first lens 210 may have a convex shape in the paraxial region, and an image-side surface of the first lens 210 may have a concave shape in the paraxial region.

The second lens 220 may have a positive refractive power, an object-side surface of the second lens 220 may have a convex shape in the paraxial region, and an image-side surface of the second lens 220 may have a concave shape in the paraxial region.

The third lens 230 may have a negative refractive power, an object-side surface of the third lens 230 may have a convex shape in the paraxial region, and an image-side surface of the third lens 230 may have a concave shape in the paraxial region.

The fourth lens 240 may have a positive refractive power, an object-side surface of the fourth lens 240 may have a convex shape in the paraxial region, and an image-side surface of the fourth lens 240 may have a concave shape in the paraxial region.

The third lens 230 and the fourth lens 240 may be bonded to each other. For example, the image-side surface of the third lens 230 and the object-side surface of the fourth lens 240 may be bonded to each other.

The third lens 230 and the fourth lens 240 may be bonded to each other by an adhesive layer 235.

The fifth lens 250 may have a negative refractive power, an object-side surface of the fifth lens 250 may have a convex shape in the paraxial region, and an image-side surface of the fifth lens 250 may have a concave shape in the paraxial region.

The sixth lens 260 may have a negative refractive power, an object-side surface of the sixth lens 260 may have a convex shape in the paraxial region, and an image-side surface of the sixth lens 260 may have a concave shape in the paraxial region.

The seventh lens 270 may have a negative refractive power, an object-side surface of the seventh lens 270 may have a concave shape in the paraxial region, and an image-side surface of the seventh lens 270 may have a convex shape in the paraxial region.

The eighth lens 280 may have a positive refractive power, an object-side surface of the eighth lens 280 may have a convex shape in the paraxial region, and an image-side surface of the eighth lens 280 may have a concave shape in the paraxial region.

The ninth lens 290 may have a negative refractive power, an object-side surface of the ninth lens 290 may have a convex shape in the paraxial region, and an image-side surface of the ninth lens 290 may have a concave shape in the paraxial region.

In addition, either one or both of the eighth lens 280 and the ninth lens 290 may have at least one inflection point on either one or both of the object-side surface and the image-side surface.

Each of the surfaces of the first lens 210 to the ninth lens 290 may have aspherical coefficients as illustrated in Table 4. For example, the object-side surfaces and the image-side surfaces of the first lens 210, the second lens 220, the fifth lens 250 to the ninth lens 290 may all be aspherical. The object-side surface of the third lens 230 and the image-side surface of the fourth lens 240 may be aspherical, and the image-side surface of the third lens 230 and the object-side surface of the fourth lens 240 may be spherical.

TABLE 4

| | S1 | S2 | S3 | S4 | S5 | S6 |
|---|---|---|---|---|---|---|
| Conic | −6.385 | −12.045 | −4.441 | −32.889 | 62.704 | 0.000 |
| Constant (K) | | | | | | |
| 4th Coeffi- | 1.444E−02 | 1.114E−02 | 9.009E−04 | −1.336E−02 | −6.972E−03 | 0.000E+00 |
| cient (A) | | | | | | |
| 6th Coeffi- | −3.248E−03 | −1.815E−02 | −1.862E−02 | −3.409E−03 | −1.185E−02 | 0.000E+00 |
| cient (B) | | | | | | |
| 8th Coeffi- | −1.963E−02 | 5.889E−03 | 6.111E−02 | 2.971E−02 | 7.098E−02 | 0.000E+00 |
| cient (C) | | | | | | |
| 10th Coeffi- | 5.909E−02 | 3.799E−02 | −1.290E−01 | −7.272E−02 | −1.882E−01 | 0.000E+00 |
| cient (D) | | | | | | |
| 12th Coeffi- | −1.027E−01 | −1.194E−01 | 1.877E−01 | 1.165E−01 | 3.241E−01 | 0.000E+00 |
| cient (E) | | | | | | |
| 14th Coeffi- | 1.179E−01 | 1.920E−01 | −1.902E−01 | −1.299E−01 | −3.830E−01 | 0.000E+00 |
| cient (F) | | | | | | |
| 16th Coeffi- | −9.406E−02 | −1.969E−01 | 1.377E−01 | 1.036E−01 | 3.182E−01 | 0.000E+00 |
| cient (G) | | | | | | |
| 18th Coeffi- | 5.345E−02 | 1.374E−01 | −7.200E−02 | −5.995E−02 | −1.881E−01 | 0.000E+00 |
| cient (H) | | | | | | |
| 20th Coeffi- | −2.177E−02 | −6.690E−02 | 2.718E−02 | 2.524E−02 | 7.930E−02 | 0.000E+00 |
| cient (J) | | | | | | |
| 22nd Coeffi- | 6.308E−03 | 2.271E−02 | −7.321E−03 | −7.671E−03 | −2.359E−02 | 0.000E+00 |
| cient (L) | | | | | | |
| 24th Coeffi- | −1.268E−03 | −5.273E−03 | 1.369E−03 | 1.642E−03 | 4.827E−03 | 0.000E+00 |
| cient (M) | | | | | | |
| 26th Coeffi- | 1.680E−04 | 7.972E−04 | −1.687E−04 | −2.352E−04 | −6.455E−04 | 0.000E+00 |
| cient (N) | | | | | | |
| 28th Coeffi- | −1.317E−05 | −7.069E−05 | 1.229E−05 | 2.023E−05 | 5.070E−05 | 0.000E+00 |
| cient (O) | | | | | | |
| 30th Coeffi- | 4.621E−07 | 2.786E−06 | −4.005E−07 | −7.892E−07 | −1.773E−06 | 0.000E+00 |
| cient (P) | | | | | | |

| | S7 | S8 | S9 | S10 | S11 | S12 |
|---|---|---|---|---|---|---|
| Conic | 0.000 | −63.290 | −99.000 | 43.282 | 98.176 | −42.385 |
| Constant (K) | | | | | | |
| 4th Coeffi- | 0.000E+00 | −2.470E−03 | −3.039E−02 | −3.346E−02 | −8.695E−02 | −1.707E−01 |
| cient (A) | | | | | | |
| 6th Coeffi- | 0.000E+00 | 4.637E−04 | 2.025E−02 | 4.355E−02 | 1.568E−01 | 2.737E−01 |
| cient (B) | | | | | | |
| 8th Coeffi- | 0.000E+00 | 1.079E−02 | −6.793E−02 | −1.175E−01 | −2.851E−01 | −4.315E−01 |
| cient (C) | | | | | | |
| 10th Coeffi- | 0.000E+00 | −4.975E−02 | 1.197E−01 | 2.043E−01 | 3.905E−01 | 4.947E−01 |
| cient (D) | | | | | | |
| 12th Coeffi- | 0.000E+00 | 1.266E−01 | −1.232E−01 | −2.474E−01 | −3.990E−01 | −4.179E−01 |
| cient (E) | | | | | | |
| 14th Coeffi- | 0.000E+00 | −2.076E−01 | 5.517E−02 | 2.154E−01 | 3.049E−01 | 2.694E−01 |
| cient (F) | | | | | | |
| 16th Coeffi- | 0.000E+00 | 2.295E−01 | 3.183E−02 | −1.371E−01 | −1.746E−01 | −1.342E−01 |
| cient (G) | | | | | | |
| 18th Coeffi- | 0.000E+00 | −1.756E−01 | −7.185E−02 | 6.420E−02 | 7.472E−02 | 5.124E−02 |
| cient (H) | | | | | | |
| 20th Coeffi- | 0.000E+00 | 9.409E−02 | 5.836E−02 | −2.199E−02 | −2.377E−02 | −1.476E−02 |
| cient (J) | | | | | | |
| 22nd Coeffi- | 0.000E+00 | −3.513E−02 | −2.845E−02 | 5.429E−03 | 5.538E−03 | 3.137E−03 |
| cient (L) | | | | | | |
| 24th Coeffi- | 0.000E+00 | 8.941E−03 | 8.927E−03 | −9.375E−04 | −9.181E−04 | −4.746E−04 |
| cient (M) | | | | | | |
| 26th Coeffi- | 0.000E+00 | −1.476E−03 | −1.772E−03 | 1.072E−04 | 1.025E−04 | 4.825E−05 |
| cient (N) | | | | | | |
| 28th Coeffi- | 0.000E+00 | 1.423E−04 | 2.027E−04 | −7.287E−06 | −6.890E−06 | −2.945E−06 |
| cient (O) | | | | | | |
| 30th Coeffi- | 0.000E+00 | −6.067E−06 | −1.020E−05 | 2.228E−07 | 2.106E−07 | 8.132E−08 |
| cient (P) | | | | | | |

| | S13 | S14 | S15 | S16 | S17 | S18 |
|---|---|---|---|---|---|---|
| Conic | 2.439 | 3.824 | −5.906 | −7.975 | 8.837 | −9.838 |
| Constant (K) | | | | | | |
| 4th Coeffi- | 3.826E−02 | 4.406E−02 | −5.342E−03 | 1.060E−02 | −1.196E−01 | −6.161E−02 |
| cient (A) | | | | | | |
| 6th Coeffi- | −8.536E−03 | −8.940E−02 | 4.142E−04 | 1.348E−02 | 7.085E−02 | 3.801E−02 |
| cient (B) | | | | | | |
| 8th Coeffi- | −4.988E−02 | 1.046E−01 | 2.013E−03 | −2.122E−02 | −3.323E−02 | −1.702E−02 |
| cient (C) | | | | | | |
| 10th Coeffi- | 7.021E−02 | −8.948E−02 | −5.553E−03 | 1.347E−02 | 1.119E−02 | 5.352E−03 |
| cient (D) | | | | | | |
| 12th Coeffi- | −4.872E−02 | 5.804E−02 | 4.982E−03 | −5.290E−03 | −2.644E−03 | −1.200E−03 |
| cient (E) | | | | | | |
| 14th Coeffi- | 2.283E−02 | −2.808E−02 | −2.523E−03 | 1.409E−03 | 4.453E−04 | 1.945E−04 |
| cient (F) | | | | | | |
| 16th Coeffi- | −8.651E−03 | 9.901E−03 | 8.185E−04 | −2.643E−04 | −5.442E−05 | −2.294E−05 |
| cient (G) | | | | | | |
| 18th Coeffi- | 2.839E−03 | −2.514E−03 | −1.794E−04 | 3.562E−05 | 4.878E−06 | 1.977E−06 |
| cient (H) | | | | | | |
| 20th Coeffi- | −7.576E−04 | 4.561E−04 | 2.718E−05 | −3.464E−06 | −3.205E−07 | −1.238E−07 |
| cient (J) | | | | | | |
| 22nd Coeffi- | 1.495E−04 | −5.837E−05 | −2.859E−06 | 2.410E−07 | 1.526E−08 | 5.556E−09 |
| cient (L) | | | | | | |
| 24th Coeffi- | −2.030E−05 | 5.138E−06 | 2.051E−07 | −1.170E−08 | −5.117E−10 | −1.737E−10 |
| cient (M) | | | | | | |
| 26th Coeffi- | 1.773E−06 | −2.956E−07 | −9.579E−09 | 3.764E−10 | 1.146E−11 | 3.588E−12 |
| cient (N) | | | | | | |
| 28th Coeffi- | −8.937E−08 | 1.000E−08 | 2.627E−10 | −7.203E−12 | −1.537E−13 | −4.395E−14 |
| cient (O) | | | | | | |
| 30th Coeffi- | 1.972E−09 | −1.509E−10 | −3.208E−12 | 6.206E−14 | 9.336E−16 | 2.415E−16 |
| cient (P) | | | | | | |

In addition, the optical imaging system 200 according to the second embodiment of the present disclosure may have the aberration characteristics illustrated in FIG. 4.

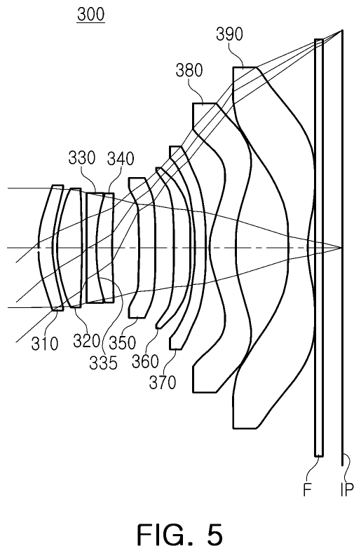

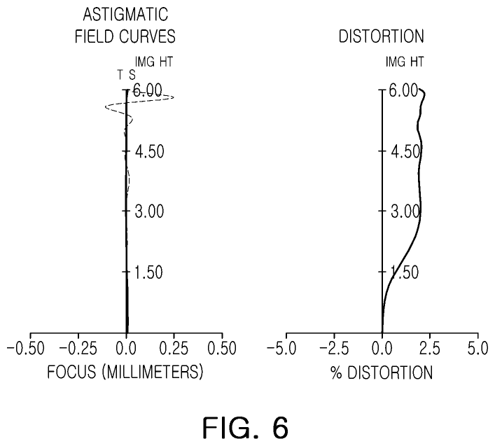

FIG. 5 is a configuration diagram of an optical imaging system according to a third embodiment of the present disclosure, ad FIG. 6 is a view illustrating aberration characteristics of the optical imaging system illustrated in FIG. 5.

Referring to FIG. 5, an optical imaging system 300 according to the third embodiment of the present disclosure may include a first lens 310, a second lens 320, a third lens 330, a fourth lens 340, a fifth lens 350, a sixth lens 360, a seventh lens 370, an eighth lens 380, and a ninth lens 390, and may further include a filter F and an image sensor (not shown).

The optical imaging system 300 according to the third embodiment of the present disclosure may form a focus on an image plane IP. The image plane IP may be a surface of the image sensor on which light is received.

Lens characteristics (a radius of curvature, a thickness of a lens or a distance between lenses, a refractive index, and an Abbe number) of each of the lenses and the filter may be as illustrated in Table 5.

TABLE 5

| Surface | | Radius of | Thickness or | Refractive | Abbe |
|---|---|---|---|---|---|
| No. | Element | Curvature | Distance | Index | No. |
| S1 | First | 3.214 | 0.379 | 1.510 | 62.0 |
| S2 | Lens | 3.582 | 0.105 | | |
| S3 | Second | 3.519 | 0.647 | 1.544 | 62.0 |
| S4 | Lens | 65.593 | 0.112 | | |
| S5 | Third | 29.289 | 0.260 | 1.720 | 29.9 |
| S6 | Lens | 5.036 | 0.000 | | |
| S7 | Fourth | 5.036 | 0.424 | 1.540 | 62.0 |
| S8 | Lens | 17.086 | 0.722 | | |
| S9 | Fifth | 100.502 | 0.425 | 1.720 | 31.5 |
| S10 | Lens | 24.794 | 0.479 | | |
| S11 | Sixth | 23.269 | 0.442 | 1.563 | 53.1 |
| S12 | Lens | 16.267 | 0.117 | | |
| S13 | Seventh | −5.998 | 0.284 | 1.614 | 25.9 |
| S14 | Lens | −9.019 | 0.112 | | |
| S15 | Eighth | 2.084 | 0.687 | 1.544 | 56.0 |
| S16 | Lens | 4.807 | 1.383 | | |
| S17 | Ninth | 38.319 | 0.511 | 1.535 | 55.7 |
| S18 | Lens | 2.412 | 0.201 | | |
| S19 | Filter | Infinity | 0.210 | 1.517 | 64.2 |
| S20 | | Infinity | 0.500 | | |
| S21 | Image | Infinity | | | |
| | Plane | | | | |

In the third embodiment of the present disclosure, the first lens 310 may have a positive refractive power, an object-side surface of the first lens 310 may have a convex shape in the paraxial region, and an image-side surface of the first lens 310 may have a concave shape in the paraxial region.

The second lens 320 may have a positive refractive power, an object-side surface of the second lens 320 may have a convex shape in the paraxial region, and an image-side surface of the second lens 320 may have a concave shape in the paraxial region.

The third lens 330 may have a negative refractive power, an object-side surface of the third lens 330 may have a convex shape in the paraxial region, and an image-side surface of the third lens 330 may have a concave shape in the paraxial region.

The fourth lens 340 may have a positive refractive power, an object-side surface of the fourth lens 340 may have a convex shape in the paraxial region, and an image-side surface of the fourth lens 340 may have a concave shape in the paraxial region.

The third lens 330 and the fourth lens 340 may be bonded to each other. For example, the image-side surface of the third lens 330 and the object-side surface of the fourth lens 340 may be bonded to each other.

The third lens 330 and the fourth lens 340 may be bonded to each other by an adhesive layer 335.

The fifth lens 350 may have a negative refractive power, an object-side surface of the fifth lens 350 may have a convex shape in the paraxial region, and an image-side surface of the fifth lens 350 may have a concave shape in the paraxial region.

The sixth lens 360 may have a negative refractive power, an object-side surface of the sixth lens 360 may have a convex shape in the paraxial region, and an image-side surface of the sixth lens 360 may have a concave shape in the paraxial region.

The seventh lens 370 may have a negative refractive power, an object-side surface of the seventh lens 370 may have a concave shape in the paraxial region, and an image-side surface of the seventh lens 370 may have a convex shape in the paraxial region.

The eighth lens 380 may have a positive refractive power, an object-side surface of the eighth lens 380 may have a convex shape in the paraxial region, and an image-side surface of the eighth lens 380 may have a concave shape in the paraxial region.

The ninth lens 390 may have a negative refractive power, an object-side surface of the ninth lens 390 may have a convex shape in the paraxial region, and an image-side surface of the ninth lens 390 may have a concave shape in the paraxial region.

In addition, either one or both of the eighth lens 380 and the ninth lens 390 may have at least one inflection point on at either one both of the object-side surface and the image-side surface.

Each of the surfaces of the first lens 310 to the ninth lens 390 may have aspherical coefficients as illustrated in Table 6. For example, the object-side surfaces and the image-side surfaces of the first lens 310 to the ninth lens 390 may all be aspherical.

TABLE 6

| | S1 | S2 | S3 | S4 | S5 | S6 |
|---|---|---|---|---|---|---|
| Conic | −6.398 | −12.057 | −4.462 | −38.770 | 60.569 | −0.040 |
| Constant (K) | | | | | | |
| 4th Coeffi- | 1.449E−02 | 9.849E−03 | 2.334E−04 | −1.307E−02 | −7.119E−03 | 2.752E−03 |
| cient (A) | | | | | | |
| 6th Coeffi- | −5.114E−03 | −1.269E−02 | −1.802E−02 | −7.778E−03 | −1.406E−02 | −3.944E−02 |
| cient (B) | | | | | | |
| 8th Coeffi- | −9.267E−03 | −1.371E−02 | 6.041E−02 | 4.934E−02 | 8.179E−02 | 2.505E−01 |
| cient (C) | | | | | | |
| 10th Coeffi- | 3.064E−02 | 8.623E−02 | −1.272E−01 | −1.235E−01 | −2.190E−01 | −1.006E+00 |
| cient (D) | | | | | | |
| 12th Coeffi- | −5.463E−02 | −1.999E−01 | 1.845E−01 | 2.021E−01 | 3.806E−01 | 2.716E+00 |
| cient (E) | | | | | | |
| 14th Coeffi- | 6.372E−02 | 2.865E−01 | −1.859E−01 | −2.287E−01 | −4.527E−01 | −5.158E+00 |
| cient (F) | | | | | | |
| 16th Coeffi- | −5.159E−02 | −2.765E−01 | 1.332E−01 | 1.835E−01 | 3.776E−01 | 7.084E+00 |
| cient (G) | | | | | | |
| 18th Coeffi- | 2.977E−02 | 1.858E−01 | −6.871E−02 | −1.057E−01 | −2.237E−01 | −7.118E+00 |
| cient (H) | | | | | | |
| 20th Coeffi- | −1.235E−02 | −8.808E−02 | 2.554E−02 | 4.393E−02 | 9.430E−02 | 5.228E+00 |
| cient (J) | | | | | | |
| 22nd Coeffi- | 3.650E−03 | 2.932E−02 | −6.772E−03 | −1.306E−02 | −2.803E−02 | −2.769E+00 |
| cient (L) | | | | | | |
| 24th Coeffi- | −7.503E−04 | −6.702E−03 | 1.248E−03 | 2.715E−03 | 5.727E−03 | 1.028E+00 |
| cient (M) | | | | | | |
| 26th Coeffi- | 1.018E−04 | 1.001E−03 | −1.517E−04 | −3.755E−04 | −7.646E−04 | −2.532E−01 |
| cient (N) | | | | | | |
| 28th Coeffi- | −8.183E−06 | −8.793E−05 | 1.092E−05 | 3.109E−05 | 5.999E−05 | 3.712E−02 |
| cient (O) | | | | | | |
| 30th Coeffi- | 2.947E−07 | 3.441E−06 | −3.525E−07 | −1.166E−06 | −2.095E−06 | −2.448E−03 |
| cient (P) | | | | | | |
| | S7 | S8 | S9 | S10 | S11 | S12 |
| Conic | −0.040 | −65.560 | −99.000 | 46.248 | 96.342 | −42.929 |
| Constant (K) | | | | | | |
| 4th Coeffi- | 2.752E−03 | −2.741E−03 | −2.972E−02 | −3.287E−02 | −8.733E−02 | −1.713E−01 |
| cient (A) | | | | | | |
| 6th Coeffi- | −3.944E−02 | 1.891E−03 | 1.372E−02 | 3.930E−02 | 1.588E−01 | 2.738E−01 |
| cient (B) | | | | | | |
| 8th Coeffi- | 2.505E−01 | 7.774E−03 | −3.887E−02 | −1.032E−01 | −2.945E−01 | −4.244E−01 |
| cient (C) | | | | | | |
| 10th Coeffi- | −1.006E+00 | −4.540E−02 | 3.555E−02 | 1.738E−01 | 4.152E−01 | 4.806E−01 |
| cient (D) | | | | | | |
| 12th Coeffi- | 2.716E+00 | 1.213E−01 | 4.265E−02 | −2.032E−01 | −4.386E−01 | −4.067E−01 |
| cient (E) | | | | | | |
| 14th Coeffi- | −5.158E+00 | −2.013E−01 | −1.741E−01 | 1.705E−01 | 3.464E−01 | 2.663E−01 |
| cient (F) | | | | | | |
| 16th Coeffi- | 7.084E+00 | 2.232E−01 | 2.588E−01 | −1.045E−01 | −2.042E−01 | −1.357E−01 |
| cient (G) | | | | | | |
| 18th Coeffi- | −7.118E+00 | −1.712E−01 | −2.343E−01 | 4.691E−02 | 8.958E−02 | 5.303E−02 |
| cient (H) | | | | | | |
| 20th Coeffi- | 5.228E+00 | 9.189E−02 | 1.426E−01 | −1.535E−02 | −2.907E−02 | −1.557E−02 |
| cient (J) | | | | | | |
| 22nd Coeffi- | −2.769E+00 | −3.439E−02 | −5.966E−02 | 3.597E−03 | 6.876E−03 | 3.350E−03 |
| cient (L) | | | | | | |
| 24th Coeffi- | 1.028E+00 | 8.775E−03 | 1.699E−02 | −5.844E−04 | −1.152E−03 | −5.103E−04 |
| cient (M) | | | | | | |
| 26th Coeffi- | −2.532E−01 | −1.453E−03 | −3.146E−03 | 6.217E−05 | 1.293E−04 | 5.197E−05 |
| cient (N) | | | | | | |
| 28th Coeffi- | 3.712E−02 | 1.404E−04 | 3.417E−04 | −3.873E−06 | −8.721E−06 | −3.167E−06 |
| cient (O) | | | | | | |
| 30th Coeffi- | −2.448E−03 | −6.001E−06 | −1.650E−05 | 1.066E−07 | 2.666E−07 | 8.706E−08 |
| cient (P) | | | | | | |

| | S13 | S14 | S15 | S16 | S17 | S18 |
|---|---|---|---|---|---|---|
| Conic | 2.381 | 4.110 | −5.924 | −7.944 | 9.465 | −9.720 |
| Constant (K) | | | | | | |
| 4th Coeffi- | 3.650E−02 | 4.417E−02 | −4.045E−03 | 1.111E−02 | −1.187E−01 | −6.149E−02 |
| cient (A) | | | | | | |
| 6th Coeffi- | −4.929E−03 | −8.701E−02 | −2.561E−03 | 1.158E−02 | 6.962E−02 | 3.760E−02 |
| cient (B) | | | | | | |
| 8th Coeffi- | −4.522E−02 | 9.903E−02 | 4.735E−03 | −1.917E−02 | −3.239E−02 | −1.671E−02 |
| cient (C) | | | | | | |
| 10th Coeffi- | 5.023E−02 | −8.382E−02 | −6.882E−03 | 1.227E−02 | 1.087E−02 | 5.225E−03 |
| cient (D) | | | | | | |
| 12th Coeffi- | −2.246E−02 | 5.462E−02 | 5.339E−03 | −4.843E−03 | −2.563E−03 | −1.169E−03 |
| cient (E) | | | | | | |
| 14th Coeffi- | 3.245E−03 | −2.670E−02 | −2.558E−03 | 1.294E−03 | 4.317E−04 | 1.892E−04 |
| cient (F) | | | | | | |
| 16th Coeffi- | 8.495E−04 | 9.512E−03 | 8.081E−04 | −2.433E−04 | −5.284E−05 | −2.235E−05 |
| cient (G) | | | | | | |
| 18th Coeffi- | −3.309E−04 | −2.435E−03 | −1.745E−04 | 3.284E−05 | 4.747E−06 | 1.930E−06 |
| cient (H) | | | | | | |
| 20th Coeffi- | −1.431E−05 | 4.443E−04 | 2.620E−05 | −3.196E−06 | −3.128E−07 | −1.212E−07 |
| cient (J) | | | | | | |
| 22nd Coeffi- | 2.692E−05 | −5.710E−05 | −2.738E−06 | 2.225E−07 | 1.493E−08 | 5.456E−09 |
| cient (L) | | | | | | |
| 24th Coeffi- | −6.365E−06 | 5.040E−06 | 1.953E−07 | −1.080E−08 | −5.021E−10 | −1.711E−10 |
| cient (M) | | | | | | |
| 26th Coeffi- | 7.330E−07 | −2.906E−07 | −9.078E−09 | 3.473E−10 | 1.127E−11 | 3.542E−12 |
| cient (N) | | | | | | |
| 28th Coeffi- | −4.346E−08 | 9.849E−09 | 2.478E−10 | −6.645E−12 | −1.515E−13 | −4.349E−14 |
| cient (O) | | | | | | |
| 30th Coeffi- | 1.064E−09 | −1.487E−10 | −3.013E−12 | 5.721E−14 | 9.223E−16 | 2.395E−16 |
| cient (P) | | | | | | |

In addition, the optical imaging system 300 according to the third embodiment of the present disclosure may have the aberration characteristics illustrated in FIG. 6.

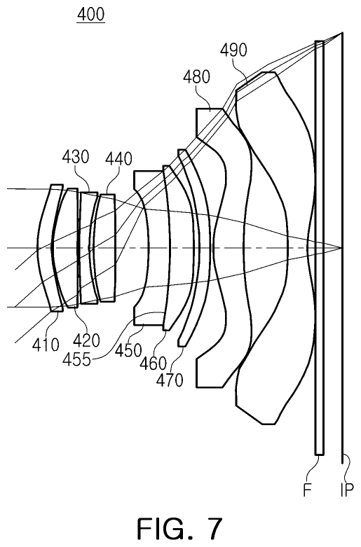

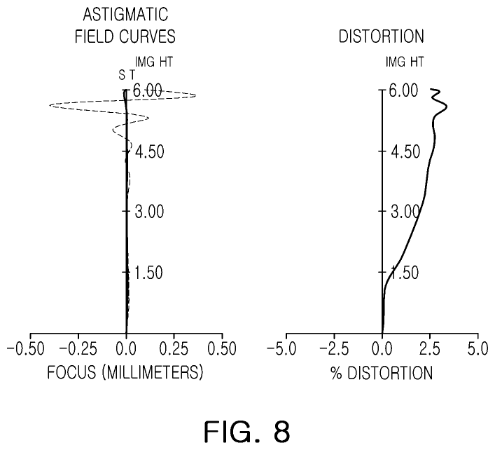

FIG. 7 is a configuration diagram of an optical imaging system according to a fourth embodiment of the present disclosure, and FIG. 8 is a view illustrating aberration characteristics of the optical imaging system illustrated in FIG. 7.

Referring to FIG. 7, an optical imaging system 400 according to the fourth embodiment of the present disclosure may include a first lens 410, a second lens 420, a third lens 430, a fourth lens 440, a fifth lens 450, a sixth lens 460, a seventh lens 470, an eighth lens 480, and a ninth lens 490, and may further include a filter F and an image sensor (not shown).

The optical imaging system 400 according to the fourth embodiment of the present disclosure may form a focus on an image plane IP. The image plane IP may be a surface of the image sensor on which light is received.

Lens characteristics (a radius of curvature, a thickness of a lens or a distance between lenses, a refractive index, and an Abbe number) of each of the lenses and the filter may be as illustrated in Table 7.

TABLE 7

| Surface | | Radius of | Thickness or | Refractive | Abbe |
|---|---|---|---|---|---|
| No. | Element | Curvature | Distance | Index | No. |
| S1 | First | 3.160 | 0.379 | 1.524 | 53.8 |
| S2 | Lens | 3.099 | 0.032 | | |
| S3 | Second | 3.105 | 0.654 | 1.603 | 61.2 |
| S4 | Lens | 33.514 | 0.045 | | |
| S5 | Third | 22.248 | 0.260 | 1.719 | 29.9 |
| S6 | Lens | 4.851 | 0.114 | | |
| S7 | Fourth | 6.029 | 0.572 | 1.628 | 58.9 |
| S8 | Lens | 140.947 | 0.891 | | |
| S9 | Fifth | −8.091 | 0.567 | 1.720 | 32.0 |
| S10 | Lens | −13.827 | 0.000 | | |
| S11 | Sixth | −13.827 | 0.641 | 1.558 | 52.0 |
| S12 | Lens | −25.445 | 0.136 | | |
| S13 | Seventh | −5.957 | 0.291 | 1.614 | 25.9 |
| S14 | Lens | −8.712 | 0.086 | | |
| S15 | Eighth | 2.973 | 0.803 | 1.544 | 56.0 |
| S16 | Lens | 12.931 | 1.167 | | |
| S17 | Ninth | 34.856 | 0.530 | 1.535 | 55.7 |
| S18 | Lens | 2.387 | 0.220 | | |
| S19 | Filter | Infinity | 0.212 | 1.517 | 64.2 |
| S20 | | Infinity | 0.500 | | |
| S21 | Image | Infinity | | | |
| | Plane | | | | |

In the fourth embodiment of the present disclosure, the first lens 410 may have a positive refractive power, an object-side surface of the first lens 410 may have a convex shape in the paraxial region, and an image-side surface of the first lens 410 may have a concave shape in the paraxial region.

The second lens 420 may have a positive refractive power, an object-side surface of the second lens 420 may have a convex shape in the paraxial region, and an image-side surface of the second lens 420 may have a concave shape in the paraxial region.

The third lens 430 may have a negative refractive power, an object-side surface of the third lens 430 may have a convex shape in the paraxial region, and an image-side surface of the third lens 430 may have a concave shape in the paraxial region.

The fourth lens 440 may have a positive refractive power, an object-side surface of the fourth lens 440 may have a convex shape in the paraxial region, and an image-side surface of the fourth lens 440 may have a concave shape in the paraxial region.

The fifth lens 450 may have a negative refractive power, an object-side surface of the fifth lens 450 may have a concave shape in the paraxial region, and an image-side surface of the fifth lens 450 may have a convex shape in the paraxial region.

The sixth lens 460 may have a negative refractive power, an object-side surface of the sixth lens 460 may have a concave shape in the paraxial region, and an image-side surface of the sixth lens 460 may have a convex shape in the paraxial region.

The fifth lens 450 and the sixth lens 460 may be bonded to each other. For example, the image-side surface of the fifth lens 450 and the object-side surface of the sixth lens 460 may be bonded to each other.

The fifth lens 450 and the sixth lens 460 may be bonded to each other by an adhesive layer 455.

The seventh lens 470 may have a negative refractive power, an object-side surface of the seventh lens 470 may have a concave shape in the paraxial region, and an image-side surface of the seventh lens 470 may have a convex shape in the paraxial region.

The eighth lens 480 may have a positive refractive power, an object-side surface of the eighth lens 480 may have a convex shape in the paraxial region, and an image-side surface of the eighth lens 480 may have a concave shape in the paraxial region.

The ninth lens 490 may have a negative refractive power, an object-side surface of the ninth lens 490 may have a convex shape in the paraxial region, and an image-side surface of the ninth lens 490 may have a concave shape in the paraxial region.

In addition, either one or both of the eighth lens 480 and the ninth lens 490 may have at least one inflection point on either one or both of the object-side surface and the image-side surface.

Each of the surfaces of the first lens 410 to the ninth lens 490 may have aspherical coefficients as illustrated in Table 8. For example, the object-side surfaces and the image-side surfaces of the first lens 410 to the fourth lens 440 and the seventh lens 470 to the ninth lens 490 may all be aspherical. The object-side surface of the fifth lens 450 and the image-side surface of the sixth lens 460 may be aspherical, and the image-side surface of the fifth lens 450 and the object-side surface of the sixth lens 460 may be spherical.

TABLE 8

| | S1 | S2 | S3 | S4 | S5 | S6 |
|---|---|---|---|---|---|---|
| Conic | −6.693 | −12.136 | −4.621 | 39.280 | 52.305 | −0.128 |
| Constant (K) | | | | | | |
| 4th Coeffi- | 1.478E−02 | 2.774E−02 | 7.450E−03 | −7.802E−03 | −1.148E−02 | −7.444E−03 |
| cient (A) | | | | | | |
| 6th Coeffi- | 8.891E−03 | −4.180E−02 | −1.196E−02 | 1.402E−02 | 2.808E−02 | 2.811E−02 |
| cient (B) | | | | | | |
| 8th Coeffi- | −7.047E−02 | 1.968E−02 | −5.647E−03 | −3.557E−02 | −7.476E−02 | −1.531E−01 |
| cient (C) | | | | | | |
| 10th Coeffi- | 1.793E−01 | 4.833E−03 | 2.433E−02 | 5.070E−02 | 1.453E−01 | 6.601E−01 |
| cient (D) | | | | | | |
| 12th Coeffi- | −2.925E−01 | −4.767E−02 | −4.275E−02 | −5.889E−02 | −2.050E−01 | −1.994E+00 |
| cient (E) | | | | | | |
| 14th Coeffi- | 3.263E−01 | 1.048E−01 | 5.813E−02 | 6.243E−02 | 2.136E−01 | 4.240E+00 |
| cient (F) | | | | | | |
| 16th Coeffi- | −2.571E−01 | −1.256E−01 | −5.236E−02 | −5.530E−02 | −1.640E−01 | −6.413E+00 |
| cient (G) | | | | | | |
| 18th Coeffi- | 1.453E−01 | 9.521E−02 | 3.067E−02 | 3.689E−02 | 9.204E−02 | 6.948E+00 |
| cient (H) | | | | | | |
| 20th Coeffi- | −5.910E−02 | −4.852E−02 | −1.193E−02 | −1.757E−02 | −3.725E−02 | −5.393E+00 |
| cient (J) | | | | | | |
| 22nd Coeffi- | 1.713E−02 | 1.697E−02 | 3.115E−03 | 5.821E−03 | 1.067E−02 | 2.971E+00 |
| cient (L) | | | | | | |
| 24th Coeffi- | −3.449E−03 | −4.029E−03 | −5.382E−04 | −1.304E−03 | −2.096E−03 | −1.132E+00 |
| cient (M) | | | | | | |
| 26th Coeffi- | 4.575E−04 | 6.219E−04 | 5.891E−05 | 1.878E−04 | 2.679E−04 | 2.839E−01 |
| cient (N) | | | | | | |
| 28th Coeffi- | −3.593E−05 | −5.627E−05 | −3.682E−06 | −1.566E−05 | −2.001E−05 | −4.209E−02 |
| cient (O) | | | | | | |
| 30th Coeffi- | 1.263E−06 | 2.265E−06 | 9.949E−08 | 5.740E−07 | 6.614E−07 | 2.795E−03 |
| cient (P) | | | | | | |

| | S7 | S8 | S9 | S10 | S11 | S12 |
|---|---|---|---|---|---|---|
| Conic | −0.040 | 99.000 | −36.506 | 0.000 | 0.000 | −98.093 |
| Constant (K) | | | | | | |
| 4th Coeffi- | 2.671E−03 | −2.870E−03 | −2.923E−02 | 0.000E+00 | 0.000E+00 | −4.782E−02 |
| cient (A) | | | | | | |
| 6th Coeffi- | −3.752E−02 | 1.608E−02 | 1.457E−02 | 0.000E+00 | 0.000E+00 | 3.707E−02 |
| cient (B) | | | | | | |
| 8th Coeffi- | 2.336E−01 | −8.343E−02 | −4.345E−02 | 0.000E+00 | 0.000E+00 | −1.047E−01 |
| cient (C) | | | | | | |
| 10th Coeffi- | −9.199E−01 | 2.545E−01 | 1.067E−01 | 0.000E+00 | 0.000E+00 | 1.754E−01 |
| cient (D) | | | | | | |
| 12th Coeffi- | 2.434E+00 | −5.166E−01 | −1.932E−01 | 0.000E+00 | 0.000E+00 | −1.658E−01 |
| cient (E) | | | | | | |
| 14th Coeffi- | −4.531E+00 | 7.218E−01 | 2.473E−01 | 0.000E+00 | 0.000E+00 | 9.745E−02 |
| cient (F) | | | | | | |
| 16th Coeffi- | 6.099E+00 | −7.094E−01 | −2.261E−01 | 0.000E+00 | 0.000E+00 | −3.770E−02 |
| cient (G) | | | | | | |
| 18th Coeffi- | −6.007E+00 | 4.963E−01 | 1.488E−01 | 0.000E+00 | 0.000E+00 | 9.827E−03 |
| cient (H) | | | | | | |
| 20th Coeffi- | 4.325E+00 | −2.474E−01 | −7.054E−02 | 0.000E+00 | 0.000E+00 | −1.719E−03 |
| cient (J) | | | | | | |
| 22nd Coeffi- | −2.246E+00 | 8.698E−02 | 2.378E−02 | 0.000E+00 | 0.000E+00 | 1.939E−04 |
| cient (L) | | | | | | |
| 24th Coeffi- | 8.173E−01 | −2.102E−02 | −5.552E−03 | 0.000E+00 | 0.000E+00 | −1.250E−05 |
| cient (M) | | | | | | |
| 26th Coeffi- | −1.973E−01 | 3.317E−03 | 8.503E−04 | 0.000E+00 | 0.000E+00 | 2.620E−07 |
| cient (N) | | | | | | |
| 28th Coeffi- | 2.836E−02 | −3.072E−04 | −7.670E−05 | 0.000E+00 | 0.000E+00 | 1.653E−08 |
| cient (O) | | | | | | |
| 30th Coeffi- | −1.833E−03 | 1.265E−05 | 3.087E−06 | 0.000E+00 | 0.000E+00 | −8.586E−10 |
| cient (P) | | | | | | |

| | S13 | S14 | S15 | S16 | S17 | S18 |
|---|---|---|---|---|---|---|
| Conic | 0.829 | 5.472 | −5.896 | −2.605 | 27.868 | −7.776 |
| Constant (K) | | | | | | |
| 4th Coeffi- | 3.912E−02 | 5.954E−02 | 2.339E−02 | 7.128E−03 | −1.193E−01 | −7.257E−02 |
| cient (A) | | | | | | |
| 6th Coeffi- | −3.645E−02 | −1.162E−01 | −5.230E−02 | 2.127E−02 | 7.337E−02 | 4.593E−02 |
| cient (B) | | | | | | |
| 8th Coeffi- | −7.668E−02 | 8.653E−02 | 5.188E−02 | −2.760E−02 | −3.532E−02 | −1.960E−02 |
| cient (C) | | | | | | |
| 10th Coeffi- | 2.065E−01 | −2.185E−02 | −3.652E−02 | 1.645E−02 | 1.175E−02 | 5.648E−03 |
| cient (D) | | | | | | |
| 12th Coeffi- | −2.163E−01 | −1.030E−02 | 1.888E−02 | −6.163E−03 | −2.696E−03 | −1.142E−03 |
| cient (E) | | | | | | |
| 14th Coeffi- | 1.330E−01 | 1.059E−02 | −7.205E−03 | 1.577E−03 | 4.401E−04 | 1.667E−04 |
| cient (F) | | | | | | |
| 16th Coeffi- | −5.382E−02 | −4.208E−03 | 2.019E−03 | −2.857E−04 | −5.243E−05 | −1.784E−05 |
| cient (G) | | | | | | |
| 18th Coeffi- | 1.507E−02 | 9.973E−04 | −4.124E−04 | 3.723E−05 | 4.609E−06 | 1.406E−06 |
| cient (H) | | | | | | |
| 20th Coeffi- | −2.977E−03 | −1.537E−04 | 6.087E−05 | −3.496E−06 | −2.985E−07 | −8.122E−08 |
| cient (J) | | | | | | |
| 22nd Coeffi- | 4.155E−04 | 1.565E−05 | −6.394E−06 | 2.343E−07 | 1.403E−08 | 3.386E−09 |
| cient (L) | | | | | | |
| 24th Coeffi- | −4.018E−05 | −1.030E−06 | 4.646E−07 | −1.092E−08 | −4.647E−10 | −9.890E−11 |
| cient (M) | | | | | | |
| 26th Coeffi- | 2.564E−06 | 4.088E−08 | −2.215E−08 | 3.357E−10 | 1.026E−11 | 1.916E−12 |
| cient (N) | | | | | | |
| 28th Coeffi- | −9.729E−08 | −8.316E−10 | 6.225E−10 | −6.119E−12 | −1.354E−13 | −2.209E−14 |
| cient (O) | | | | | | |
| 30th Coeffi- | 1.663E−09 | 5.314E−12 | −7.805E−12 | 5.005E−14 | 8.068E−16 | 1.146E−16 |
| cient (P) | | | | | | |

In addition, the optical imaging system 400 according to the fourth embodiment of the present disclosure may have the aberration characteristics illustrated in FIG. 8.

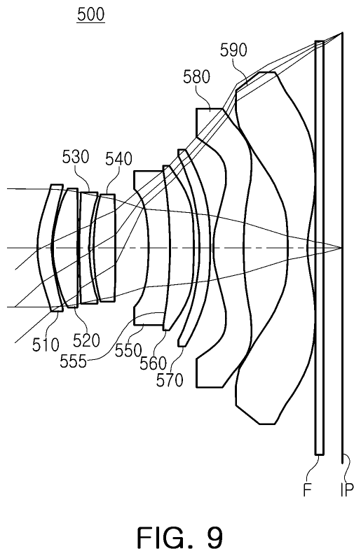

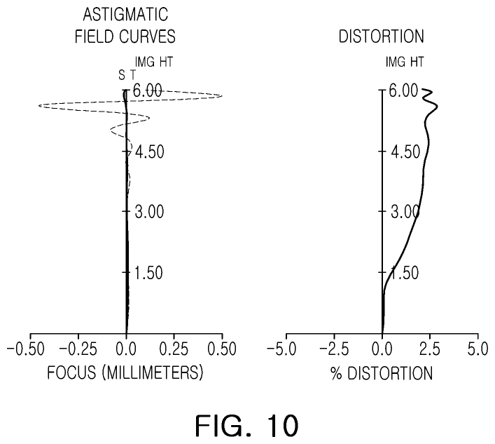

FIG. 9 is a configuration diagram of an optical imaging system according to a fifth embodiment of the present disclosure, and FIG. 10 is a view illustrating aberration characteristics of the optical imaging system illustrated in FIG. 9.

Referring to FIG. 9, an optical imaging system 500 according to the fifth embodiment of the present disclosure may include a first lens 510, a second lens 520, a third lens 530, a fourth lens 540, a fifth lens 550, a sixth lens 560, a seventh lens 570, an eighth lens 580, and a ninth lens 590, and may further include a filter F and an image sensor (not shown).

The optical imaging system 500 according to the fifth embodiment of the present disclosure may form a focus on an image plane IP. The image plane IP may be a surface of the image sensor on which light is received.

Lens characteristics (a radius of curvature, a thickness of a lens or a distance between lenses, a refractive index, and an Abbe number) of each of the lenses and the filter may be as illustrated in Table 9.

TABLE 9

| Surface | | Radius of | Thickness or | Refractive | Abbe |
|---|---|---|---|---|---|
| No. | Element | Curvature | Distance | Index | No. |
| S1 | First | 3.160 | 0.379 | 1.525 | 53.7 |
| S2 | Lens | 3.099 | 0.032 | | |
| S3 | Second | 3.105 | 0.654 | 1.603 | 61.2 |
| S4 | Lens | 33.353 | 0.044 | | |
| S5 | Third | 22.231 | 0.260 | 1.719 | 29.9 |
| S6 | Lens | 4.845 | 0.114 | | |
| S7 | Fourth | 6.038 | 0.572 | 1.628 | 58.9 |
| S8 | Lens | 156.452 | 0.890 | | |
| S9 | Fifth | −8.103 | 0.567 | 1.720 | 32.0 |
| S10 | Lens | −13.690 | 0.000 | | |
| S11 | Sixth | −13.690 | 0.640 | 1.558 | 52.7 |
| S12 | Lens | −25.577 | 0.135 | | |
| S13 | Seventh | −5.955 | 0.291 | 1.614 | 25.9 |
| S14 | Lens | −8.697 | 0.086 | | |
| S15 | Eighth | 2.974 | 0.803 | 1.544 | 56.0 |
| S16 | Lens | 12.977 | 1.168 | | |
| S17 | Ninth | 34.882 | 0.532 | 1.535 | 55.7 |
| S18 | Lens | 2.380 | 0.221 | | |
| S19 | Filter | Infinity | 0.212 | 1.517 | 64.2 |
| S20 | | Infinity | 0.501 | | |
| S21 | Image | Infinity | | | |
| | Plane | | | | |

In the fifth embodiment of the present disclosure, the first lens 510 may have a positive refractive power, an object-side surface of the first lens 510 may have a convex shape in the paraxial region, and an image-side surface of the first lens 510 may have a concave shape in the paraxial region.

The second lens 520 may have a positive refractive power, an object-side surface of the second lens 520 may have a convex shape in the paraxial region, and an image-side surface of the second lens 520 may have a concave shape in the paraxial region.

The third lens 530 may have a negative refractive power, an object-side surface of the third lens 530 may have a convex shape in the paraxial region, and an image-side surface of the third lens 530 may have a concave shape in the paraxial region.

The fourth lens 540 may have a positive refractive power, an object-side surface of the fourth lens 540 may have a convex shape in the paraxial region, and an image-side surface of the fourth lens 540 may have a concave shape in the paraxial region.

The fifth lens 550 may have a negative refractive power, an object-side surface of the fifth lens 550 may have a concave shape in the paraxial region, and an image-side surface of the fifth lens 550 may have a convex shape in the paraxial region.

The sixth lens 560 may have a negative refractive power, an object-side surface of the sixth lens 560 may have a concave shape in the paraxial region, and an image-side surface of the sixth lens 560 may have a convex shape in the paraxial region.

The fifth lens 550 and the sixth lens 560 may be bonded to each other. For example, the image-side surface of the fifth lens 550 and the object-side surface of the sixth lens 560 may be bonded to each other.

The fifth lens 550 and the sixth lens 560 may be bonded to each other by an adhesive layer 555.

The seventh lens 570 may have a negative refractive power, an object-side surface of the seventh lens 570 may have a concave shape in the paraxial region, and an image-side surface of the seventh lens 570 may have a convex shape in the paraxial region.

The eighth lens 580 may have a positive refractive power, an object-side surface of the eighth lens 580 may have a convex shape in the paraxial region, and an image-side surface of the eighth lens 580 may have a concave shape in the paraxial region.

The ninth lens 590 may have a negative refractive power, an object-side surface of the ninth lens 590 may have a convex shape in the paraxial region, and an image-side surface of the ninth lens 590 may have a concave shape in the paraxial region.

In addition, either one or both of the eighth lens 580 and the ninth lens 590 may have at least one inflection point on either one or both of the object-side surface and the image-side surface.

Each of the surfaces of the first lens 510 to the ninth lens 590 may have aspherical coefficients as illustrated in Table 10. For example, the object-side surfaces and the image-side surfaces of the first lens 510 to the ninth lens 590 may all be aspherical.

TABLE 10

| | S1 | S2 | S3 | S4 | S5 | S6 |
|---|---|---|---|---|---|---|
| Conic | −6.696 | −12.134 | −4.622 | 39.349 | 52.376 | −0.130 |
| Constant (K) | | | | | | |
| 4th Coeffi- | 1.496E−02 | 2.816E−02 | 8.090E−03 | −8.077E−03 | −1.177E−02 | −7.432E−03 |
| cient (A) | | | | | | |
| 6th Coeffi- | 7.425E−03 | −4.827E−02 | −1.938E−02 | 1.608E−02 | 3.007E−02 | 2.804E−02 |
| cient (B) | | | | | | |
| 8th Coeffi- | −6.518E−02 | 4.990E−02 | 2.723E−02 | −4.183E−02 | −8.075E−02 | −1.537E−01 |
| cient (C) | | | | | | |
| 10th Coeffi- | 1.684E−01 | −6.612E−02 | −5.250E−02 | 6.095E−02 | 1.552E−01 | 6.664E−01 |
| cient (D) | | | | | | |
| 12th Coeffi- | −2.780E−01 | 5.281E−02 | 6.684E−02 | −6.911E−02 | −2.146E−01 | −2.019E+00 |
| cient (E) | | | | | | |
| 14th Coeffi- | 3.130E−01 | 1.097E−02 | −4.513E−02 | 6.912E−02 | 2.191E−01 | 4.304E+00 |
| cient (F) | | | | | | |
| 16th Coeffi- | −2.483E−01 | −6.502E−02 | 1.487E−02 | −5.843E−02 | −1.657E−01 | −6.522E+00 |
| cient (G) | | | | | | |
| 18th Coeffi- | 1.411E−01 | 6.735E−02 | −3.245E−04 | 3.806E−02 | 9.206E−02 | 7.077E+00 |
| cient (H) | | | | | | |
| 20th Coeffi- | −5.764E−02 | −3.931E−02 | −1.732E−03 | −1.796E−02 | −3.707E−02 | −5.502E+00 |
| cient (J) | | | | | | |
| 22nd Coeffi- | 1.677E−02 | 1.478E−02 | 7.310E−04 | 5.938E−03 | 1.059E−02 | 3.036E+00 |
| cient (L) | | | | | | |
| 24th Coeffi- | −3.386E−03 | −3.666E−03 | −1.520E−04 | −1.331E−03 | −2.081E−03 | −1.159E+00 |
| cient (M) | | | | | | |
| 26th Coeffi- | 4.504E−04 | 5.814E−04 | 1.765E−05 | 1.920E−04 | 2.662E−04 | 2.912E−01 |
| cient (N) | | | | | | |
| 28th Coeffi- | −3.545E−05 | −5.355E−05 | −1.068E−06 | −1.605E−05 | −1.990E−05 | −4.325E−02 |
| cient (O) | | | | | | |
| 30th Coeffi- | 1.249E−06 | 2.180E−06 | 2.510E−08 | 5.897E−07 | 6.587E−07 | 2.877E−03 |
| cient (P) | | | | | | |
| | S7 | S8 | S9 | S10 | S11 | S12 |
| Conic | −0.040 | 99.000 | −36.648 | 0.386 | 0.386 | −95.610 |
| Constant (K) | | | | | | |
| 4th Coeffi- | 2.671E−03 | −3.113E−03 | −2.969E−02 | −2.967E−03 | −2.967E−03 | −4.693E−02 |
| cient (A) | | | | | | |
| 6th Coeffi- | −3.752E−02 | 1.756E−02 | 1.970E−02 | 2.171E−02 | 2.171E−02 | 3.166E−02 |
| cient (B) | | | | | | |
| 8th Coeffi- | 2.336E−01 | −8.894E−02 | −6.451E−02 | −6.415E−02 | −6.415E−02 | −9.160E−02 |
| cient (C) | | | | | | |
| 10th Coeffi- | −9.199E−01 | 2.687E−01 | 1.558E−01 | 1.079E−01 | 1.079E−01 | 1.580E−01 |
| cient (D) | | | | | | |
| 12th Coeffi- | 2.434E+00 | −5.422E−01 | −2.661E−01 | −1.162E−01 | −1.162E−01 | −1.513E−01 |
| cient (E) | | | | | | |
| 14th Coeffi- | −4.531E+00 | 7.540E−01 | 3.196E−01 | 8.478E−02 | 8.478E−02 | 8.946E−02 |
| cient (F) | | | | | | |
| 16th Coeffi- | 6.099E+00 | −7.382E−01 | −2.749E−01 | −4.319E−02 | −4.319E−02 | −3.465E−02 |
| cient (G) | | | | | | |
| 18th Coeffi- | −6.007E+00 | 5.146E−01 | 1.712E−01 | 1.558E−02 | 1.558E−02 | 9.011E−03 |
| cient (H) | | | | | | |
| 20th Coeffi- | 4.325E+00 | −2.557E−01 | −7.717E−02 | −3.977E−03 | −3.977E−03 | −1.565E−03 |
| cient (J) | | | | | | |
| 22nd Coeffi- | −2.246E+00 | 8.965E−02 | 2.489E−02 | 7.058E−04 | 7.058E−04 | 1.737E−04 |
| cient (L) | | | | | | |
| 24th Coeffi- | 8.173E−01 | −2.161E−02 | −5.582E−03 | −8.345E−05 | −8.345E−05 | −1.073E−05 |
| cient (M) | | | | | | |
| 26th Coeffi- | −1.973E−01 | 3.402E−03 | 8.238E−04 | 6.021E−06 | 6.021E−06 | 1.648E−07 |
| cient (N) | | | | | | |
| 28th Coeffi- | 2.836E−02 | −3.145E−04 | −7.171E−05 | −2.163E−07 | −2.163E−07 | 1.935E−08 |
| cient (O) | | | | | | |
| 30th Coeffi- | −1.833E−03 | 1.293E−05 | 2.785E−06 | 1.808E−09 | 1.808E−09 | −8.864E−10 |
| cient (P) | | | | | | |
| | S13 | S14 | S15 | S16 | S17 | S18 |
| Conic | 0.822 | 5.488 | −5.909 | −2.780 | 27.882 | −7.781 |
| Constant (K) | | | | | | |
| 4th Coeffi- | 3.970E−02 | 5.949E−02 | 2.375E−02 | 7.302E−03 | −1.196E−01 | −7.232E−02 |
| cient (A) | | | | | | |
| 6th Coeffi- | −3.981E−02 | −1.160E−01 | −5.310E−02 | 2.131E−02 | 7.382E−02 | 4.563E−02 |
| cient (B) | | | | | | |
| 8th Coeffi- | −6.851E−02 | 8.571E−02 | 5.252E−02 | −2.786E−02 | −3.559E−02 | −1.942E−02 |
| cient (C) | | | | | | |
| 10th Coeffi- | 1.955E−01 | −2.064E−02 | −3.682E−02 | 1.669E−02 | 1.184E−02 | 5.579E−03 |
| cient (D) | | | | | | |
| 12th Coeffi- | −2.071E−01 | −1.124E−02 | 1.897E−02 | −6.273E−03 | −2.712E−03 | −1.125E−03 |
| cient (E) | | | | | | |
| 14th Coeffi- | 1.278E−01 | 1.102E−02 | −7.228E−03 | 1.609E−03 | 4.419E−04 | 1.639E−04 |
| cient (F) | | | | | | |
| 16th Coeffi- | −5.180E−02 | −4.337E−03 | 2.024E−03 | −2.922E−04 | −5.251E−05 | −1.750E−05 |
| cient (G) | | | | | | |
| 18th Coeffi- | 1.450E−02 | 1.023E−03 | −4.132E−04 | 3.814E−05 | 4.601E−06 | 1.377E−06 |
| cient (H) | | | | | | |
| 20th Coeffi- | −2.862E−03 | −1.572E−04 | 6.098E−05 | −3.587E−06 | −2.969E−07 | −7.946E−08 |
| cient (J) | | | | | | |
| 22nd Coeffi- | 3.989E−04 | 1.596E−05 | −6.403E−06 | 2.407E−07 | 1.391E−08 | 3.309E−09 |
| cient (L) | | | | | | |
| 24th Coeffi- | −3.850E−05 | −1.046E−06 | 4.652E−07 | −1.123E−08 | −4.590E−10 | −9.656E−11 |
| cient (M) | | | | | | |
| 26th Coeffi- | 2.453E−06 | 4.129E−08 | −2.217E−08 | 3.456E−10 | 1.010E−11 | 1.869E−12 |
| cient (N) | | | | | | |
| 28th Coeffi- | −9.288E−08 | −8.298E−10 | 6.227E−10 | −6.307E−12 | −1.328E−13 | −2.153E−14 |
| cient (O) | | | | | | |
| 30th Coeffi- | 1.585E−09 | 5.082E−12 | −7.804E−12 | 5.163E−14 | 7.889E−16 | 1.116E−16 |
| cient (P) | | | | | | |

In addition, the optical imaging system 500 according to the fifth embodiment of the present disclosure may have the aberration characteristics illustrated in FIG. 10.

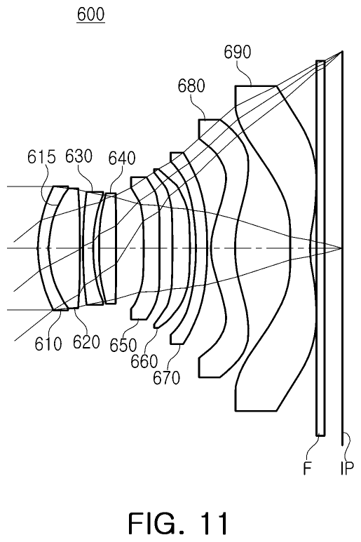

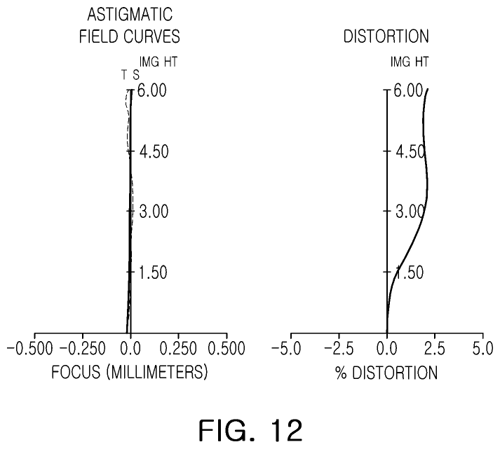

FIG. 11 is a configuration diagram of an optical imaging system according to a sixth embodiment of the present disclosure, and FIG. 12 is a view illustrating aberration characteristics of the optical imaging system illustrated in FIG. 11.

Referring to FIG. 11, an optical imaging system 600 according to the sixth embodiment of the present disclosure may include a first lens 610, a second lens 620, a third lens 630, a fourth lens 640, a fifth lens 650, a sixth lens 660, a seventh lens 670, an eighth lens 680, and a ninth lens 690, and may further include a filter F and an image sensor (not shown).

The optical imaging system 600 according to the sixth embodiment of the present disclosure may form a focus on an image plane IP. The image plane IP may be a surface of the image sensor on which light is received.

Lens characteristics (a radius of curvature, a thickness of a lens or a distance between lenses, a refractive index, and an Abbe number) of each of the lenses and the filter may be as illustrated in Table 11.

TABLE 11

| Surface | | Radius of | Thickness or | Refractive | Abbe |
|---|---|---|---|---|---|
| No. | Element | Curvature | Distance | Index | No. |
| S1 | First | 3.617 | 0.321 | 1.595 | 51.0 |
| S2 | Lens | 3.237 | 0.000 | | |
| S3 | Second | 3.237 | 0.909 | 1.553 | 62.0 |
| S4 | Lens | 240.707 | 0.091 | | |
| S5 | Third | 18.440 | 0.300 | 1.720 | 29.2 |
| S6 | Lens | 4.938 | 0.165 | | |
| S7 | Fourth | 7.292 | 0.490 | 1.650 | 55.1 |
| S8 | Lens | 47.232 | 0.801 | | |
| S9 | Fifth | −83.304 | 0.462 | 1.720 | 29.2 |
| S10 | Lens | 23.674 | 0.376 | | |
| S11 | Sixth | 30.534 | 0.511 | 1.639 | 57.0 |
| S12 | Lens | 28.039 | 0.170 | | |
| S13 | Seventh | −6.147 | 0.332 | 1.614 | 25.9 |
| S14 | Lens | −8.614 | 0.110 | | |
| S15 | Eighth | 2.182 | 0.700 | 1.544 | 56.0 |
| S16 | Lens | 4.455 | 1.604 | | |
| S17 | Ninth | 42.242 | 0.574 | 1.535 | 55.7 |
| S18 | Lens | 2.838 | 0.194 | | |
| S19 | Filter | Infinity | 0.231 | 1.517 | 64.2 |
| S20 | | Infinity | 0.515 | | |
| S21 | Image | Infinity | | | |
| | Plane | | | | |

In the sixth embodiment of the present disclosure, the first lens 610 may have a negative refractive power, an object-side surface of the first lens 610 may have a convex shape in the paraxial region, and an image-side surface of the first lens 610 may have a concave shape in the paraxial region.

The second lens 620 may have a positive refractive power, an object-side surface of the second lens 620 may have a convex shape in the paraxial region, and an image-side surface of the second lens 620 may have a concave shape in the paraxial region.

The first lens 610 and the second lens 620 may be bonded to each other. For example, the image-side surface of the first lens 610 and the object-side surface of the second lens 620 may be bonded to each other.

The first lens 610 and the second lens 620 may be bonded to each other by an adhesive layer 615.

The third lens 630 may have a negative refractive power, an object-side surface of the third lens 630 may have a convex shape in the paraxial region, and an image-side surface of the third lens 630 may have a concave shape in the paraxial region.

The fourth lens 640 may have a positive refractive power, an object-side surface of the fourth lens 640 may have a convex shape in the paraxial region, and an image-side surface of the fourth lens 640 may have a concave shape in the paraxial region.

The fifth lens 650 may have a negative refractive power, and an object-side surface and an image-side surface of the fifth lens 650 may have concave shapes in the paraxial region.

The sixth lens 660 may have a negative refractive power, an object-side surface of the sixth lens 660 may have a convex shape in the paraxial region, and an image-side surface of the sixth lens 660 may have a concave shape in the paraxial region.

The seventh lens 670 may have a negative refractive power, an object-side surface of the seventh lens 670 may have a concave shape in the paraxial region, and an image-side surface of the seventh lens 670 may have a convex shape in the paraxial region.

The eighth lens 680 may have a positive refractive power, an object-side surface of the eighth lens 680 may have a convex shape in the paraxial region, and an image-side surface of the eighth lens 680 may have a concave shape in the paraxial region.

The ninth lens 690 may have a negative refractive power, an object-side surface of the ninth lens 690 may have a convex shape in the paraxial region, and an image-side surface of the ninth lens 690 may have a concave shape in the paraxial region.

In addition, either one or both of the eighth lens 680 and the ninth lens 690 may have at least one inflection point on either one or both of the object-side surface and the image-side surface.

Each of the surfaces of the first lens 610 to the ninth lens 690 may have aspherical coefficients as illustrated in Table 12. For example, the object-side surfaces and the image-side surfaces of the third lens 630 to the ninth lens 690 may all be aspherical. In addition, the object-side surface of the first lens 610 and the image-side surface of the second lens 620 may be aspherical, and the image-side surface of the first lens 610 and the object-side surface of the second lens 620 may be spherical.

TABLE 12

| | S1 | S2 | S3 | S4 | S5 | S6 |
|---|---|---|---|---|---|---|
| Conic | −4.754 | 0.000 | 0.000 | −99.000 | 54.907 | 4.537 |
| Constant (K) | | | | | | |
| 4th Coeffi- | 8.558E−03 | 0.000E+00 | 0.000E+00 | −1.527E−03 | −4.323E−03 | −7.137E−03 |
| cient (A) | | | | | | |
| 6th Coeffi- | 6.879E−03 | 0.000E+00 | 0.000E+00 | −3.219E−02 | −1.164E−02 | 4.234E−03 |
| cient (B) | | | | | | |
| 8th Coeffi- | −2.737E−02 | 0.000E+00 | 0.000E+00 | 1.031E−01 | 3.833E−02 | −4.399E−02 |
| cient (C) | | | | | | |
| 10th Coeffi- | 5.181E−02 | 0.000E+00 | 0.000E+00 | −2.089E−01 | −7.766E−02 | 1.335E−01 |
| cient (D) | | | | | | |
| 12th Coeffi- | −6.333E−02 | 0.000E+00 | 0.000E+00 | 2.887E−01 | 1.206E−01 | −2.300E−01 |
| cient (E) | | | | | | |
| 14th Coeffi- | 5.264E−02 | 0.000E+00 | 0.000E+00 | −2.797E−01 | −1.369E−01 | 2.598E−01 |
| cient (F) | | | | | | |
| 16th Coeffi- | −3.069E−02 | 0.000E+00 | 0.000E+00 | 1.933E−01 | 1.120E−01 | −2.027E−01 |
| cient (G) | | | | | | |
| 18th Coeffi- | 1.275E−02 | 0.000E+00 | 0.000E+00 | −9.615E−02 | −6.604E−02 | 1.114E−01 |
| cient (H) | | | | | | |
| 20th Coeffi- | −3.792E−03 | 0.000E+00 | 0.000E+00 | 3.442E−02 | 2.803E−02 | −4.329E−02 |
| cient (J) | | | | | | |
| 22nd Coeffi- | 7.999E−04 | 0.000E+00 | 0.000E+00 | −8.771E−03 | −8.463E−03 | 1.177E−02 |
| cient (L) | | | | | | |
| 24th Coeffi- | −1.167E−04 | 0.000E+00 | 0.000E+00 | 1.549E−03 | 1.770E−03 | −2.181E−03 |
| cient (M) | | | | | | |
| 26th Coeffi- | 1.120E−05 | 0.000E+00 | 0.000E+00 | −1.797E−04 | −2.434E−04 | 2.606E−04 |
| cient (N) | | | | | | |
| 28th Coeffi- | −6.343E−07 | 0.000E+00 | 0.000E+00 | 1.232E−05 | 1.974E−05 | −1.800E−05 |
| cient (O) | | | | | | |
| 30th Coeffi- | 1.607E−08 | 0.000E+00 | 0.000E+00 | −3.770E−07 | −7.141E−07 | 5.408E−07 |
| cient (P) | | | | | | |
| | S7 | S8 | S9 | S10 | S11 | S12 |
| Conic | −3.374 | 69.782 | 0.000 | −28.171 | 120.477 | −99.000 |
| Constant (K) | | | | | | |
| 4th Coeffi- | 1.363E−03 | −1.766E−03 | −2.128E−02 | −2.393E−02 | −6.110E−02 | −1.122E−01 |
| cient (A) | | | | | | |
| 6th Coeffi- | 3.787E−03 | −5.980E−03 | 1.112E−03 | 1.586E−02 | 6.969E−02 | 1.273E−01 |
| cient (B) | | | | | | |
| 8th Coeffi- | −3.910E−02 | 1.532E−02 | −6.266E−03 | −2.870E−02 | −8.411E−02 | −1.552E−01 |
| cient (C) | | | | | | |
| 10th Coeffi- | 1.086E−01 | −3.282E−02 | −6.374E−04 | 3.278E−02 | 8.158E−02 | 1.467E−01 |
| cient (D) | | | | | | |
| 12th Coeffi- | −1.762E−01 | 4.825E−02 | 2.226E−02 | −2.575E−02 | −6.101E−02 | −1.015E−01 |
| cient (E) | | | | | | |
| 14th Coeffi- | 1.852E−01 | −4.758E−02 | −4.437E−02 | 1.406E−02 | 3.483E−02 | 5.185E−02 |
| cient (F) | | | | | | |
| 16th Coeffi- | −1.289E−01 | 3.062E−02 | 4.848E−02 | −5.278E−03 | −1.529E−02 | −1.998E−02 |
| cient (G) | | | | | | |
| 18th Coeffi- | 5.812E−02 | −1.167E−02 | −3.447E−02 | 1.299E−03 | 5.185E−03 | 5.901E−03 |
| cient (H) | | | | | | |
| 20th Coeffi- | −1.523E−02 | 1.510E−03 | 1.677E−02 | −1.780E−04 | −1.351E−03 | −1.340E−03 |
| cient (J) | | | | | | |
| 22nd Coeffi- | 1.154E−03 | 8.336E−04 | −5.643E−03 | 1.901E−06 | 2.652E−04 | 2.305E−04 |
| cient (L) | | | | | | |
| 24th Coeffi- | 6.212E−04 | −5.023E−04 | 1.291E−03 | 3.958E−06 | −3.777E−05 | −2.890E−05 |
| cient (M) | | | | | | |
| 26th Coeffi- | −2.268E−04 | 1.228E−04 | −1.917E−04 | −6.935E−07 | 3.657E−06 | 2.474E−06 |
| cient (N) | | | | | | |
| 28th Coeffi- | 3.210E−05 | −1.509E−05 | 1.662E−05 | 5.086E−08 | −2.138E−07 | −1.281E−07 |
| cient (O) | | | | | | |
| 30th Coeffi- | −1.757E−06 | 7.612E−07 | −6.371E−07 | −1.372E−09 | 5.655E−09 | 3.006E−09 |
| cient (P) | | | | | | |
| | S13 | S14 | S15 | S16 | S17 | S18 |
| Conic | 2.587 | 3.336 | −6.509 | −10.429 | 26.889 | −9.443 |
| Constant (K) | | | | | | |
| 4th Coeffi- | 2.610E−02 | 1.971E−02 | 3.502E−04 | 1.060E−02 | −7.966E−02 | −4.542E−02 |
| cient (A) | | | | | | |
| 6th Coeffi- | 1.286E−02 | −1.946E−02 | −6.198E−03 | −1.406E−03 | 3.152E−02 | 1.948E−02 |
| cient (B) | | | | | | |
| 8th Coeffi- | −6.325E−02 | 6.001E−03 | 6.789E−03 | −8.565E−04 | −9.674E−03 | −6.011E−03 |
| cient (C) | | | | | | |
| 10th Coeffi- | 7.947E−02 | 3.687E−03 | −5.531E−03 | −9.653E−05 | 2.122E−03 | 1.304E−03 |
| cient (D) | | | | | | |
| 12th Coeffi- | −5.760E−02 | −5.088E−03 | 2.759E−03 | 2.612E−04 | −3.187E−04 | −2.043E−04 |
| cient (E) | | | | | | |
| 14th Coeffi- | 2.735E−02 | 2.759E−03 | −9.130E−04 | −1.088E−04 | 3.271E−05 | 2.356E−05 |
| cient (F) | | | | | | |
| 16th Coeffi- | −8.931E−03 | −9.093E−04 | 2.111E−04 | 2.497E−05 | −2.300E−06 | −2.026E−06 |
| cient (G) | | | | | | |
| 18th Coeffi- | 2.045E−03 | 2.006E−04 | −3.496E−05 | −3.733E−06 | 1.091E−07 | 1.303E−07 |
| cient (H) | | | | | | |
| 20th Coeffi- | −3.283E−04 | −3.063E−05 | 4.175E−06 | 3.829E−07 | −3.303E−09 | −6.222E−09 |
| cient (J) | | | | | | |
| 22nd Coeffi- | 3.626E−05 | 3.253E−06 | −3.563E−07 | −2.729E−08 | 5.221E−11 | 2.168E−10 |
| cient (L) | | | | | | |
| 24th Coeffi- | −2.630E−06 | −2.362E−07 | 2.116E−08 | 1.331E−09 | 9.828E−14 | −5.341E−12 |
| cient (M) | | | | | | |
| 26th Coeffi- | 1.131E−07 | 1.119E−08 | −8.292E−10 | −4.241E−11 | −2.104E−14 | 8.796E−14 |
| cient (N) | | | | | | |
| 28th Coeffi- | −2.221E−09 | −3.117E−10 | 1.924E−11 | 7.962E−13 | 3.626E−16 | −8.672E−16 |
| cient (O) | | | | | | |
| 30th Coeffi- | 2.377E−12 | 3.877E−12 | −1.999E−13 | −6.677E−15 | −2.139E−18 | 3.866E−18 |
| cient (P) | | | | | | |

In addition, the optical imaging system 600 according to the sixth embodiment of the present disclosure may have the aberration characteristics illustrated in FIG. 12.

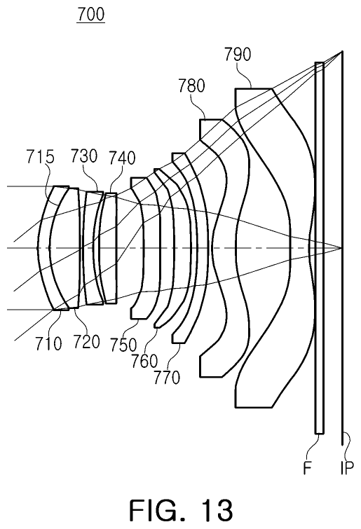

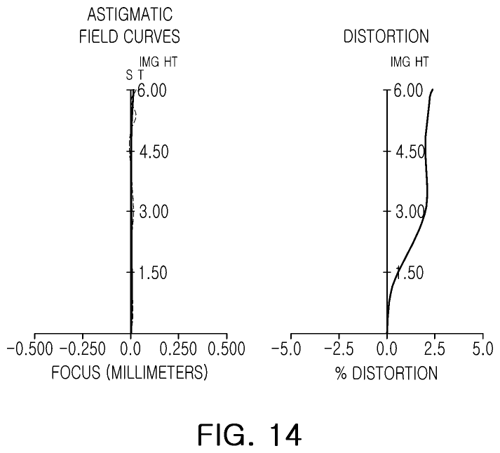

FIG. 13 is a configuration diagram of an optical imaging system according to a seventh embodiment of the present disclosure, and FIG. 14 is a view illustrating aberration characteristics of the optical imaging system illustrated in FIG. 13.

Referring to FIG. 13, an optical imaging system 700 according to the seventh embodiment of the present disclosure may include a first lens 710, a second lens 720, a third lens 730, a fourth lens 740, a fifth lens 750, a sixth lens 760, a seventh lens 770, an eighth lens 780, and a ninth lens 790, and may further include a filter F and an image sensor (not shown).

The optical imaging system 700 according to the seventh embodiment of the present disclosure may form a focus on an image plane IP. The image plane IP may be a surface of the image sensor on which light is received.

Lens characteristics (a radius of curvature, a thickness of a lens or a distance between lenses, a refractive index, and an Abbe number) of each of the lenses and the filter may be as illustrated in Table 13.

TABLE 13

| Surface | | Radius of | Thickness or | Refractive | Abbe |
|---|---|---|---|---|---|
| No. | Element | Curvature | Distance | Index | No. |
| S1 | First | 3.614 | 0.327 | 1.599 | 45.7 |
| S2 | Lens | 3.135 | 0.000 | | |
| S3 | Second | 3.135 | 0.893 | 1.551 | 62.0 |
| S4 | Lens | 203.953 | 0.107 | | |
| S5 | Third | 18.444 | 0.293 | 1.720 | 29.2 |
| S6 | Lens | 4.960 | 0.163 | | |
| S7 | Fourth | 7.248 | 0.500 | 1.661 | 53.4 |
| S8 | Lens | 44.080 | 0.804 | | |
| S9 | Fifth | −81.939 | 0.468 | 1.720 | 29.2 |
| S10 | Lens | 24.475 | 0.400 | | |
| S11 | Sixth | 33.329 | 0.501 | 1.643 | 56.2 |
| S12 | Lens | 28.545 | 0.182 | | |
| S13 | Seventh | −6.214 | 0.314 | 1.614 | 25.9 |
| S14 | Lens | −8.635 | 0.112 | | |
| S15 | Eighth | 2.181 | 0.687 | 1.544 | 56.0 |
| S16 | Lens | 4.381 | 1.580 | | |
| S17 | Ninth | 42.182 | 0.555 | 1.535 | 55.7 |
| S18 | Lens | 2.866 | 0.179 | | |
| S19 | Filter | Infinity | 0.231 | 1.517 | 64.2 |
| S20 | | Infinity | 0.570 | | |
| S21 | Image | Infinity | | | |
| | Plane | | | | |

In the seventh embodiment of the present disclosure, the first lens 710 may have a negative refractive power, an object-side surface of the first lens 710 may have a convex shape in the paraxial region, and an image-side surface of the first lens 710 may have a concave shape in the paraxial region.

The second lens 720 may have a positive refractive power, an object-side surface of the second lens 720 may have a convex shape in the paraxial region, and an image-side surface of the second lens 720 may have a concave shape in the paraxial region.

The first lens 710 and the second lens 720 may be bonded to each other. For example, the image-side surface of the first lens 710 and the object-side surface of the second lens 720 may be bonded to each other.

The first lens 710 and the second lens 720 may be bonded to each other by an adhesive layer 715.

The third lens 730 may have a negative refractive power, an object-side surface of the third lens 730 may have a convex shape in the paraxial region, and an image-side surface of the third lens 730 may have a concave shape in the paraxial region.

The fourth lens 740 may have a positive refractive power, an object-side surface of the fourth lens 740 may have a convex shape in the paraxial region, and an image-side surface of the fourth lens 740 may have a concave shape in the paraxial region.

The fifth lens 750 may have a negative refractive power, and an object-side surface and an image-side surface of the fifth lens 750 may have concave shapes in the paraxial region.

The sixth lens 760 may have a negative refractive power, an object-side surface of the sixth lens 760 may have a convex shape in the paraxial region, and an image-side surface of the sixth lens 760 may have a concave shape in the paraxial region.

The seventh lens 770 may have a negative refractive power, an object-side surface of the seventh lens 770 may have a concave shape in the paraxial region, and an image-side surface of the seventh lens 770 may have a convex shape in the paraxial region.

The eighth lens 780 may have a positive refractive power, an object-side surface of the eighth lens 780 may have a convex shape in the paraxial region, and an image-side surface of the eighth lens 780 may have a concave shape in the paraxial region.

The ninth lens 790 may have a negative refractive power, an object-side surface of the ninth lens 790 may have a convex shape in the paraxial region, and an image-side surface of the ninth lens 790 may have a concave shape in the paraxial region.

In addition, either one or both of the eighth lens 780 and the ninth lens 790 may have at least one inflection point on either one or both of the object-side surface and the image-side surface.

Each of the surfaces of the first lens 710 to the ninth lens 790 may have aspherical coefficients as illustrated in Table 14. For example, the object-side surfaces and the image-side surfaces of the first lens 710 to the ninth lens 790 may all be aspherical.

TABLE 14

| | S1 | S2 | S3 | S4 | S5 | S6 |
|---|---|---|---|---|---|---|
| Conic | −4.778 | −0.129 | −0.129 | 99.000 | 54.622 | 4.528 |
| Constant (K) | | | | | | |
| 4th Coeffi- | 8.769E−03 | −2.092E−03 | −2.092E−03 | −6.379E−03 | −7.953E−03 | −1.040E−02 |
| cient (A) | | | | | | |
| 6th Coeffi- | 7.310E−03 | 1.388E−02 | 1.388E−02 | −1.352E−02 | −1.888E−04 | 1.482E−02 |
| cient (B) | | | | | | |
| 8th Coeffi- | −2.902E−02 | 9.339E−02 | 9.339E−02 | 6.631E−02 | 3.150E−02 | −5.691E−02 |
| cient (C) | | | | | | |
| 10th Coeffi- | 5.502E−02 | −5.931E−01 | −5.931E−01 | −1.615E−01 | −1.018E−01 | 1.305E−01 |
| cient (D) | | | | | | |
| 12th Coeffi- | −6.773E−02 | 1.543E+00 | 1.543E+00 | 2.460E−01 | 1.869E−01 | −1.971E−01 |
| cient (E) | | | | | | |
| 14th Coeffi- | 5.687E−02 | −2.395E+00 | −2.395E+00 | −2.523E−01 | −2.228E−01 | 2.067E−01 |
| cient (F) | | | | | | |
| 16th Coeffi- | −3.351E−02 | 2.461E+00 | 2.461E+00 | 1.807E−01 | 1.828E−01 | −1.536E−01 |
| cient (G) | | | | | | |
| 18th Coeffi- | 1.407E−02 | −1.747E+00 | −1.747E+00 | −9.214E−02 | −1.062E−01 | 8.142E−02 |
| cient (H) | | | | | | |
| 20th Coeffi- | −4.222E−03 | 8.712E−01 | 8.712E−01 | 3.358E−02 | 4.400E−02 | −3.073E−02 |
| cient (J) | | | | | | |
| 22nd Coeffi- | 8.975E−04 | −3.048E−01 | −3.048E−01 | −8.675E−03 | −1.293E−02 | 8.143E−03 |
| cient (L) | | | | | | |
| 24th Coeffi- | −1.319E−04 | 7.325E−02 | 7.325E−02 | 1.549E−03 | 2.631E−03 | −1.470E−03 |
| cient (M) | | | | | | |
| 26th Coeffi- | 1.272E−05 | −1.153E−02 | −1.153E−02 | −1.814E−04 | −3.516E−04 | 1.708E−04 |
| cient (N) | | | | | | |
| 28th Coeffi- | −7.238E−07 | 1.070E−03 | 1.070E−03 | 1.253E−05 | 2.774E−05 | −1.138E−05 |
| cient (O) | | | | | | |
| 30th Coeffi- | 1.841E−08 | −4.438E−05 | −4.438E−05 | −3.864E−07 | −9.780E−07 | 3.255E−07 |
| cient (P) | | | | | | |
| | S7 | S8 | S9 | S10 | S11 | S12 |
| Conic | −3.399 | 80.190 | 0.000 | −37.057 | 99.000 | −99.000 |
| Constant (K) | | | | | | |
| 4th Coeffi- | 2.865E−03 | −2.795E−03 | −2.009E−02 | −2.290E−02 | −5.933E−02 | −1.114E−01 |
| cient (A) | | | | | | |
| 6th Coeffi- | −1.524E−02 | 2.458E−03 | −7.200E−03 | 1.156E−02 | 6.421E−02 | 1.303E−01 |
| cient (B) | | | | | | |
| 8th Coeffi- | 5.505E−02 | −2.253E−02 | 2.476E−02 | −2.026E−02 | −7.669E−02 | −1.650E−01 |
| cient (C) | | | | | | |
| 10th Coeffi- | −1.531E−01 | 7.322E−02 | −7.345E−02 | 2.238E−02 | 7.452E−02 | 1.581E−01 |
| cient (D) | | | | | | |
| 12th Coeffi- | 2.911E−01 | −1.445E−01 | 1.387E−01 | −1.687E−02 | −5.528E−02 | −1.081E−01 |
| cient (E) | | | | | | |
| 14th Coeffi- | −3.860E−01 | 1.892E−01 | −1.764E−01 | 8.480E−03 | 3.087E−02 | 5.336E−02 |
| cient (F) | | | | | | |
| 16th Coeffi- | 3.652E−01 | −1.718E−01 | 1.566E−01 | −2.583E−03 | −1.316E−02 | −1.954E−02 |
| cient (G) | | | | | | |
| 18th Coeffi- | −2.493E−01 | 1.107E−01 | −9.905E−02 | 2.782E−04 | 4.360E−03 | 5.443E−03 |
| cient (H) | | | | | | |
| 20th Coeffi- | 1.228E−01 | −5.109E−02 | 4.481E−02 | 1.227E−04 | −1.130E−03 | −1.171E−03 |
| cient (J) | | | | | | |
| 22nd Coeffi- | −4.314E−02 | 1.676E−02 | −1.438E−02 | −6.483E−05 | 2.256E−04 | 1.934E−04 |
| cient (L) | | | | | | |
| 24th Coeffi- | 1.053E−02 | −3.816E−03 | 3.191E−03 | 1.455E−05 | −3.330E−05 | −2.376E−05 |
| cient (M) | | | | | | |
| 26th Coeffi- | −1.692E−03 | 5.729E−04 | −4.647E−04 | −1.812E−06 | 3.375E−06 | 2.026E−06 |
| cient (N) | | | | | | |
| 28th Coeffi- | 1.609E−04 | −5.093E−05 | 3.991E−05 | 1.206E−07 | −2.070E−07 | −1.057E−07 |
| cient (O) | | | | | | |
| 30th Coeffi- | −6.842E−06 | 2.028E−06 | −1.529E−06 | −3.295E−09 | 5.727E−09 | 2.510E−09 |
| cient (P) | | | | | | |
| | S13 | S14 | S15 | S16 | S17 | S18 |
| Conic | 2.586 | 3.287 | −6.528 | −10.178 | 30.914 | −10.245 |
| Constant (K) | | | | | | |
| 4th Coeffi- | 2.282E−02 | 1.932E−02 | 4.079E−03 | 1.385E−02 | −8.063E−02 | −4.461E−02 |
| cient (A) | | | | | | |
| 6th Coeffi- | 2.952E−02 | −1.678E−02 | −1.321E−02 | −5.067E−03 | 3.212E−02 | 1.876E−02 |
| cient (B) | | | | | | |
| 8th Coeffi- | −9.595E−02 | −6.531E−04 | 1.308E−02 | 1.193E−03 | −1.003E−02 | −5.806E−03 |
| cient (C) | | | | | | |
| 10th Coeffi- | 1.152E−01 | 1.133E−02 | −9.276E−03 | −8.059E−04 | 2.306E−03 | 1.278E−03 |
| cient (D) | | | | | | |
| 12th Coeffi- | −8.221E−02 | −1.013E−02 | 4.365E−03 | 4.303E−04 | −3.781E−04 | −2.037E−04 |
| cient (E) | | | | | | |
| 14th Coeffi- | 3.880E−02 | 4.889E−03 | −1.419E−03 | −1.385E−04 | 4.467E−05 | 2.382E−05 |
| cient (F) | | | | | | |
| 16th Coeffi- | −1.266E−02 | −1.520E−03 | 3.281E−04 | 2.901E−05 | −3.872E−06 | −2.063E−06 |
| cient (G) | | | | | | |
| 18th Coeffi- | 2.914E−03 | 3.233E−04 | −5.473E−05 | −4.164E−06 | 2.496E−07 | 1.325E−07 |
| cient (H) | | | | | | |
| 20th Coeffi- | −4.737E−04 | −4.809E−05 | 6.597E−06 | 4.189E−07 | −1.201E−08 | −6.267E−09 |
| cient (J) | | | | | | |
| 22nd Coeffi- | 5.360E−05 | 5.007E−06 | −5.681E−07 | −2.955E−08 | 4.271E−10 | 2.144E−10 |
| cient (L) | | | | | | |
| 24th Coeffi- | −4.069E−06 | −3.578E−07 | 3.401E−08 | 1.434E−09 | −1.092E−11 | −5.137E−12 |
| cient (M) | | | | | | |
| 26th Coeffi- | 1.920E−07 | 1.673E−08 | −1.342E−09 | −4.557E−11 | 1.896E−13 | 8.151E−14 |
| cient (N) | | | | | | |
| 28th Coeffi- | −4.786E−09 | −4.614E−10 | 3.134E−11 | 8.542E−13 | −2.004E−15 | −7.667E−16 |
| cient (O) | | | | | | |
| 30th Coeffi- | 3.979E−11 | 5.689E−12 | −3.276E−13 | −7.157E−15 | 9.707E−18 | 3.228E−18 |
| cient (P) | | | | | | |

In addition, the optical imaging system 700 according to the seventh embodiment of the present disclosure may have the aberration characteristics illustrated in FIG. 14.

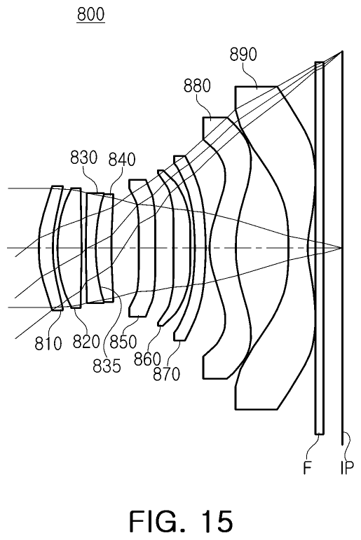

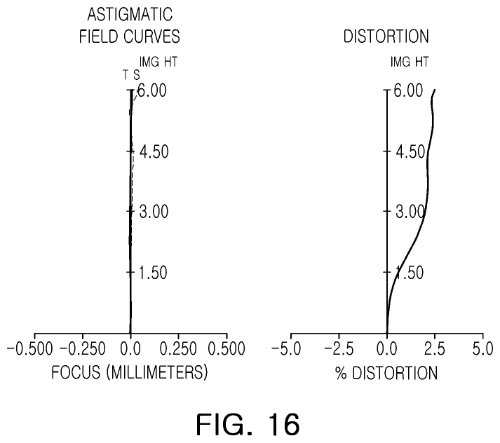

FIG. 15 is a configuration diagram of an optical imaging system according to an eighth embodiment of the present disclosure, and FIG. 16 is a view illustrating aberration characteristics of the optical imaging system illustrated in FIG. 15.

Referring to FIG. 15, an optical imaging system 800 according to the eighth embodiment of the present disclosure may include a first lens 810, a second lens 820, a third lens 830, a fourth lens 840, a fifth lens 850, a sixth lens 860, a seventh lens 870, an eighth lens 880, and a ninth lens 890, and may further include a filter F and an image sensor (not shown).

The optical imaging system 800 according to the eighth embodiment of the present disclosure may form a focus on an image plane IP. The image plane IP may be a surface of the image sensor on which light is received.

Lens characteristics (a radius of curvature, a thickness of a lens or a distance between lenses, a refractive index, and an Abbe number) of each of the lenses and the filter may be as illustrated in Table 15.

TABLE 15

| Surface | | Radius of | Thickness or | Refractive | Abbe |
|---|---|---|---|---|---|
| No. | Element | Curvature | Distance | Index | No. |
| S1 | First | 3.533 | 0.416 | 1.510 | 62.0 |
| S2 | Lens | 3.951 | 0.126 | | |
| S3 | Second | 3.869 | 0.702 | 1.544 | 62.0 |
| S4 | Lens | 71.357 | 0.131 | | |
| S5 | Third | 32.117 | 0.280 | 1.720 | 30.1 |
| S6 | Lens | 5.470 | 0.000 | | |
| S7 | Fourth | 5.470 | 0.462 | 1.542 | 62.0 |
| S8 | Lens | 18.250 | 0.798 | | |
| S9 | Fifth | 86.278 | 0.471 | 1.720 | 29.4 |
| S10 | Lens | 25.992 | 0.541 | | |
| S11 | Sixth | 25.535 | 0.483 | 1.560 | 52.6 |
| S12 | Lens | 18.074 | 0.132 | | |
| S13 | Seventh | −6.375 | 0.313 | 1.614 | 25.9 |
| S14 | Lens | −9.408 | 0.123 | | |
| S15 | Eighth | 2.299 | 0.766 | 1.544 | 56.0 |
| S16 | Lens | 5.228 | 1.517 | | |
| S17 | Ninth | 38.947 | 0.567 | 1.535 | 55.7 |
| S18 | Lens | 2.695 | 0.232 | | |
| S19 | Filter | Infinity | 0.231 | 1.517 | 64.2 |
| S20 | | Infinity | 0.544 | | |
| S21 | Image | Infinity | | | |
| | Plane | | | | |

In the eighth embodiment of the present disclosure, the first lens 810 may have a positive refractive power, an object-side surface of the first lens 810 may have a convex shape in the paraxial region, and an image-side surface of the first lens 810 may have a concave shape in the paraxial region.

The second lens 820 may have a positive refractive power, an object-side surface of the second lens 820 may have a convex shape in the paraxial region, and an image-side surface of the second lens 820 may have a concave shape in the paraxial region.

The third lens 830 may have a negative refractive power, an object-side surface of the third lens 830 may have a convex shape in the paraxial region, and an image-side surface of the third lens 830 may have a concave shape in the paraxial region.

The fourth lens 840 may have a positive refractive power, an object-side surface of the fourth lens 840 may have a convex shape in the paraxial region, and an image-side surface of the fourth lens 840 may have a concave shape in the paraxial region.

The third lens 830 and the fourth lens 840 may be bonded to each other. For example, the image-side surface of the third lens 830 and the object-side surface of the fourth lens 840 may be bonded to each other.

The third lens 830 and the fourth lens 840 may be bonded to each other by an adhesive layer 835.

The fifth lens 850 may have a negative refractive power, an object-side surface of the fifth lens 850 may have a convex shape in the paraxial region, and an image-side surface of the fifth lens 850 may have a concave shape in the paraxial region.

The sixth lens 860 may have a negative refractive power, an object-side surface of the sixth lens 860 may have a convex shape in the paraxial region, and an image-side surface of the sixth lens 860 may have a concave shape in the paraxial region.

The seventh lens 870 may have a negative refractive power, an object-side surface of the seventh lens 870 may have a concave shape in the paraxial region, and an image-side surface of the seventh lens 870 may have a convex shape in the paraxial region.

The eighth lens 880 may have a positive refractive power, an object-side surface of the eighth lens 880 may have a convex shape in the paraxial region, and an image-side surface of the eighth lens 880 may have a concave shape in the paraxial region.

The ninth lens 890 may have a negative refractive power, an object-side surface of the ninth lens 890 may have a convex shape in the paraxial region, and an image-side surface of the ninth lens 890 may have a concave shape in the paraxial region.

In addition, either one or both of the eighth lens 880 and the ninth lens 890 may have at least one inflection point on either one or both of the object-side surface an the image-side surface.

Each of the surfaces of the first lens 810 to the ninth lens 890 may have aspherical coefficients as illustrated in Table 16. For example, the object-side surfaces and the image-side surfaces of the first lens 810, the second lens 820, and the fifth lens 850 to the ninth lens 890 may all be aspherical. In addition, the object-side surface of the third lens 830 and the image-side surface of the fourth lens 840 may be aspherical, and the image-side surface of the third lens 830 and the object-side surface of the fourth lens 840 may be spherical.

TABLE 16

| | S1 | S2 | S3 | S4 | S5 | S6 |
|---|---|---|---|---|---|---|
| Conic | −6.388 | −12.037 | −4.457 | 14.656 | 61.577 | 0.000 |
| Constant (K) | | | | | | |
| 4th Coeffi- | 1.060E−02 | 7.539E−03 | 3.939E−05 | −7.592E−03 | −4.944E−03 | 0.000E+00 |
| cient (A) | | | | | | |
| 6th Coeffi- | −1.198E−03 | −5.994E−03 | −7.341E−03 | −1.186E−02 | −6.556E−03 | 0.000E+00 |
| cient (B) | | | | | | |
| 8th Coeffi- | −1.084E−02 | −1.307E−02 | 2.096E−02 | 4.447E−02 | 3.294E−02 | 0.000E+00 |
| cient (C) | | | | | | |
| 10th Coeffi- | 2.375E−02 | 4.497E−02 | −4.201E−02 | −9.235E−02 | −7.619E−02 | 0.000E+00 |
| cient (D) | | | | | | |
| 12th Coeffi- | −3.166E−02 | −7.753E−02 | 5.723E−02 | 1.275E−01 | 1.140E−01 | 0.000E+00 |
| cient (E) | | | | | | |
| 14th Coeffi- | 2.865E−02 | 8.802E−02 | −5.246E−02 | −1.211E−01 | −1.156E−01 | 0.000E+00 |
| cient (F) | | | | | | |
| 16th Coeffi- | −1.834E−02 | −6.909E−02 | 3.346E−02 | 8.116E−02 | 8.161E−02 | 0.000E+00 |
| cient (G) | | | | | | |
| 18th Coeffi- | 8.460E−03 | 3.827E−02 | −1.512E−02 | −3.892E−02 | −4.073E−02 | 0.000E+00 |
| cient (H) | | | | | | |
| 20th Coeffi- | −2.823E−03 | −1.505E−02 | 4.862E−03 | 1.339E−02 | 1.443E−02 | 0.000E+00 |
| cient (J) | | | | | | |
| 22nd Coeffi- | 6.747E−04 | 4.173E−03 | −1.103E−03 | −3.281E−03 | −3.595E−03 | 0.000E+00 |
| cient (L) | | | | | | |
| 24th Coeffi- | −1.124E−04 | −7.959E−04 | 1.722E−04 | 5.582E−04 | 6.149E−04 | 0.000E+00 |
| cient (M) | | | | | | |
| 26th Coeffi- | 1.238E−05 | 9.925E−05 | −1.760E−05 | −6.272E−05 | −6.860E−05 | 0.000E+00 |
| cient (N) | | | | | | |
| 28th Coeffi- | −8.084E−07 | −7.277E−06 | 1.059E−06 | 4.187E−06 | 4.491E−06 | 0.000E+00 |
| cient (O) | | | | | | |
| 30th Coeffi- | 2.367E−08 | 2.376E−07 | −2.841E−08 | −1.258E−07 | −1.307E−07 | 0.000E+00 |
| cient (P) | | | | | | |
| | S7 | S8 | S9 | S10 | S11 | S12 |
| Conic | 0.000 | −65.163 | −99.000 | 46.641 | 97.743 | −44.239 |
| Constant (K) | | | | | | |
| 4th Coeffi- | 0.000E+00 | −1.443E−03 | −2.181E−02 | −2.241E−02 | −5.982E−02 | −1.124E−01 |
| cient (A) | | | | | | |
| 6th Coeffi- | 0.000E+00 | −1.241E−03 | 4.982E−03 | 1.269E−02 | 6.942E−02 | 9.897E−02 |
| cient (B) | | | | | | |
| 8th Coeffi- | 0.000E+00 | 7.543E−03 | −7.897E−03 | −2.038E−02 | −8.865E−02 | −8.997E−02 |
| cient (C) | | | | | | |
| 10th Coeffi- | 0.000E+00 | −2.113E−02 | −9.076E−03 | 1.812E−02 | 9.706E−02 | 7.001E−02 |
| cient (D) | | | | | | |
| 12th Coeffi- | 0.000E+00 | 3.936E−02 | 4.607E−02 | −7.932E−03 | −8.695E−02 | −4.956E−02 |
| cient (E) | | | | | | |
| 14th Coeffi- | 0.000E+00 | −5.041E−02 | −7.779E−02 | −1.118E−03 | 6.042E−02 | 3.144E−02 |
| cient (F) | | | | | | |
| 16th Coeffi- | 0.000E+00 | 4.487E−02 | 7.882E−02 | 4.007E−03 | −3.153E−02 | −1.603E−02 |
| cient (G) | | | | | | |
| 18th Coeffi- | 0.000E+00 | −2.809E−02 | −5.374E−02 | −2.853E−03 | 1.217E−02 | 6.068E−03 |
| cient (H) | | | | | | |
| 20th Coeffi- | 0.000E+00 | 1.241E−02 | 2.557E−02 | 1.187E−03 | −3.441E−03 | −1.652E−03 |
| cient (J) | | | | | | |
| 22nd Coeffi- | 0.000E+00 | −3.840E−03 | −8.533E−03 | −3.249E−04 | 7.026E−04 | 3.183E−04 |
| cient (L) | | | | | | |
| 24th Coeffi- | 0.000E+00 | 8.122E−04 | 1.960E−03 | 5.944E−05 | −1.008E−04 | −4.232E−05 |
| cient (M) | | | | | | |
| 26th Coeffi- | 0.000E+00 | −1.116E−04 | −2.949E−04 | −7.008E−06 | 9.630E−06 | 3.699E−06 |
| cient (N) | | | | | | |
| 28th Coeffi- | 0.000E+00 | 8.953E−06 | 2.616E−05 | 4.817E−07 | −5.496E−07 | −1.911E−07 |
| cient (O) | | | | | | |
| 30th Coeffi- | 0.000E+00 | −3.178E−07 | −1.035E−06 | −1.466E−08 | 1.415E−08 | 4.423E−09 |
| cient (P) | | | | | | |
| | S13 | S14 | S15 | S16 | S17 | S18 |
| Conic | 2.371 | 4.145 | −5.904 | −8.013 | 19.579 | −8.707 |
| Constant (K) | | | | | | |
| 4th Coeffi- | 3.857E−02 | 3.174E−02 | −4.622E−03 | 8.573E−03 | −8.102E−02 | −4.463E−02 |
| cient (A) | | | | | | |
| 6th Coeffi- | −5.129E−02 | −5.186E−02 | 1.104E−03 | 5.749E−03 | 3.430E−02 | 2.057E−02 |
| cient (B) | | | | | | |
| 8th Coeffi- | 6.093E−02 | 5.073E−02 | 5.237E−04 | −7.293E−03 | −1.099E−02 | −6.831E−03 |
| cient (C) | | | | | | |
| 10th Coeffi- | −6.214E−02 | −3.681E−02 | −1.816E−03 | 3.342E−03 | 2.416E−03 | 1.605E−03 |
| cient (D) | | | | | | |
| 12th Coeffi- | 4.572E−02 | 1.997E−02 | 1.260E−03 | −9.478E−04 | −3.492E−04 | −2.736E−04 |
| cient (E) | | | | | | |
| 14th Coeffi- | −2.285E−02 | −7.932E−03 | −4.834E−04 | 1.852E−04 | 3.230E−05 | 3.435E−05 |
| cient (F) | | | | | | |
| 16th Coeffi- | 7.765E−03 | 2.273E−03 | 1.199E−04 | −2.594E−05 | −1.728E−06 | −3.190E−06 |
| cient (G) | | | | | | |
| 18th Coeffi- | −1.816E−03 | −4.670E−04 | −2.033E−05 | 2.652E−06 | 2.488E−08 | 2.185E−07 |
| cient (H) | | | | | | |
| 20th Coeffi- | 2.939E−04 | 6.850E−05 | 2.411E−06 | −1.984E−07 | 3.593E−09 | −1.094E−08 |
| cient (J) | | | | | | |
| 22nd Coeffi- | −3.260E−05 | −7.094E−06 | −2.002E−07 | 1.077E−08 | −3.093E−10 | 3.931E−10 |
| cient (L) | | | | | | |
| 24th Coeffi- | 2.409E−06 | 5.059E−07 | 1.143E−08 | −4.123E−10 | 1.251E−11 | −9.837E−12 |
| cient (M) | | | | | | |
| 26th Coeffi- | −1.115E−07 | −2.361E−08 | −4.271E−10 | 1.057E−11 | −2.923E−13 | 1.622E−13 |
| cient (N) | | | | | | |
| 28th Coeffi- | 2.840E−09 | 6.489E−10 | 9.415E−12 | −1.626E−13 | 3.790E−15 | −1.582E−15 |
| cient (O) | | | | | | |
| 30th Coeffi- | −2.854E−11 | −7.959E−12 | −9.276E−14 | 1.133E−15 | −2.123E−17 | 6.893E−18 |
| cient (P) | | | | | | |

In addition, the optical imaging system 800 according to the eighth embodiment of the present disclosure may have the aberration characteristics illustrated in FIG. 16.

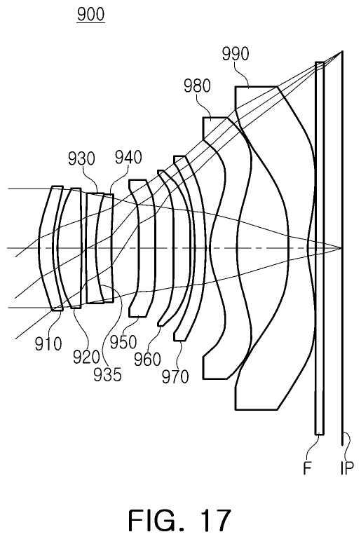

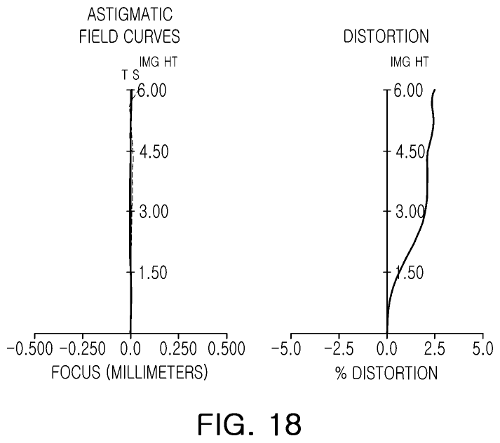

FIG. 17 is a configuration diagram of an optical imaging system according to a ninth embodiment of the present disclosure, and FIG. 18 is a view illustrating aberration characteristics of the optical imaging system illustrated in FIG. 17.

Referring to FIG. 17, an optical imaging system 900 according to the ninth embodiment of the present disclosure may include a first lens 910, a second lens 920, a third lens 930, a fourth lens 940, a fifth lens 950, a sixth lens 960, a seventh lens 970, an eighth lens 980, and a ninth lens 990, and may further include a filter F and an image sensor (not shown).

The optical imaging system 900 according to the ninth embodiment of the present disclosure may form a focus on an image plane IP. The image plane IP may be a surface of the image sensor on which light is received.

Lens characteristics (a radius of curvature, a thickness of a lens or a distance between lenses, a refractive index, and an Abbe number) of each of the lenses and the filter may be as illustrated in Table 17.

TABLE 17

| Surface | | Radius of | Thickness or | Refractive | Abbe |
|---|---|---|---|---|---|
| No. | Element | Curvature | Distance | Index | No. |
| S1 | First | 3.537 | 0.414 | 1.510 | 62.0 |
| S2 | Lens | 3.936 | 0.119 | | |
| S3 | Second | 3.858 | 0.703 | 1.546 | 62.0 |
| S4 | Lens | 70.478 | 0.129 | | |
| S5 | Third | 31.211 | 0.280 | 1.720 | 30.3 |
| S6 | Lens | 5.326 | 0.000 | | |
| S7 | Fourth | 5.326 | 0.470 | 1.542 | 62.0 |
| S8 | Lens | 18.306 | 0.796 | | |
| S9 | Fifth | 112.366 | 0.477 | 1.720 | 30.3 |
| S10 | Lens | 27.756 | 0.542 | | |
| S11 | Sixth | 26.058 | 0.487 | 1.565 | 53.1 |
| S12 | Lens | 18.460 | 0.131 | | |
| S13 | Seventh | −6.376 | 0.314 | 1.614 | 25.9 |
| S14 | Lens | −9.517 | 0.126 | | |
| S15 | Eighth | 2.306 | 0.771 | 1.544 | 56.0 |
| S16 | Lens | 5.309 | 1.511 | | |
| S17 | Ninth | 39.369 | 0.565 | 1.535 | 55.7 |
| S18 | Lens | 2.701 | 0.232 | | |
| S19 | Filter | Infinity | 0.231 | 1.517 | 64.2 |
| S20 | | Infinity | 0.546 | | |
| S21 | Image | Infinity | | | |
| | Plane | | | | |

In the ninth embodiment of the present disclosure, the first lens 910 may have a positive refractive power, an object-side surface of the first lens 910 may have a convex shape in the paraxial region, and an image-side surface of the first lens 910 may have a concave shape in the paraxial region.

The second lens 920 may have a positive refractive power, an object-side surface of the second lens 920 may have a convex shape in the paraxial region, and an image-side surface of the second lens 920 may have a concave shape in the paraxial region.

The third lens 930 may have a negative refractive power, an object-side surface of the third lens 930 may have a convex shape in the paraxial region, and an image-side surface of the third lens 930 may have a concave shape in the paraxial region.

The fourth lens 940 may have a positive refractive power, an object-side surface of the fourth lens 940 may have a convex shape in the paraxial region, and an image-side surface of the fourth lens 940 may have a concave shape in the paraxial region.

The third lens 930 and the fourth lens 940 may be bonded to each other. For example, the image-side surface of the third lens 930 and the object-side surface of the fourth lens 940 may be bonded to each other.

The third lens 930 and the fourth lens 940 may be bonded to each other by an adhesive layer 935.

The fifth lens 950 may have a negative refractive power, an object-side surface of the fifth lens 950 may have a convex shape in the paraxial region, and an image-side surface of the fifth lens 950 may have a concave shape in the paraxial region.

The sixth lens 960 may have a negative refractive power, an object-side surface of the sixth lens 960 may have a convex shape in the paraxial region, and an image-side surface of the sixth lens 960 may have a concave shape in the paraxial region.

The seventh lens 970 may have a negative refractive power, an object-side surface of the seventh lens 970 may have a concave shape in the paraxial region, and an image-side surface of the seventh lens 970 may have a convex shape in the paraxial region.

The eighth lens 980 may have a positive refractive power, an object-side surface of the eighth lens 980 may have a convex shape in the paraxial region, and an image-side surface of the eighth lens 980 may have a concave shape in the paraxial region.

The ninth lens 990 may have a negative refractive power, an object-side surface of the ninth lens 990 may have a convex shape in the paraxial region, and an image-side surface of the ninth lens 990 may have a concave shape in the paraxial region.

In addition, either one or both of the eighth lens 980 and the ninth lens 990 may have at least one inflection point on either one or both of the object-side surface and the image-side surface.

Each of the surfaces of the first lens 910 to the ninth lens 990 may have aspherical coefficients as illustrated in Table 18. For example, the object-side surfaces and the image-side surfaces of the first lens 910 to the ninth lens 990 may all be aspherical.

TABLE 18

| | S1 | S2 | S3 | S4 | S5 | S6 |
|---|---|---|---|---|---|---|
| Conic | −6.404 | −12.039 | −4.482 | 0.268 | 59.522 | −0.267 |
| Constant (K) | | | | | | |
| 4th Coeffi- | 1.064E−02 | 6.698E−03 | −7.367E−04 | −8.005E−03 | −5.837E−03 | 5.160E−04 |
| cient (A) | | | | | | |
| 6th Coeffi- | −1.808E−03 | −2.977E−03 | −5.098E−03 | −1.329E−02 | −6.137E−03 | −2.431E−02 |
| cient (B) | | | | | | |
| 8th Coeffi- | −8.340E−03 | −2.183E−02 | 1.333E−02 | 5.196E−02 | 3.682E−02 | 1.454E−01 |
| cient (C) | | | | | | |
| 10th Coeffi- | 1.841E−02 | 6.121E−02 | −2.570E−02 | −1.091E−01 | −9.021E−02 | −4.674E−01 |
| cient (D) | | | | | | |
| 12th Coeffi- | −2.450E−02 | −9.772E−02 | 3.482E−02 | 1.509E−01 | 1.395E−01 | 9.489E−01 |
| cient (E) | | | | | | |
| 14th Coeffi- | 2.214E−02 | 1.059E−01 | −3.118E−02 | −1.430E−01 | −1.445E−01 | −1.306E+00 |
| cient (F) | | | | | | |
| 16th Coeffi- | −1.414E−02 | −8.054E−02 | 1.920E−02 | 9.514E−02 | 1.033E−01 | 1.266E+00 |
| cient (G) | | | | | | |
| 18th Coeffi- | 6.501E−03 | 4.353E−02 | −8.366E−03 | −4.515E−02 | −5.183E−02 | −8.794E−01 |
| cient (H) | | | | | | |
| 20th Coeffi- | −2.164E−03 | −1.678E−02 | 2.608E−03 | 1.536E−02 | 1.837E−02 | 4.393E−01 |
| cient (J) | | | | | | |
| 22nd Coeffi- | 5.167E−04 | 4.572E−03 | −5.786E−04 | −3.721E−03 | −4.568E−03 | −1.558E−01 |
| cient (L) | | | | | | |
| 24th Coeffi- | −8.627E−05 | −8.596E−04 | 8.921E−05 | 6.266E−04 | 7.786E−04 | 3.795E−02 |
| cient (M) | | | | | | |
| 26th Coeffi- | 9.552E−06 | 1.059E−04 | −9.077E−06 | −6.982E−05 | −8.654E−05 | −5.968E−03 |
| cient (N) | | | | | | |
| 28th Coeffi- | −6.292E−07 | −7.694E−06 | 5.474E−07 | 4.631E−06 | 5.644E−06 | 5.346E−04 |
| cient (O) | | | | | | |
| 30th Coeffi- | 1.862E−08 | 2.494E−07 | −1.479E−08 | −1.385E−07 | −1.638E−07 | −1.997E−05 |
| cient (P) | | | | | | |
| | S7 | S8 | S9 | S10 | S11 | S12 |
| Conic | −0.267 | −66.460 | −99.000 | 51.228 | 95.483 | −43.594 |
| Constant (K) | | | | | | |
| 4th Coeffi- | 5.160E−04 | −1.819E−03 | −2.157E−02 | −2.234E−02 | −5.987E−02 | −1.125E−01 |
| cient (A) | | | | | | |
| 6th Coeffi- | −2.431E−02 | 1.396E−03 | 2.524E−03 | 1.198E−02 | 6.972E−02 | 1.003E−01 |
| cient (B) | | | | | | |
| 8th Coeffi- | 1.454E−01 | −2.568E−03 | 1.140E−03 | −1.870E−02 | −9.091E−02 | −9.198E−02 |
| cient (C) | | | | | | |
| 10th Coeffi- | −4.674E−01 | 3.399E−03 | −3.084E−02 | 1.549E−02 | 1.023E−01 | 7.206E−02 |
| cient (D) | | | | | | |
| 12th Coeffi- | 9.489E−01 | −1.405E−04 | 8.219E−02 | −4.982E−03 | −9.378E−02 | −5.113E−02 |
| cient (E) | | | | | | |
| 14th Coeffi- | −1.306E+00 | −6.807E−03 | −1.203E−01 | −3.563E−03 | 6.626E−02 | 3.234E−02 |
| cient (F) | | | | | | |
| 16th Coeffi- | 1.266E+00 | 1.120E−02 | 1.149E−01 | 5.526E−03 | −3.500E−02 | −1.642E−02 |
| cient (G) | | | | | | |
| 18th Coeffi- | −8.794E−01 | −9.679E−03 | −7.595E−02 | −3.557E−03 | 1.364E−02 | 6.201E−03 |
| cient (H) | | | | | | |
| 20th Coeffi- | 4.393E−01 | 5.262E−03 | 3.550E−02 | 1.427E−03 | −3.890E−03 | −1.686E−03 |
| cient (J) | | | | | | |
| 22nd Coeffi- | −1.558E−01 | −1.884E−03 | −1.171E−02 | −3.844E−04 | 8.001E−04 | 3.244E−04 |
| cient (L) | | | | | | |
| 24th Coeffi- | 3.795E−02 | 4.436E−04 | 2.669E−03 | 6.970E−05 | −1.155E−04 | −4.310E−05 |
| cient (M) | | | | | | |
| 26th Coeffi- | −5.968E−03 | −6.614E−05 | −3.993E−04 | −8.181E−06 | 1.109E−05 | 3.762E−06 |
| cient (N) | | | | | | |
| 28th Coeffi- | 5.346E−04 | 5.655E−06 | 3.526E−05 | 5.611E−07 | −6.352E−07 | −1.941E−07 |
| cient (O) | | | | | | |
| 30th Coeffi- | −1.997E−05 | −2.111E−07 | −1.391E−06 | −1.706E−08 | 1.641E−08 | 4.483E−09 |
| cient (P) | | | | | | |
| | S13 | S14 | S15 | S16 | S17 | S18 |
| Conic | 2.322 | 4.395 | −5.922 | −7.976 | 18.719 | −8.802 |
| Constant (K) | | | | | | |
| 4th Coeffi- | 3.738E−02 | 3.128E−02 | −4.745E−03 | 8.216E−03 | −8.040E−02 | −4.361E−02 |
| cient (A) | | | | | | |
| 6th Coeffi- | −4.732E−02 | −4.939E−02 | 1.303E−03 | 5.648E−03 | 3.368E−02 | 1.985E−02 |
| cient (B) | | | | | | |
| 8th Coeffi- | 5.588E−02 | 4.700E−02 | 2.300E−04 | −7.004E−03 | −1.069E−02 | −6.554E−03 |
| cient (C) | | | | | | |
| 10th Coeffi- | −5.859E−02 | −3.380E−02 | −1.535E−03 | 3.176E−03 | 2.340E−03 | 1.538E−03 |
| cient (D) | | | | | | |
| 12th Coeffi- | 4.421E−02 | 1.836E−02 | 1.102E−03 | −8.947E−04 | −3.380E−04 | −2.628E−04 |
| cient (E) | | | | | | |
| 14th Coeffi- | −2.251E−02 | −7.326E−03 | −4.258E−04 | 1.741E−04 | 3.145E−05 | 3.313E−05 |
| cient (F) | | | | | | |
| 16th Coeffi- | 7.771E−03 | 2.106E−03 | 1.056E−04 | −2.434E−05 | −1.724E−06 | −3.093E−06 |
| cient (G) | | | | | | |
| 18th Coeffi- | −1.848E−03 | −4.335E−04 | −1.784E−05 | 2.487E−06 | 3.121E−08 | 2.130E−07 |
| cient (H) | | | | | | |
| 20th Coeffi- | 3.051E−04 | 6.363E−05 | 2.104E−06 | −1.863E−07 | 2.873E−09 | −1.072E−08 |
| cient (J) | | | | | | |
| 22nd Coeffi- | −3.478E−05 | −6.588E−06 | −1.735E−07 | 1.012E−08 | −2.658E−10 | 3.872E−10 |
| cient (L) | | | | | | |
| 24th Coeffi- | 2.673E−06 | 4.695E−07 | 9.821E−09 | −3.887E−10 | 1.088E−11 | −9.739E−12 |
| cient (M) | | | | | | |
| 26th Coeffi- | −1.312E−07 | −2.189E−08 | −3.639E−10 | 9.992E−12 | −2.542E−13 | 1.615E−13 |
| cient (N) | | | | | | |
| 28th Coeffi- | 3.679E−09 | 6.012E−10 | 7.947E−12 | −1.542E−13 | 3.281E−15 | −1.583E−15 |
| cient (O) | | | | | | |
| 30th Coeffi- | −4.408E−11 | −7.367E−12 | −7.754E−14 | 1.078E−15 | −1.825E−17 | 6.938E−18 |
| cient (P) | | | | | | |

In addition, the optical imaging system 900 according to the ninth embodiment of the present disclosure may have the aberration characteristics illustrated in FIG. 18.

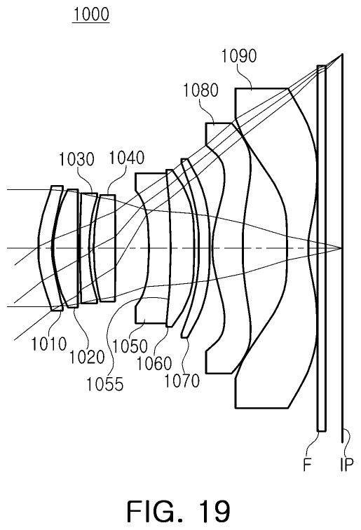

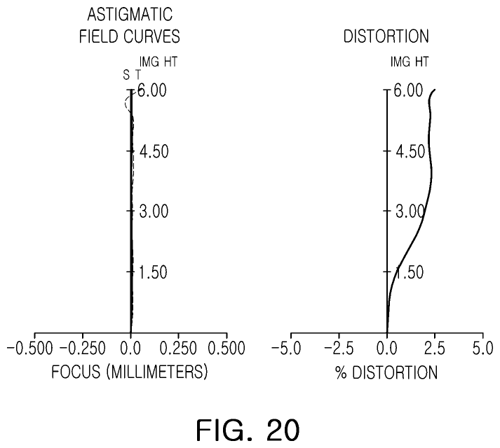

FIG. 19 is a configuration diagram of an optical imaging system according to a tenth embodiment of the present disclosure, and FIG. 20 is a view illustrating aberration characteristics of the optical imaging system illustrated in FIG. 19.

Referring to FIG. 19, an optical imaging system 1000 according to the tenth embodiment of the present disclosure may include a first lens 1010, a second lens 1020, a third lens 1030, a fourth lens 1040, a fifth lens 1050, a sixth lens 1060, a seventh lens 1070, an eighth lens 1080, and a ninth lens 1090, and may further include a filter F and an image sensor (not shown).

The optical imaging system 1000 according to the tenth embodiment of the present disclosure may form a focus on an image plane IP. The image plane IP may be a surface of the image sensor on which light is received.

Lens characteristics (a radius of curvature, a thickness of a lens or a distance between lenses, a refractive index, and an Abbe number) of each of the lenses and the filter may be as illustrated in Table 19.

TABLE 19

| Surface | | Radius of | Thickness or | Refractive | Abbe |
|---|---|---|---|---|---|
| No. | Element | Curvature | Distance | Index | No. |
| S1 | First | 3.481 | 0.416 | 1.524 | 53.8 |
| S2 | Lens | 3.410 | 0.036 | | |
| S3 | Second | 3.421 | 0.716 | 1.604 | 61.2 |
| S4 | Lens | 38.475 | 0.058 | | |
| S5 | Third | 25.669 | 0.280 | 1.720 | 29.8 |
| S6 | Lens | 5.500 | 0.129 | | |
| S7 | Fourth | 7.039 | 0.651 | 1.624 | 59.6 |
| S8 | Lens | 648.609 | 0.980 | | |
| S9 | Fifth | −9.032 | 0.643 | 1.720 | 32.0 |
| S10 | Lens | −22.456 | 0.000 | | |
| S11 | Sixth | −22.456 | 0.699 | 1.559 | 52.0 |
| S12 | Lens | −31.895 | 0.135 | | |
| S13 | Seventh | −6.516 | 0.314 | 1.614 | 25.9 |
| S14 | Lens | −9.061 | 0.080 | | |
| S15 | Eighth | 3.299 | 0.902 | 1.544 | 56.0 |
| S16 | Lens | 14.352 | 1.306 | | |
| S17 | Ninth | 38.495 | 0.622 | 1.535 | 55.7 |
| S18 | Lens | 2.691 | 0.270 | | |
| S19 | Filter | Infinity | 0.233 | 1.517 | 64.2 |
| S20 | | Infinity | 0.500 | | |
| S21 | Image | Infinity | | | |
| | Plane | | | | |

In the tenth embodiment of the present disclosure, the first lens 1010 may have a positive refractive power, an object-side surface of the first lens 1010 may have a convex shape in the paraxial region, and an image-side surface of the first lens 1010 may have a concave shape in the paraxial region.

The second lens 1020 may have a positive refractive power, an object-side surface of the second lens 1020 may have a convex shape in the paraxial region, and an image-side surface of the second lens 1020 may have a concave shape in the paraxial region.

The third lens 1030 may have a negative refractive power, an object-side surface of the third lens 1030 may have a convex shape in the paraxial region, and an image-side surface of the third lens 1030 may have a concave shape in the paraxial region.

The fourth lens 1040 may have a positive refractive power, an object-side surface of the fourth lens 1040 may have a convex shape in the paraxial region, and an image-side surface of the fourth lens 1040 may have a concave shape in the paraxial region.

The fifth lens 1050 may have a negative refractive power, an object-side surface of the fifth lens 1050 may have a concave shape in the paraxial region, and an image-side surface of the fifth lens 1050 may have a convex shape in the paraxial region.

The sixth lens 1060 may have a negative refractive power, an object-side surface of the sixth lens 1060 may have a concave shape in the paraxial region, and an image-side surface of the sixth lens 1060 may have a convex shape in the paraxial region.

The fifth lens 1050 and the sixth lens 1060 may be bonded to each other. For example, the image-side surface of the fifth lens 1050 and the object-side surface of the sixth lens 1060 may be bonded to each other.

The fifth lens 1050 and the sixth lens 1060 may be bonded to each other by an adhesive layer 1055.

The seventh lens 1070 may have a negative refractive power, an object-side surface of the seventh lens 1070 may have a concave shape in the paraxial region, and an image-side surface of the seventh lens 1070 may have a convex shape in the paraxial region.

The eighth lens 1080 may have a positive refractive power, an object-side surface of the eighth lens 1080 may have a convex shape in the paraxial region, and an image-side surface of the eighth lens 1080 may have a concave shape in the paraxial region.

The ninth lens 1090 may have a negative refractive power, an object-side surface of the ninth lens 1090 may have a convex shape in the paraxial region, and an image-side surface of the ninth lens 1090 may have a concave shape in the paraxial region.

In addition, either one or both of the eighth lens 1080 and the ninth lens 1090 may have at least one inflection point on either one or both of the object-side surface and the image-side surface.

Each of the surfaces of the first lens 1010 to the ninth lens 1090 may have aspherical coefficients as illustrated in Table 20. For example, the object-side surfaces and the image-side surfaces of the first lens 1010 to the fourth lens 1040 and the seventh lens 1070 to the ninth lens 1090 may all be aspherical. The object-side surface of the fifth lens 1050 and the image-side surface of the sixth lens 1060 may be aspherical, and the image-side surface of the fifth lens 1050 and the object-side surface of the sixth lens 1060 may be spherical.

TABLE 20

| | S1 | S2 | S3 | S4 | S5 | S6 |
|---|---|---|---|---|---|---|
| Conic | −6.690 | −12.123 | −4.635 | 44.648 | 53.645 | −0.159 |
| Constant (K) | | | | | | |
| 4th Coeffi- | 1.102E−02 | 2.147E−02 | 6.876E−03 | −5.238E−03 | −8.364E−03 | −5.593E−03 |
| cient (A) | | | | | | |
| 6th Coeffi- | 5.901E−03 | −2.394E−02 | −1.191E−02 | 5.570E−03 | 1.539E−02 | 1.676E−02 |
| cient (B) | | | | | | |
| 8th Coeffi- | −3.601E−02 | −4.020E−03 | 6.380E−03 | −1.480E−02 | −3.631E−02 | −7.633E−02 |
| cient (C) | | | | | | |
| 10th Coeffi- | 7.374E−02 | 3.276E−02 | −7.262E−03 | 2.565E−02 | 6.727E−02 | 2.791E−01 |
| cient (D) | | | | | | |
| 12th Coeffi- | −9.805E−02 | −5.540E−02 | 1.060E−02 | −3.526E−02 | −8.875E−02 | −7.091E−01 |
| cient (E) | | | | | | |
| 14th Coeffi- | 8.989E−02 | 6.351E−02 | −8.392E−03 | 3.581E−02 | 8.253E−02 | 1.260E+00 |
| cient (F) | | | | | | |
| 16th Coeffi- | −5.846E−02 | −5.070E−02 | 4.196E−03 | −2.590E−02 | −5.430E−02 | −1.586E+00 |
| cient (G) | | | | | | |
| 18th Coeffi- | 2.734E−02 | 2.833E−02 | −1.527E−03 | 1.331E−02 | 2.543E−02 | 1.427E+00 |
| cient (H) | | | | | | |
| 20th Coeffi- | −9.211E−03 | −1.116E−02 | 4.389E−04 | −4.853E−03 | −8.467E−03 | −9.193E−01 |
| cient (J) | | | | | | |
| 22nd Coeffi- | 2.212E−03 | 3.084E−03 | −1.002E−04 | 1.244E−03 | 1.982E−03 | 4.201E−01 |
| cient (L) | | | | | | |
| 24th Coeffi- | −3.688E−04 | −5.856E−04 | 1.715E−05 | −2.185E−04 | −3.179E−04 | −1.328E−01 |
| cient (M) | | | | | | |
| 26th Coeffi- | 4.051E−05 | 7.271E−05 | −1.998E−06 | 2.499E−05 | 3.317E−05 | 2.762E−02 |
| cient (N) | | | | | | |
| 28th Coeffi- | −2.633E−06 | −5.312E−06 | 1.382E−07 | −1.672E−06 | −2.025E−06 | −3.396E−03 |
| cient (O) | | | | | | |
| 30th Coeffi- | 7.658E−08 | 1.730E−07 | −4.226E−09 | 4.957E−08 | 5.480E−08 | 1.871E−04 |
| cient (P) | | | | | | |
| | S7 | S8 | S9 | S10 | S11 | S12 |
| Conic | −0.040 | 99.000 | −35.921 | 0.000 | 0.000 | −57.248 |
| Constant (K) | | | | | | |
| 4th Coeffi- | 2.007E−03 | −1.416E−03 | −2.029E−02 | 0.000E+00 | 0.000E+00 | −3.357E−02 |
| cient (A) | | | | | | |
| 6th Coeffi- | −2.330E−02 | 3.680E−03 | 1.621E−03 | 0.000E+00 | 0.000E+00 | 1.931E−02 |
| cient (B) | | | | | | |
| 8th Coeffi- | 1.199E−01 | −1.702E−02 | 4.826E−03 | 0.000E+00 | 0.000E+00 | −4.913E−02 |
| cient (C) | | | | | | |
| 10th Coeffi- | −3.901E−01 | 4.370E−02 | −2.218E−02 | 0.000E+00 | 0.000E+00 | 6.965E−02 |
| cient (D) | | | | | | |
| 12th Coeffi- | 8.531E−01 | −7.660E−02 | 4.589E−02 | 0.000E+00 | 0.000E+00 | −5.486E−02 |
| cient (E) | | | | | | |
| 14th Coeffi- | −1.313E+00 | 9.292E−02 | −6.222E−02 | 0.000E+00 | 0.000E+00 | 2.695E−02 |
| cient (F) | | | | | | |
| 16th Coeffi- | 1.460E+00 | −7.907E−02 | 5.854E−02 | 0.000E+00 | 0.000E+00 | −8.799E−03 |
| cient (G) | | | | | | |
| 18th Coeffi- | −1.189E+00 | 4.761E−02 | −3.897E−02 | 0.000E+00 | 0.000E+00 | 1.973E−03 |
| cient (H) | | | | | | |
| 20th Coeffi- | 7.072E−01 | −2.029E−02 | 1.842E−02 | 0.000E+00 | 0.000E+00 | −3.072E−04 |
| cient (J) | | | | | | |
| 22nd Coeffi- | −3.035E−01 | 6.059E−03 | −6.138E−03 | 0.000E+00 | 0.000E+00 | 3.298E−05 |
| cient (L) | | | | | | |
| 24th Coeffi- | 9.127E−02 | −1.236E−03 | 1.406E−03 | 0.000E+00 | 0.000E+00 | −2.375E−06 |
| cient (M) | | | | | | |
| 26th Coeffi- | −1.821E−02 | 1.638E−04 | −2.104E−04 | 0.000E+00 | 0.000E+00 | 1.082E−07 |
| cient (N) | | | | | | |
| 28th Coeffi- | 2.163E−03 | −1.267E−05 | 1.850E−05 | 0.000E+00 | 0.000E+00 | −2.756E−09 |
| cient (O) | | | | | | |
| 30th Coeffi- | −1.156E−04 | 4.340E−07 | −7.232E−07 | 0.000E+00 | 0.000E+00 | 2.861E−11 |
| cient (P) | | | | | | |
| | S13 | S14 | S15 | S16 | S17 | S18 |
| Conic | 0.698 | 5.793 | −6.144 | −3.232 | 24.812 | −7.386 |
| Constant (K) | | | | | | |
| 4th Coeffi- | 2.913E−02 | 3.943E−02 | 1.487E−02 | 7.837E−03 | −7.390E−02 | −4.380E−02 |
| cient (A) | | | | | | |
| 6th Coeffi- | −2.348E−02 | −6.491E−02 | −2.871E−02 | 9.424E−03 | 3.129E−02 | 2.080E−02 |
| cient (B) | | | | | | |
| 8th Coeffi- | −3.217E−02 | 4.235E−02 | 2.340E−02 | −1.101E−02 | −1.080E−02 | −7.125E−03 |
| cient (C) | | | | | | |
| 10th Coeffi- | 7.484E−02 | −1.265E−02 | −1.354E−02 | 5.344E−03 | 2.589E−03 | 1.696E−03 |
| cient (D) | | | | | | |
| 12th Coeffi- | −6.465E−02 | 3.427E−04 | 5.707E−03 | −1.606E−03 | −4.247E−04 | −2.862E−04 |
| cient (E) | | | | | | |
| 14th Coeffi- | 3.260E−02 | 9.927E−04 | −1.766E−03 | 3.289E−04 | 4.976E−05 | 3.479E−05 |
| cient (F) | | | | | | |
| 16th Coeffi- | −1.081E−02 | −3.416E−04 | 3.997E−04 | −4.767E−05 | −4.336E−06 | −3.074E−06 |
| cient (G) | | | | | | |
| 18th Coeffi- | 2.481E−03 | 5.449E−05 | −6.593E−05 | 4.972E−06 | 2.877E−07 | 1.981E−07 |
| cient (H) | | | | | | |
| 20th Coeffi- | −4.019E−04 | −3.960E−06 | 7.863E−06 | −3.740E−07 | −1.460E−08 | −9.263E−09 |
| cient (J) | | | | | | |
| 22nd Coeffi- | 4.600E−05 | −6.610E−08 | −6.680E−07 | 2.009E−08 | 5.573E−10 | 3.101E−10 |
| cient (L) | | | | | | |
| 24th Coeffi- | −3.646E−06 | 3.866E−08 | 3.930E−08 | −7.510E−10 | −1.542E−11 | −7.226E−12 |
| cient (M) | | | | | | |
| 26th Coeffi- | 1.908E−07 | −3.297E−09 | −1.519E−09 | 1.853E−11 | 2.901E−13 | 1.111E−13 |
| cient (N) | | | | | | |
| 28th Coeffi- | −5.931E−09 | 1.281E−10 | 3.462E−11 | −2.711E−13 | −3.306E−15 | −1.013E−15 |
| cient (O) | | | | | | |
| 30th Coeffi- | 8.303E−11 | −1.982E−12 | −3.524E−13 | 1.779E−15 | 1.715E−17 | 4.138E−18 |
| cient (P) | | | | | | |

In addition, the optical imaging system 1000 according to the tenth embodiment of the present disclosure may have the aberration characteristics illustrated in FIG. 20.

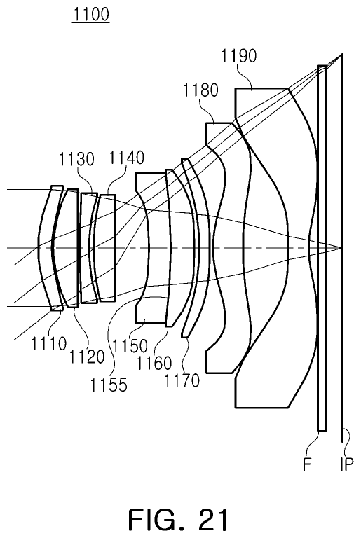

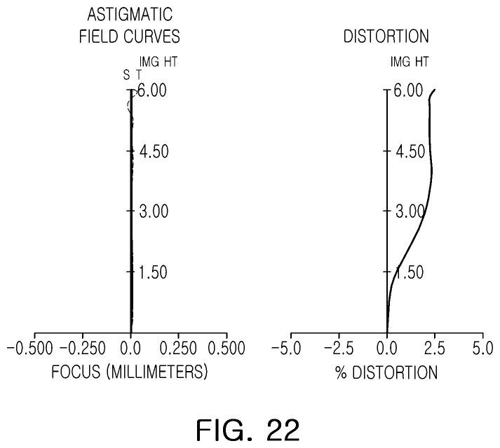

FIG. 21 is a configuration diagram of an optical imaging system according to an eleventh embodiment of the present disclosure, and FIG. 22 is a view illustrating aberration characteristics of the optical imaging system illustrated in FIG. 21.

Referring to FIG. 21, an optical imaging system 1100 according to the eleventh embodiment of the present disclosure may include a first lens 1110, a second lens 1120, a third lens 1130, a fourth lens 1140, a fifth lens 1150, a sixth lens 1160, a seventh lens 1170, an eighth lens 1180, and a ninth lens 1190, and may further include a filter F and an image sensor (not shown).

The optical imaging system 1100 according to the eleventh embodiment of the present disclosure may form a focus on an image plane IP. The image plane IP may be a surface of the image sensor on which light is received.

Lens characteristics (a radius of curvature, a thickness of a lens or a distance between lenses, a refractive index, and an Abbe number) of each of the lenses and the filter may be as illustrated in Table 21.

TABLE 21

| Surface | | Radius of | Thickness or | Refractive | Abbe |
|---|---|---|---|---|---|
| No. | Element | Curvature | Distance | Index | No. |
| S1 | First | 3.480 | 0.417 | 1.524 | 54.0 |
| S2 | Lens | 3.410 | 0.038 | | |
| S3 | Second | 3.421 | 0.716 | 1.603 | 61.2 |
| S4 | Lens | 37.825 | 0.058 | | |
| S5 | Third | 25.235 | 0.280 | 1.720 | 30.1 |
| S6 | Lens | 5.384 | 0.131 | | |
| S7 | Fourth | 6.809 | 0.648 | 1.625 | 59.4 |
| S8 | Lens | 409.333 | 0.975 | | |
| S9 | Fifth | −9.014 | 0.643 | 1.720 | 32.0 |
| S10 | Lens | −20.313 | 0.000 | | |
| S11 | Sixth | −20.313 | 0.711 | 1.558 | 52.4 |
| S12 | Lens | −32.156 | 0.134 | | |
| S13 | Seventh | −6.596 | 0.307 | 1.614 | 25.9 |
| S14 | Lens | −9.229 | 0.089 | | |
| S15 | Eighth | 3.292 | 0.893 | 1.544 | 56.0 |
| S16 | Lens | 14.421 | 1.309 | | |
| S17 | Ninth | 38.349 | 0.612 | 1.535 | 55.7 |
| S18 | Lens | 2.675 | 0.270 | | |
| S19 | Filter | Infinity | 0.233 | 1.517 | 64.2 |
| S20 | | Infinity | 0.500 | | |
| S21 | Image | Infinity | | | |
| | Plane | | | | |

In the eleventh embodiment of the present disclosure, the first lens 1110 may have a positive refractive power, an object-side surface of the first lens 1110 may have a convex shape in the paraxial region, and an image-side surface of the first lens 1110 may have a concave shape in the paraxial region.

The second lens 1120 may have a positive refractive power, an object-side surface of the second lens 1120 may have a convex shape in the paraxial region, and an image-side surface of the second lens 1120 may have a concave shape in the paraxial region.

The third lens 1130 may have a negative refractive power, an object-side surface of the third lens 1130 may have a convex shape in the paraxial region, and an image-side surface of the third lens 1130 may have a concave shape in the paraxial region.

The fourth lens 1140 may have a positive refractive power, an object-side surface of the fourth lens 1140 may have a convex shape in the paraxial region, and an image-side surface of the fourth lens 1140 may have a concave shape in the paraxial region.

The fifth lens 1150 may have a negative refractive power, an object-side surface of the fifth lens 1150 may have a concave shape in the paraxial region, and an image-side surface of the fifth lens 1150 may have a convex shape in the paraxial region.

The sixth lens 1160 may have a negative refractive power, an object-side surface of the sixth lens 1160 may have a concave shape in the paraxial region, and an image-side surface of the sixth lens 1160 may have a convex shape in the paraxial region.

The fifth lens 1150 and the sixth lens 1160 may be bonded to each other. For example, the image-side surface of the fifth lens 1150 and the object-side surface of the sixth lens 1160 may be bonded to each other.

The fifth lens 1150 and the sixth lens 1160 may be bonded to each other by an adhesive layer 1155.

The seventh lens 1170 may have a negative refractive power, an object-side surface of the seventh lens 1170 may have a concave shape in the paraxial region, and an image-side surface of the seventh lens 1170 may have a convex shape in the paraxial region.

The eighth lens 1180 may have a positive refractive power, an object-side surface of the eighth lens 1180 may have a convex shape in the paraxial region, and an image-side surface of the eighth lens 1180 may have a concave shape in the paraxial region.

The ninth lens 1190 may have a negative refractive power, an object-side surface of the ninth lens 1190 may have a convex shape in the paraxial region, and an image-side surface of the ninth lens 1190 may have a concave shape in the paraxial region.

In addition, either one or both of the eighth lens 1180 and the ninth lens 1190 may have at least one inflection point on either one or both of the object-side surface and the image-side surface.

Each of the surfaces of the first lens 1110 to the ninth lens 1190 may have aspherical coefficients as illustrated in Table 22. For example, the object-side surfaces and the image-side surfaces of the first lens 1110 to the ninth lens 1190 may all be aspherical.

TABLE 22

| | S1 | S2 | S3 | S4 | S5 | S6 |
|---|---|---|---|---|---|---|
| Conic | −6.694 | −12.124 | −4.632 | 43.673 | 53.495 | −0.154 |
| Constant (K) | | | | | | |
| 4th Coeffi- | 1.130E−02 | 2.199E−02 | 7.081E−03 | −5.293E−03 | −7.779E−03 | −5.496E−03 |
| cient (A) | | | | | | |
| 6th Coeffi- | 4.390E−03 | −2.851E−02 | −1.446E−02 | 6.481E−03 | 1.331E−02 | 1.699E−02 |
| cient (B) | | | | | | |
| 8th Coeffi- | −3.181E−02 | 9.625E−03 | 1.365E−02 | −1.895E−02 | −3.187E−02 | −7.797E−02 |
| cient (C) | | | | | | |
| 10th Coeffi- | 6.645E−02 | 1.211E−02 | −1.573E−02 | 3.464E−02 | 5.967E−02 | 2.820E−01 |
| cient (D) | | | | | | |
| 12th Coeffi- | −8.955E−02 | −3.659E−02 | 1.373E−02 | −4.782E−02 | −7.916E−02 | −7.104E−01 |
| cient (E) | | | | | | |
| 14th Coeffi- | 8.293E−02 | 5.211E−02 | −5.514E−03 | 4.810E−02 | 7.410E−02 | 1.257E+00 |
| cient (F) | | | | | | |
| 16th Coeffi- | −5.435E−02 | −4.566E−02 | −1.784E−04 | −3.448E−02 | −4.915E−02 | −1.579E+00 |
| cient (G) | | | | | | |
| 18th Coeffi- | 2.558E−02 | 2.653E−02 | 1.191E−03 | 1.757E−02 | 2.320E−02 | 1.419E+00 |
| cient (H) | | | | | | |
| 20th Coeffi- | −8.669E−03 | −1.060E−02 | −5.775E−04 | −6.354E−03 | −7.782E−03 | −9.139E−01 |
| cient (J) | | | | | | |
| 22nd Coeffi- | 2.093E−03 | 2.940E−03 | 1.473E−04 | 1.615E−03 | 1.833E−03 | 4.176E−01 |
| cient (L) | | | | | | |
| 24th Coeffi- | −3.507E−04 | −5.573E−04 | −2.254E−05 | −2.815E−04 | −2.954E−04 | −1.321E−01 |
| cient (M) | | | | | | |
| 26th Coeffi- | 3.870E−05 | 6.898E−05 | 2.053E−06 | 3.195E−05 | 3.094E−05 | 2.747E−02 |
| cient (N) | | | | | | |
| 28th Coeffi- | −2.526E−06 | −5.024E−06 | −1.009E−07 | −2.124E−06 | −1.893E−06 | −3.380E−03 |
| cient (O) | | | | | | |
| 30th Coeffi- | 7.376E−08 | 1.632E−07 | 1.994E−09 | 6.261E−08 | 5.133E−08 | 1.863E−04 |
| cient (P) | | | | | | |
| | S7 | S8 | S9 | S10 | S11 | S12 |
| Conic | −0.040 | 99.000 | −36.381 | 1.917 | 1.917 | −73.045 |
| Constant (K) | | | | | | |
| 4th Coeffi- | 2.007E−03 | −1.564E−03 | −2.050E−02 | 2.496E−03 | 2.496E−03 | −3.250E−02 |
| cient (A) | | | | | | |
| 6th Coeffi- | −2.330E−02 | 4.465E−03 | 6.707E−03 | 1.200E−02 | 1.200E−02 | 9.672E−03 |
| cient (B) | | | | | | |
| 8th Coeffi- | 1.199E−01 | −2.085E−02 | −1.850E−02 | −4.887E−02 | −4.887E−02 | −3.158E−02 |
| cient (C) | | | | | | |
| 10th Coeffi- | −3.901E−01 | 5.381E−02 | 3.360E−02 | 8.042E−02 | 8.042E−02 | 5.303E−02 |
| cient (D) | | | | | | |
| 12th Coeffi- | 8.531E−01 | −9.269E−02 | −4.026E−02 | −7.995E−02 | −7.995E−02 | −4.407E−02 |
| cient (E) | | | | | | |
| 14th Coeffi- | −1.313E+00 | 1.097E−01 | 3.103E−02 | 5.405E−02 | 5.405E−02 | 2.123E−02 |
| cient (F) | | | | | | |
| 16th Coeffi- | 1.460E+00 | −9.108E−02 | −1.469E−02 | −2.622E−02 | −2.622E−02 | −6.244E−03 |
| cient (G) | | | | | | |
| 18th Coeffi- | −1.189E+00 | 5.365E−02 | 3.230E−03 | 9.345E−03 | 9.345E−03 | 1.076E−03 |
| cient (H) | | | | | | |
| 20th Coeffi- | 7.072E−01 | −2.245E−02 | 6.587E−04 | −2.454E−03 | −2.454E−03 | −7.743E−05 |
| cient (J) | | | | | | |
| 22nd Coeffi- | −3.035E−01 | 6.601E−03 | −7.600E−04 | 4.685E−04 | 4.685E−04 | −8.137E−06 |
| cient (L) | | | | | | |
| 24th Coeffi- | 9.127E−02 | −1.330E−03 | 2.710E−04 | −6.308E−05 | −6.308E−05 | 2.590E−06 |
| cient (M) | | | | | | |
| 26th Coeffi- | −1.821E−02 | 1.743E−04 | −5.247E−05 | 5.663E−06 | 5.663E−06 | −2.763E−07 |
| cient (N) | | | | | | |
| 28th Coeffi- | 2.163E−03 | −1.337E−05 | 5.501E−06 | −3.036E−07 | −3.036E−07 | 1.447E−08 |
| cient (O) | | | | | | |
| 30th Coeffi- | −1.156E−04 | 4.547E−07 | −2.451E−07 | 7.343E−09 | 7.343E−09 | −3.106E−10 |
| cient (P) | | | | | | |
| | S13 | S14 | S15 | S16 | S17 | S18 |
| Conic | 0.732 | 5.669 | −6.143 | −2.868 | 26.007 | −7.385 |
| Constant (K) | | | | | | |
| 4th Coeffi- | 3.370E−02 | 4.342E−02 | 1.550E−02 | 7.661E−03 | −7.568E−02 | −4.543E−02 |
| cient (A) | | | | | | |
| 6th Coeffi- | −3.547E−02 | −7.337E−02 | −3.041E−02 | 1.025E−02 | 3.294E−02 | 2.213E−02 |
| cient (B) | | | | | | |
| 8th Coeffi- | −2.262E−02 | 4.905E−02 | 2.513E−02 | −1.195E−02 | −1.138E−02 | −7.660E−03 |
| cient (C) | | | | | | |
| 10th Coeffi- | 7.671E−02 | −1.424E−02 | −1.462E−02 | 5.839E−03 | 2.649E−03 | 1.836E−03 |
| cient (D) | | | | | | |
| 12th Coeffi- | −7.288E−02 | −6.172E−04 | 6.179E−03 | −1.759E−03 | −4.127E−04 | −3.118E−04 |
| cient (E) | | | | | | |
| 14th Coeffi- | 3.906E−02 | 1.891E−03 | −1.911E−03 | 3.594E−04 | 4.507E−05 | 3.822E−05 |
| cient (F) | | | | | | |
| 16th Coeffi- | −1.361E−02 | −6.892E−04 | 4.314E−04 | −5.188E−05 | −3.631E−06 | −3.414E−06 |
| cient (G) | | | | | | |
| 18th Coeffi- | 3.260E−03 | 1.366E−04 | −7.082E−05 | 5.382E−06 | 2.255E−07 | 2.227E−07 |
| cient (H) | | | | | | |
| 20th Coeffi- | −5.493E−04 | −1.687E−05 | 8.397E−06 | −4.025E−07 | −1.106E−08 | −1.057E−08 |
| cient (J) | | | | | | |
| 22nd Coeffi- | 6.518E−05 | 1.322E−06 | −7.092E−07 | 2.150E−08 | 4.249E−10 | 3.596E−10 |
| cient (L) | | | | | | |
| 24th Coeffi- | −5.341E−06 | −6.241E−08 | 4.149E−08 | −7.992E−10 | −1.224E−11 | −8.532E−12 |
| cient (M) | | | | | | |
| 26th Coeffi- | 2.882E−07 | 1.479E−09 | −1.595E−09 | 1.962E−11 | 2.449E−13 | 1.338E−13 |
| cient (N) | | | | | | |
| 28th Coeffi- | −9.215E−09 | −4.270E−12 | 3.619E−11 | −2.858E−13 | −2.989E−15 | −1.247E−15 |
| cient (O) | | | | | | |
| 30th Coeffi- | 1.324E−10 | −3.488E−13 | −3.669E−13 | 1.868E−15 | 1.660E−17 | 5.217E−18 |
| cient (P) | | | | | | |

In addition, the optical imaging system 1100 according to the eleventh embodiment of the present disclosure may have the aberration characteristics illustrated in FIG. 22.

Table 23 shows the values of f1, f2, f3, f4, f5, f6, f7, f8, f9, TTL, BFL, f, IMG HT, EPD, FOV, f12, f34, and f56 in the first to eleventh embodiments of the present disclosure.

TABLE 23

| | First | Second | Third | Fourth | Fifth | Sixth |
|---|---|---|---|---|---|---|
| | Emb. | Emb. | Emb. | Emb. | Emb. | Emb. |
| f1 | −110.97 | 43.6 | 45.24 | 267.76 | 266.02 | −75.42 |
| f2 | 5.56 | 6.83 | 6.78 | 5.6 | 5.61 | 5.9 |
| f3 | −8.61 | −8.66 | −8.42 | −8.61 | −8.6 | −9.38 |
| f4 | 11.82 | 13.58 | 13.01 | 9.97 | 9.95 | 13.14 |
| f5 | −23.2 | −45.69 | −45.48 | −28.06 | −28.59 | −25.35 |
| f6 | −327.52 | −94.65 | −97.85 | −55.11 | −53.58 | −581.61 |
| f7 | −34.15 | −30.9 | −29.95 | −31.67 | −31.76 | −36.49 |
| f8 | 6.5 | 6.23 | 6.18 | 6.87 | 6.87 | 7.06 |
| f9 | −5.21 | −4.82 | −4.82 | −4.8 | −4.78 | −5.69 |
| TTL | 7.999 | 8.001 | 8 | 8.1 | 8.101 | 8.856 |
| BFL | 0.872 | 0.910 | 0.911 | 0.932 | 0.934 | 0.940 |
| f | 6.43 | 6.43 | 6.43 | 6.44 | 6.44 | 7 |
| IMG HT | 6.000 | 6.000 | 6.000 | 6.000 | 6.000 | 6.000 |
| EPD | 3.404 | 3.302 | 3.302 | 3.282 | 3.285 | 3.758 |
| FOV | 85 | 85 | 85 | 84.6 | 84.8 | 79.9 |
| f12 | 6.097 | 6.150 | 6.142 | 5.742 | 5.747 | 6.670 |
| f34 | −32.649 | −23.577 | −23.468 | −68.209 | −68.338 | −33.732 |
| f56 | −21.674 | −30.740 | −30.959 | −18.634 | −18.677 | −24.304 |

| | Seventh | Eighth | Ninth | Tenth | Eleventh |
|---|---|---|---|---|---|
| | Emb. | Emb. | Emb. | Emb. | Emb. |
| f1 | −52.87 | 48.75 | 50.42 | 316.33 | 305.38 |
| f2 | 5.75 | 7.47 | 7.42 | 6.17 | 6.16 |
| f3 | −9.43 | −9.13 | −8.89 | −9.78 | −9.49 |
| f4 | 12.98 | 14.18 | 13.63 | 11.4 | 11.03 |
| f5 | −25.92 | −51.42 | −50.92 | −21.41 | −22.89 |
| f6 | −321.17 | −112.62 | −114.13 | −139.55 | −100.51 |
| f7 | −37.61 | −33.2 | −32.4 | −39.61 | −39.02 |
| f8 | 7.16 | 6.88 | 6.84 | 7.65 | 7.59 |
| f9 | −5.75 | −5.42 | −5.43 | −5.44 | −5.39 |
| TTL | 8.866 | 8.835 | 8.844 | 8.97 | 8.964 |
| BFL | 0.980 | 1.007 | 1.009 | 1.003 | 1.003 |
| f | 7.11 | 7.07 | 7.07 | 7.1 | 7.09 |
| IMG HT | 6.000 | 6.000 | 6.000 | 6.000 | 6.000 |
| EPD | 3.764 | 3.631 | 3.634 | 3.619 | 3.614 |
| FOV | 79 | 79.2 | 79.2 | 79.1 | 79.1 |
| f12 | 6.733 | 6.746 | 6.733 | 6.307 | 6.319 |
| f34 | −35.515 | −25.178 | −25.106 | −72.362 | −73.916 |
| f56 | −23.984 | −35.224 | −35.122 | −18.617 | −18.789 |

Table 24 shows the values of Conditional Expressions 1 to 20 in the first to eleventh embodiments according to the present disclosure. As can be seen from Table 24, all of the first to eleventh embodiments satisfy all of Conditional Expressions 1 to 20.

TABLE 24

| | First | Second | Third | Fourth | Fifth | Sixth |
|---|---|---|---|---|---|---|
| | Emb. | Emb. | Emb. | Emb. | Emb. | Emb. |
| 0 ≤ \|fa/Va − fb/Vb\| < 3 | 2.864 | 0.510 | 0.491 | 0.183 | 0.123 | 1.574 |
| −0.4 < f1/(f × 100) < 0.7 | −0.173 | 0.068 | 0.070 | 0.416 | 0.413 | −0.108 |
| 0.5 < f2/f < 1.5 | 0.865 | 1.062 | 1.054 | 0.870 | 0.871 | 0.843 |
| −2 < f3/f < 0 | −1.339 | −1.347 | −1.309 | −1.337 | −1.335 | −1.340 |
| 0.5 < f4/f < 3 | 1.838 | 2.112 | 2.023 | 1.548 | 1.545 | 1.877 |
| −9 < f5/f < −1 | −3.608 | −7.106 | −7.073 | −4.357 | −4.439 | −3.621 |
| −1 < f6/(f × 100) < 0 | −0.509 | −0.147 | −0.152 | −0.086 | −0.083 | −0.831 |
| −7 < f7/f < −2 | −5.311 | −4.806 | −4.658 | −4.918 | −4.932 | −5.213 |
| 0.5 < f8/f < 2 | 1.011 | 0.969 | 0.961 | 1.067 | 1.067 | 1.009 |
| −2 < f9/f < 0 | −0.810 | −0.750 | −0.750 | −0.745 | −0.742 | −0.813 |
| 1 < TTL/f < 1.4 | 1.244 | 1.244 | 1.244 | 1.258 | 1.258 | 1.265 |
| 0 < BFL/f < 0.3 | 0.136 | 0.142 | 0.142 | 0.145 | 0.145 | 0.134 |
| 0.5 < TTL/(2 × IMG HT) < 0.8 | 0.667 | 0.667 | 0.667 | 0.675 | 0.675 | 0.738 |
| 1.5 < f/EPD < 2 | 1.889 | 1.947 | 1.947 | 1.962 | 1.960 | 1.863 |
| 60° < FOV × (IMG HT/f) < 90° | 79.316° | 79.316° | 79.316° | 78.820° | 79.006° | 68.486° |
| 1.3 < AVE(Va, Vb)/Vc < 2 | 1.743 | 1.743 | 1.743 | 1.743 | 1.743 | 1.743 |
| 6 < \|f1/f2\| < 55 | −19.959 | 6.384 | 6.673 | 47.814 | 47.419 | −12.783 |
| 0.7 < f12/f < 1 | 0.948 | 0.956 | 0.955 | 0.892 | 0.892 | 0.953 |
| −11 < f34/f < −3 | −5.078 | −3.667 | −3.650 | −10.591 | −10.611 | −4.819 |
| −6 < f56/f < 0 | −3.371 | −4.781 | −4.815 | −2.893 | −2.900 | −3.472 |

| | Seventh | Eighth | Ninth | Tenth | Eleventh |
|---|---|---|---|---|---|
| | Emb. | Emb. | Emb. | Emb. | Emb. |
| 0 ≤ \|fa/Va − fb/Vb\| < 3 | 1.2496347 | 0.5320319 | 0.513238 | 2.0145913 | 1.2028173 |
| −0.4 < f1/(f × 100) < 0.7 | −0.074 | 0.069 | 0.071 | 0.446 | 0.431 |
| 0.5 < f2/f < 1.5 | 0.809 | 1.057 | 1.050 | 0.869 | 0.869 |
| −2 < f3/f < 0 | −1.326 | −1.291 | −1.257 | −1.377 | −1.339 |
| 0.5 < f4/f < 3 | 1.826 | 2.006 | 1.928 | 1.606 | 1.556 |
| −9 < f5/f < −1 | −3.646 | −7.273 | −7.202 | −3.015 | −3.228 |
| −1 < f6/(f × 100) < 0 | −0.452 | −0.159 | −0.161 | −0.197 | −0.142 |
| −7 < f7/f < −2 | −5.290 | −4.696 | −4.583 | −5.579 | −5.504 |
| 0.5 < f8/f < 2 | 1.007 | 0.973 | 0.967 | 1.077 | 1.071 |
| −2 < f9/f < 0 | −0.809 | −0.767 | −0.768 | −0.766 | −0.760 |
| 1 < TTL/f < 1.4 | 1.247 | 1.250 | 1.251 | 1.263 | 1.264 |
| 0 < BFL/f < 0.3 | 0.138 | 0.142 | 0.143 | 0.141 | 0.142 |
| 0.5 < TTL/(2 × IMG HT) < 0.8 | 0.739 | 0.736 | 0.737 | 0.748 | 0.747 |
| 1.5 < f/EPD < 2 | 1.889 | 1.947 | 1.946 | 1.962 | 1.962 |
| 60° < FOV × (IMG HT/f) < 90° | 66.667° | 67.214° | 67.214° | 66.845° | 66.939° |
| 1.3 < AVE(Va, Vb)/Vc < 2 | 1.743 | 1.743 | 1.743 | 1.743 | 1.743 |
| 6 < \|f1/f2\| < 55 | −9.195 | 6.526 | 6.795 | 51.269 | 49.575 |
| 0.7 < f12/f < 1 | 0.947 | 0.954 | 0.952 | 0.888 | 0.891 |
| −11 < f34/f < −3 | −4.995 | −3.561 | −3.551 | −10.192 | −10.425 |
| −6 < f56/f < 0 | −3.373 | −4.982 | −4.968 | −2.622 | −2.650 |

According to an optical imaging system according to an embodiment of the present disclosure, a size may be reduced while implementing a high degree of resolution.

While this disclosure includes specific examples, it will be apparent after an understanding of the disclosure of this application that various changes in form and details may be made in these examples without departing from the spirit and scope of the claims and their equivalents. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents. Therefore, the scope of the disclosure is defined not by the detailed description, but by the claims and their equivalents, and all variations within the scope of the claims and their equivalents are to be construed as being included in the disclosure.

What is claimed is:

1. An optical imaging system comprising:
a first lens, a second lens, a third lens, a fourth lens, a fifth lens, a sixth lens, a seventh lens, an eighth lens, and a ninth lens sequentially disposed in ascending numerical order along an optical axis of the optical imaging system from an object side of the optical imaging system toward an image plane of the optical imaging system,
wherein a composite focal length of the first lens and the second lens has a positive value,
the third lens has a negative refractive power,
two lenses among the first lens to the ninth lens are bonded to each other, and
the optical imaging system satisfies 0≤|fa/Va−fb/Vb|<3, where fa is a focal length of a lens disposed closer to the object side of the optical imaging system among the two bonded lenses, Va is an Abbe number of the lens disposed closer to the object side of the optical imaging system among the two bonded lenses, fb is a focal length of a lens disposed closer to the image plane of the optical imaging system among the two bonded lenses, and Vb is an Abbe number of the lens disposed closer to the image plane of the optical imaging system among the two bonded lenses.

2. The optical imaging system of claim 1, wherein −0.4<f1/(f×100)<0.7 is satisfied, where f1 is a focal length of the first lens, and f is a total focal length of the optical imaging system.

3. The optical imaging system of claim 1, wherein 0.5<f2/f<1.5 is satisfied, where f2 is a focal length of the second lens, and f is a total focal length of the optical imaging system.

4. The optical imaging system of claim 1, wherein −2<f3/f<0 is satisfied, where f3 is a focal length of the third lens, and f is a total focal length of the optical imaging system.

5. The optical imaging system of claim 1, wherein 0.5<f4/f<3 is satisfied, where f4 is a focal length of the fourth lens, and f is a total focal length of the optical imaging system.

6. The optical imaging system of claim 1, wherein −9<f5/f<−1 is satisfied, where f5 is a focal length of the fifth lens, and f is a total focal length of the optical imaging system.

7. The optical imaging system of claim 1, wherein −1<f6/(f×100)<0 is satisfied, where f6 is a focal length of the sixth lens, and f is a total focal length of the optical imaging system.

8. The optical imaging system of claim 1, wherein −7<f7/f<−2 is satisfied, where f7 is a focal length of the seventh lens, and f is a total focal length of the optical imaging system.

9. The optical imaging system of claim 1, wherein 0.5<f8/f<2 is satisfied, where f8 is a focal length of the eighth lens, and f is a total focal length of the optical imaging system.

10. The optical imaging system of claim 1, wherein −2<f9/f<0 is satisfied, where f9 is a focal length of the ninth lens, and f is a total focal length of the optical imaging system.

11. The optical imaging system of claim 1, wherein 1<TTL/f<1.4 and 0<BFL/f<0.3 are satisfied, where TTL is a distance along the optical axis from an object-side surface of the first lens to the image plane, BFL is a distance along the optical axis from an image-side surface of the ninth lens to the image plane, and f is a total focal length of the optical imaging system.

12. The optical imaging system of claim 1, wherein 0.5<TTL/(2×IMG HT)<0.8 is satisfied, where TTL is a distance along the optical axis from an object-side surface of the first lens to the image plane, and IMG HT is one half of a diagonal length of the image plane.

13. The optical imaging system of claim 1, wherein 1.5<f/EPD<2 is satisfied, where f is a total focal length of the optical imaging system, EPD is an entrance pupil diameter of the optical imaging system, and f/EPD is an F-number of the optical imaging system.

14. The optical imaging system of claim 1, wherein 1.3<AVE(Va, Vb)/Vc<2 is satisfied, where AVE(Va, Vb) is an average value of Abbe numbers of the two bonded lenses, and Vc is an Abbe number of a lens among the first to ninth lenses located adjacent to the two bonded lenses on an image side of the two bonded lenses.

15. The optical imaging system of claim 1, further comprising an adhesive layer bonding the two bonded lenses to each other,
wherein a refractive index of the adhesive layer is greater than a refractive index of a lens having a smaller refractive index among the two bonded lenses, and is less than a refractive index of a lens having a greater refractive index among the two bonded lenses.

16. The optical imaging system of claim 1, further comprising an adhesive layer bonding the two bonded lenses to each other,
wherein the optical imaging system satisfies 10<Vg<80, where Vg is an Abbe number of the adhesive layer.

17. The optical imaging system of claim 1, wherein 60°<FOV×(IMG HT/f)<90° is satisfied, where FOV is a field of view of the optical imaging system, IMG HT is one half of a diagonal length of the image plane, and f is a total focal length of the optical imaging system.

18. The optical imaging system of claim 1, wherein 6<|f1/f2|<55 is satisfied, where f1 is a focal length of the first lens, and f2 is a focal length of the second lens.

19. The optical imaging system of claim 1, wherein 0.7<f12/f<1 is satisfied, where f12 is a composite focal length of the first lens and the second lens, and f is a total focal length of the optical imaging system.

20. The optical imaging system of claim 1, wherein −11<f34/f<−3 is satisfied, where f34 is a composite focal length of the third lens and the fourth lens, and f is a total focal length of the optical imaging system.

21. The optical imaging system of claim 1, wherein −6<f56/f<0 is satisfied, where f56 is a composite focal length of the fifth lens and the sixth lens, and f is a total focal length of the optical imaging system.
